(19) United States
(12) Patent Application Publication
(10) Pub. No.: US 2026/0052401 A1
(43) Pub. Date: Feb. 19, 2026

(54) COMMUNICATION CONTROL APPARATUS, WIRELESS COMMUNICATION SYSTEM, COMMUNICATION CONTROL METHOD AND PROGRAM

(71) Applicant: NTT, Inc., Tokyo (JP)

(72) Inventors: Shuki WAI, Musashino-shi (JP); Takuto ARAI, Musashino-shi (JP); Daisei UCHIDA, Musashino-shi (JP); Tatshiko IWAKUNI, Musashno-shi (JP); Naoki KITA, Tokyo (JP)

(73) Assignee: NTT, Inc., Tokyo (JP)

(21) Appl. No.: 19/101,544

(22) PCT Filed: Aug. 10, 2022
(86) PCT No.: PCT/JP2022/030534

§ 371 Date: Feb. 5, 2025

(51) Int. Cl. H04W 16/28

(52) U.S. Cl. CPC H04W 16/28

(57) ABSTRACT

Each of a plurality of distributed antennas is caused to perform an all-beam search performed by transmitting beams in all transmittable directions in a beam search period for searching for a beam to be used for wireless communication with a terminal device in a different order of the distributed antennas for each beam search period, the all-beam search is stopped when one beam identifier indicating a best beam has been acquired according to the all-beam search, a beam identified by the acquired beam identifier and information indicating a distributed antenna that has transmitted the beam indicated by the beam identifier is set as a detection reference beam, a beam identifier of a distributed antenna that has not performed the all-beam search, which corresponds to a beam that has been selected together with the detection reference beam, is detected as a candidate beam identifier for the distributed antenna from a beam combination history storage unit, and whether or not to cause the distributed antenna that has not performed the all-beam search in the beam search period to perform the all-beam search is determined on the basis of detection results.

### TECHNICAL FIELD

The present invention relates to a communication control apparatus, a wireless communication system, a communication control method and program.

### BACKGROUND ART

### (Beamforming in High-Frequency Band)

In high-frequency bands such as millimeter-wave bands and terahertz bands, free-space propagation loss is greater than in low-frequency bands such as microwave bands. Therefore, in order to compensate for this loss, it is necessary to use a beamforming technique in which a beam that concentrates power in a specific direction is formed (refer to NPL 1, for example).

In the case of point-to-point (P-P) type communication in which a combination of wireless stations that always perform communication is fixed, and the positional relationship of the wireless stations and the propagation environment around the wireless stations do not change, a beam forming direction can be determined in advance to perform beamforming fixedly when a wireless station is installed, and the like. On the other hand, in the case of point-to-multi point (P-MP) type communication accommodating a plurality of wireless stations, or in the case where at least one of the wireless stations moves, the beamforming cannot be performed fixedly. In this case, it is necessary to perform adaptive beamforming in which the beam forming direction is adaptively controlled according to the location of a wireless station that requires communication among a plurality of wireless stations, the movement of the wireless station, and changes in the propagation environment around the wireless station.

Adaptive beamforming is generally performed by adjusting the phase relationship of radio waves radiated between a plurality of antenna elements to control the beam forming direction without using a mechanical drive unit. However, in order to appropriately adjust the phase relationship, it is necessary to derive an appropriate phase relationship after grasping the phase relationship between the antenna elements of both wireless stations on the transmitting side and the receiving side. That is, it is necessary to know the state of the propagation path between the antenna elements of both wireless stations on the transmitting side and receiving side for all combinations of antenna elements.

The state of the propagation path can be found by transmitting and receiving known signals between the transmitting-side wireless station and the receiving-side wireless station. However, since no other communication can be performed during the transmission and reception and it is necessary to accurately transmit the state of the propagation path from the receiving-side wireless station to the transmitting-side wireless station, communication overhead increases.

In order to suppress the increase in overhead, adaptive beamforming uses a technique in which a signal containing a beam identifier (hereinafter referred to as a beam identifier (ID)) associated with a plurality of candidate beams that are set discretely in advance is transmitted with each candidate beam and the beam ID of the beam determined to be most suitable for communication from among these beams is selected. This technique has been specified as a specification for wireless communication systems that have been put into practical use in recent years, such as 3GPP (registered trademark) 5G (5th Generation) and IEEE802.11ad, and is also being implemented (refer to NPL 1, NPL 2, and NPL 3, for example).

### (Beam Selection Procedure)

When selecting a transmitting-side beam of a wireless station, the transmitting-side wireless station transmits a signal that allows the receiving-side wireless station to uniquely identify each beam used for transmission. An example of such a signal is a beam search signal in which the beam ID of a beam used for transmission is embedded as digital information. The transmitting-side wireless station transmits beams carrying beam search signals in which different beam IDs are embedded while temporally switching the directions of the beams. The receiving-side wireless station receives a plurality of beams, reads the beam ID included in the beam search signal of each of the plurality of received beams, measures the reception quality of each beam, and determines which transmitting-side beam has the best reception quality. The receiving-side wireless station transmits a feedback signal to the transmitting-side wireless station that allows the transmitting-side wireless station to uniquely identify the beam ID of the transmitting-side beam with the best reception quality, whereby the transmitting-side wireless station can select the transmitting-side beam.

Regarding selection of a receiving-side beam of a wireless station, in a system such as time division duplex (TDD), which uses the same frequency for transmission and reception, it is also possible to select the same beam as that on the transmitting side. On the other hand, in systems such as frequency division duplex (FDD) that use different frequencies for transmission and reception, it is necessary to perform beam selection for the receiving-side beam in the same manner as for the selection of the transmitting-side beam. When selecting a receiving-side beam of a wireless station, the receiving-side wireless station transmits a signal requesting a receiving-side beam search procedure to the transmitting-side wireless station. The receiving-side wireless station receives the signal transmitted by the transmitting-side wireless station while temporally switching the direction according to the signal and measures the reception quality of the received signal. In this way, the receiving-side wireless station can select the receiving-side beam by determining which receiving-side beam has the best reception quality.

### (Distributed Antenna System)

FIG. 36 is a diagram showing the configuration of a wireless communication system 500, which is an example of a conventional general wireless communication system. FIG. 36 shows, as an example, a configuration in which five cells 100-1 to 100-5 exist in the wireless communication system 500. The wireless communication system 500 has a configuration in which one antenna is installed for one cell. That is, the wireless communication system 500 is configured by installing antenna devices 200-1 to 200-5 in the cells 100-1 to 100-5, respectively. The antenna devices 200-1 to 200-5 are connected to digital signal processing devices 210-1 to 210-5, respectively, that transmit and receive signals. Regarding the cell 100-1, the antenna device 200-1 and the digital signal processing device 210-1 become a so-called base station device. When one terminal station is located in the cell 100-1, for example, the terminal station will be connected by radio waves from one antenna device 200-1.

Here, as described above, in high-frequency bands such as the millimeter-wave band and the terahertz band, since the beamforming technique is used, the influence of reflected waves and diffracted waves is reduced. Therefore, in high-frequency bands, there is a high possibility that communication will be interrupted if the beam is blocked, and line-of-sight communication becomes the basis. Incidentally, there is a technique called multiple input multiple output (MIMO) that is a powerful spatial multiplexing technique. MIMO is a technique that uses a plurality of antennas for transmission and reception, increasing the transmission speed by the maximum number of antennas through spatial multiplexing using the same frequency resources at the same time. However, since line-of-sight communication is the basis in high-frequency bands, when the MIMO technique is applied, the spatial correlation between a plurality of transmitting and receiving antennas becomes high, making spatial multiplexing difficult.

Therefore, distributed antenna systems that have the effect of improving shielding resistance and reducing spatial correlation in high-frequency bands are being studied (refer to NPL 4 and NPL 5, for example). FIG. 37 is a diagram showing the configuration of a wireless communication system 500a, which is an example of a high-frequency band distributed antenna system. Similarly to the wireless communication system 500 in FIG. 36, the wireless communication system 500a includes five cells 100-1 to 100-5. However, unlike the wireless communication system 500, the wireless communication system 500a has a configuration in which a plurality of antennas are distributed and installed in one cell. Hereinafter, each of the plurality of antennas installed in a distributed manner will be referred to as a distributed antenna. Regarding the cell 100-1, distributed antenna devices 200a to 200a-1-4 each having one distributed antenna are installed in a distributed manner, and distributed antenna devices 200a-1-1 to 200a-1-4 are connected to one digital signal processing device 210a-1. In the wireless communication system 500a, the distributed antenna devices 200a-1-1 to 200a-1-4 and the digital signal processing device 210a-1 become a so-called base station device, and the cells 100-2 to 100-5 have a similar configuration. In the wireless communication system 500a, when one terminal station is located in the cell 100-1, for example, the terminal station will be connected by the radio waves from the plurality of distributed antenna devices 200a-1-1 to 200a-1-4.

### (Beam Selection Procedure in Distributed Antenna)

Spatial correlation is reduced and spatial multiplexing becomes possible by applying MIMO, that is, single-user MIMO, between a wireless station equipped with a plurality of antennas installed in a distributed manner, that is, distributed antennas, and one terminal station equipped with a plurality of antennas. However, it is essential to select a beam in advance in the link between each of the plurality of antennas of the wireless station and each of the plurality of antennas of the terminal station. Note that in the following description, MIMO between a wireless station equipped with distributed antennas and a terminal station equipped with a plurality of antennas is referred to as distributed MIMO.

Here, a general transmission beam selection method for performing distributed MIMO in high-frequency bands will be explained. A plurality of beam search signals in which a beam ID associated with each of a plurality of candidate beams that are discretely set in advance for each of a plurality of transmitting antennas of a wireless station and an antenna ID associated with each of a plurality of transmitting antennas are embedded as digital information are generated for each combination of a beam ID and an antenna ID. Each of the plurality of generated beam search signals is transmitted while being carried on a transmission beam that a transmitting antenna corresponding to an antenna ID included in each beam search signal transmits while temporally switching the same and that corresponds to a beam ID included in each beam search signal.

A terminal station serving as a communication partner receives a plurality of beams using each of a plurality of receiving antennas, reads a beam ID and a transmitting antenna ID included in a beam search signal of each of the plurality of received beams, and measures the reception quality of the received beam. The terminal station selects the beam ID with the best reception quality for each transmitting antenna ID, and feeds back, to the transmitting-side wireless station, data which is a combination of the transmitting antenna ID, the beam ID selected for the transmitting antenna ID, and the reception quality corresponding to the beam ID. The wireless station that has received this feedback selects a plurality of transmission beams corresponding to the number of spatial multiplexing by MIMO based on the reception quality. In addition to this, the terminal station on the communication partner side sequentially selects a plurality of reception beams by receiving-side beam selection. This enables MIMO transmission and reception between a plurality of transmission and reception beams in high-frequency bands.

It is assumed that distributed MIMO is applied to the wireless communication system 500a shown in FIG. 37. For example, when one terminal station is located in the cell 100-1, each of the plurality of distributed antenna devices 200a-1-1 to 200a-1-4 located in the cell 100-1 needs to perform a beam search to transmit a beam search signal to the terminal station, and select the beam with the best reception quality from among the plurality of beams obtained through the beam search. Therefore, in the wireless communication system 500a, overhead increases due to beam searches for the number of distributed antenna devices 200a-1-1 to 200a-1-4, and data transmission efficiency decreases. In other words, the problem is that increasing the number of distributed antenna devices 200a-1-1 to 200a-1-4 increases overhead.

To deal with this problem of increasing overhead, for example, a method of storing beam combinations selected for each of a plurality of distributed antennas and reducing the number of beam searches based on a history of beam combinations has been proposed in NPL 6.

FIGS. 38 and 39 are diagrams showing an outline of the technique disclosed in NPL 6. A wireless communication system 500b shown in FIG. 38(a) includes a cell 100 corresponding to any one of the cells 100-1 to 100-5 in the wireless communication system 500a shown in FIG. 37. In the cell 100, three distributed antenna devices 200a-1 to 200a-3 are installed in a distributed manner, and one digital signal processing device 210 is connected to the distributed antenna devices 200a-1 to 200a-3. A communication control device 220 stores a history of beam combinations selected for the plurality of distributed antenna devices 200a-1 to 200a-3. The communication control device 220 is a device that executes a method of reducing the number of beam searches based on the history of beam combinations, and is connected to the digital signal processing device 210. In the cell 100, there is one terminal device 300, which corresponds to the above-described terminal station, and moves within the cell 100.

In the high-frequency bands, a small number of paths centered on line-of-sight waves become dominant due to the large free-space propagation loss and diffraction loss and the use of beamforming. For this reason, the beam combinations that each of the distributed antenna devices 200a-1 to 200a-3 selects for distributed MIMO are limited at each location of the terminal device 300. Therefore, any one of the distributed antenna devices 200a-1 to 200a-3 transmits a beam carrying a beam search signal in all transmittable directions. Other beams of the distributed antenna devices 200a-1 to 200a-3 selected in the past in combination with one beam selected based on the beam search signal are set as candidate beams, and a partial beam search is performed only on the candidate beams. This allows the number of beam searches to be reduced. In order to perform this process of reducing the number of beam searches, the communication control device 220 performs processing in two types of modes including a storage mode of storing beam combinations selected for the distributed antenna devices 200a-1 to 200a-3, and a reference mode of reducing the number of beam searches based on a history of beam combinations. FIG. 38 is a diagram showing an outline of processing in the storage mode, and FIG. 39 is a diagram showing an outline of processing in the reference mode.

In the storage mode, the communication control device 220 instructs the digital signal processing device 210 to transmit beams carrying beam search signals to each of the distributed antenna devices 200a-1 to 200a-3 in all directions in which each distributed antenna device can perform transmission. When the terminal device 300 receives each beam carrying a beam search signal transmitted by each of the distributed antenna devices 200a-1 to 200a-3, the terminal device 300 reads the beam ID included in the beam search signal and measures the reception quality of the beam. The terminal device 300 determines which beam has the best reception quality for each of the distributed antenna devices 200a-1 to 200a-3 based on the value indicating the measured reception quality, and transmits a feedback signal enabling the communication control device 220 to uniquely identify the beam ID with the best reception quality.

When the communication control device 220 acquires the feedback signal through the distributed antenna devices 200a-1 to 200a-3 and the digital signal processing device 210, the communication control device 220 generates a record in a beam combination history table shown in FIG. 38(b) based on the acquired feedback signal. In the table shown in FIG. 38(b), “1” under the item “antenna” indicates the distributed antenna device 200a-1, “2” indicates the distributed antenna device 200a-2, and “3” indicates the distributed antenna device 200a-3. Numbers with “#” in the table indicate beam IDs. For example, the record in the first row indicates that beams with the beam IDs “#3”, “#4”, and “#5” are selected as the best beams for the distributed antenna devices 200a-1 to 200a-3, respectively. When the communication control device 220 repeatedly performs storage mode processing while the terminal device 300 moves within the cell 100, records of different combinations are added to the beam combination history table in the row direction.

In the reference mode, for example, as shown in FIG. 39(a), the communication control device 220 instructs the digital signal processing device 210 to transmit beams carrying beam search signals to the distributed antenna device 200a-1 in all transmittable directions. As a result, it is assumed that the beam with the beam ID “#3” is selected as the best beam for the distributed antenna device 200a-1. In this case, the communication control device 220 uses the beam with the beam ID “#3” of the distributed antenna device 200a-1 as a detection reference beam, and detects the beam IDs “#4” and “#5” indicating beams of distributed antenna device 200a-2 that have been selected in combination with the detection reference beam in the beam combination history table as the beam IDs indicating candidate beams as shown in FIG. 39(b). The communication control device 220 detects beam IDs “#4”, “#5”, and “#6” indicating the beams of the distributed antenna device 200a-3 that have been selected in combination with the detection reference beam as beam IDs indicating the candidate beams. The communication control device 220 instructs the digital signal processing device 210 to transmit beams of beam search signals to the distributed antenna device 200a-2 in directions corresponding to the beam IDs “#4” and “#5”. The communication control device 220 instructs the digital signal processing device 210 to transmit beams of beam search signals to the distributed antenna device 200a-3 in the directions corresponding to the beam IDs “#4”, “#5”, and “#6”. In this way, since beam searches are performed partially by narrowing down to candidate beams without performing beam searches in all directions in which the distributed antenna devices 200a-2 and 200a-3 can perform transmission, the number of beam searches can be reduced.

### CITATION LIST

### Non Patent Literature

NPL 1: Suyama Satoshi, et al., “5G multi-antenna technology.” NTT DOCOMO Technical Journal, Vol. 23, No. 4, pp. 30-39, January 2016
NPL 2: Kazuaki Takeda, et al., “Study status for technology for physical layer and high frequency band utilization in 5G,” NTT DOCOMO Technical Journal, Vol. 25, No. 3, pp. 23-32, October 2017
NPL 3: Koji Takinami, et al., “Standardization trend and element technology of millimeter wave band wireless LAN system,” IEICE communication society magazine, No. 38, Autumn issue, pp. 100-106, 2016
NPL 4: Daisei Uchida, et al., “A study of high-frequency band distributed antenna system in terminal high-density/shielded environments,” IEICE General Conference Proceedings of the Communication 1, B-5-87, p. 375, March 2020
NPL 5: Masashi Iwabuchi, et al., “Proposal of high-frequency band multi-path formation control by a large number and a variety of relay systems,” IEICE General Conference Proceedings of the Communication 1, B-5-101, pp 389, March 2020
NPL 6: Shuki Wai et al., “A method for reducing number of searches based on beam combination history in high-frequency band distributed antenna system,” IEICE Technical Report, vol. 121, No. 210, RCS2021-123, pp. 31-36, October 2021

### SUMMARY OF INVENTION

### Technical Problem

The total number of combinations of beams transmitted by the plurality of distributed antenna devices 200a-1 to 200a-3 is determined by the range where the terminal device 300 exists, the positions of the distributed antenna devices 200a-1 to 200a-3, the angular interval of discrete beams transmitted by the distributed antenna devices 200a-1 to 200a-3, and the like. Therefore, when the communication control device 220 performs processing in the storage mode, for example, in the vicinity of an area where the terminal device 300 did not exist in the past, such as the area indicated by reference numeral 400 in FIG. 40, it may not be possible to acquire candidate beams that have been previously selected in combination with a detection reference beam. In this case, since a sufficiently large number of records are not stored in the beam combination history table, appropriate beam search and beam selection may not be possible, and in such a case, the transmission capacity will be reduced. In order not to reduce the transmission capacity, for example, as shown in FIG. 41, it is conceivable to take a countermeasure such that the terminal device 300 is moved little by little at intervals that do not reduce the transmission capacity throughout the cell 100, which is a service providing area during processing performed in the storage mode so that a sufficiently large number of records are stored in the beam combination history table. Examples of methods for storing a sufficiently large number of records include a method performed by a business operator and a method performed using the user's terminal device 300.

If this is done by the business operator, there is a problem that it is very costly to move the terminal device 300 little by little throughout the cell 100, which is the service providing area, at intervals that do not reduce the transmission capacity. On the other hand, when the user's terminal device 300 is used, costs can be reduced, but there is a low possibility that the user will move in a manner ideal for the operator of the wireless communication system 500b. Therefore, when the user's terminal device 300 is used, there is a problem that it takes an enormous amount of time to obtain a sufficiently large number of records. In particular, since the beam width decreases as the carrier frequency increases, in order to avoid reduction in the transmission capacity, it is necessary to shorten the length of the intervals when moving the terminal device 300, and the time required to obtain a sufficiently large number of records will further increase.

Therefore, it is required to be able to accumulate a sufficient number of records to reduce the number of beam searches without reducing transmission capacity at the time of performing beam search processing without generating records indicating the history of beam combinations by moving a terminal device little by little in advance at intervals that do not reduce transmission capacity throughout the all service providing area. For such a problem, for example, a method of defining a search period (mode) and recording the communication quality in the search period as a history for each combination of beams is considered. For example, a method of measuring communication quality any time without providing a search period and updating a history of communication quality for each combination of beams each time measurement is performed is considered.

However, in the above-described method, it is assumed that processing is performed while fixing the order of radio stations (overhanging stations) and distributed antenna devices that perform beam searches. In beam search in which the processing order is fixed as described above, even if the beam search is repeated, there is a possibility that a combination of beams to be searched is fixed in a state of being separated from a combination of beams which actually obtain the best quality.

In view of the above-mentioned circumstances, an object of the present invention is to provide a technique capable of reducing the number of beam searches while preventing a combination of beams to be searched from being fixed in beam searches in a distributed antenna system.

### Solution to Problem

One aspect of the present invention is a communication control device including: a candidate beam detection unit configured to cause each of a plurality of distributed antennas to perform an all-beam search performed by transmitting beams in all transmittable directions in a beam search period for searching for a beam to be used for wireless communication with a terminal device in a different order of the distributed antennas for each beam search period, to stop the all-beam search when one beam identifier indicating a best beam has been acquired among beams according to the all-beam search, to set a beam identified by the acquired beam identifier and information indicating the distributed antenna that has transmitted the beam indicated by the beam identifier as a detection reference beam, and to detect a beam identifier of the distributed antenna that has not performed the all-beam search in the beam search period, the beam identifier corresponding to a beam that has been selected together with the detection reference beam, as a candidate beam identifier for the distributed antenna from a beam combination history storage unit; a beam search execution determination unit configured to determine whether or not to cause the distributed antenna that has not performed the all-beam search in the beam search period to perform the all-beam search on the basis of detection results from the candidate beam detection unit; and a beam combination recording unit configured to generate a record indicating a combination of beam identifiers indicating beams determined to be best beams in the respective distributed antennas in the beam search period and to record the generated record in the beam combination history storage unit.

One aspect of the present invention is a wireless communication system including a terminal device, a plurality of distributed antenna devices each including one distributed antenna, and a communication control device, wherein the communication control device includes: a candidate beam detection unit configured to cause each of a plurality of distributed antennas to perform an all-beam search performed by transmitting beams in all transmittable directions in a beam search period for searching for a beam to be used for wireless communication with a terminal device in a different order of the distributed antennas for each beam search period, to stop the all-beam search when one beam identifier indicating a best beam has been acquired among beams according to the all-beam search, to set a beam identified by the acquired beam identifier and information indicating the distributed antenna that has transmitted the beam indicated by the beam identifier as a detection reference beam, and to detect a beam identifier of the distributed antenna that has not performed the all-beam search in the beam search period, the beam identifier corresponding to a beam that has been selected together with the detection reference beam, as a candidate beam identifier for the distributed antenna from a beam combination history storage unit; a beam search execution determination unit configured to determine whether or not to cause the distributed antenna that has not performed the all-beam search in the beam search period to perform the all-beam search on the basis of detection results from the candidate beam detection unit; and a beam combination recording unit configured to generate a record indicating a combination of beam identifiers indicating beams determined to be best beams in the respective distributed antennas in the beam search period and to record the generated record in the beam combination history storage unit.

One aspect of the present invention is a communication control method including: a candidate beam detection step of causing each of a plurality of distributed antennas to perform an all-beam search performed by transmitting beams in all transmittable directions in a beam search period for searching for a beam to be used for wireless communication with a terminal device in a different order of the distributed antennas for each beam search period, stopping the all-beam search when one beam identifier indicating a best beam is acquired among beams according to the all-beam search, setting a beam identified by the acquired beam identifier and information indicating the distributed antenna that has transmitted a beam indicated by the beam identifier as a detection reference beam, and detecting a beam identifier of the distributed antenna that has not performed the all-beam search in the beam search period, the beam identifier corresponding to a beam that has been selected together with the detection reference beam, as a candidate beam identifier for the distributed antenna from a beam combination history storage unit; a beam search execution determination step of determining whether or not to cause the distributed antenna that has not performed the all-beam search in the beam search period to perform the all-beam search on the basis of detection results from the candidate beam detection unit; and a beam combination recording step of generating a record indicating a combination of beam identifiers indicating beams determined to be best beams in the respective distributed antennas in the beam search period and recording the generated record in the beam combination history storage unit.

One aspect of the present invention is a program for causing a computer to execute: a candidate beam detection step of causing each of a plurality of distributed antennas to perform an all-beam search performed by transmitting beams in all transmittable directions in a beam search period for searching for a beam to be used for wireless communication with a terminal device in a different order of the distributed antennas for each beam search period, stopping the all-beam search when one beam identifier indicating a best beam is acquired among beams according to the all-beam search, setting a beam identified by the acquired beam identifier and information indicating the distributed antenna that has transmitted a beam indicated by the beam identifier as a detection reference beam, and detecting a beam identifier of the distributed antenna that has not performed the all-beam search in the beam search period, the beam identifier corresponding to a beam that has been selected together with the detection reference beam, as a candidate beam identifier for the distributed antenna from a beam combination history storage unit; a beam search execution determination step of determining whether or not to cause the distributed antenna that has not performed the all-beam search in the beam search period to perform the all-beam search on the basis of detection results from the candidate beam detection unit; and a beam combination recording step of generating a record indicating a combination of beam identifiers indicating beams determined to be best beams in the respective distributed antennas in the beam search period and recording the generated record in the beam combination history storage unit.

### Advantageous Effects of Invention

According to the present invention, it is possible to reduce the number of beam searches while preventing a combination of beams to be searched from being fixed in beam searches in a distributed antenna system.

### BRIEF DESCRIPTION OF DRAWINGS

FIG. 1 is a block diagram showing a configuration of a wireless communication system of a first embodiment.

FIG. 2 is a block diagram showing an internal configuration of a communication control device and a connection relationship between the communication control device and a digital signal processing device of the first embodiment.

FIG. 3 is a diagram showing a data format of a beam count table stored in a beam search execution instruction unit of the first embodiment.

FIG. 4 is a diagram showing a data format of a beam combination history table stored in a beam combination history storage unit of the first embodiment.

FIG. 5 is a block diagram showing an internal configuration of a terminal device of the first embodiment.

FIG. 6 is a flowchart (part 1) showing a flow of processing performed by the terminal device of the first embodiment.

FIG. 7 is a flowchart (part 2) showing the flow of processing performed by the terminal device of the first embodiment.

FIG. 8 is a flowchart showing the overall flow of processing performed by the wireless communication system of the first embodiment.

FIG. 9 is a flowchart showing a flow of beam combination generation processing of the first embodiment.

FIG. 10 is a flowchart showing a flow of beam search processing of the first embodiment.

FIG. 11 is a flowchart showing a flow of subroutine processing of all-beam search execution determination executed in the beam search processing of the first embodiment.

FIG. 12 is a diagram showing an outline of processing performed in the wireless communication system of the first embodiment.

FIG. 13 is a block diagram showing an internal configuration of a communication control device and a connection relationship between the communication control device and a digital signal processing device of a second embodiment.

FIG. 14 is a diagram showing a data format of a beam combination history table stored in a beam combination history storage unit of the second embodiment.

FIG. 15 is a flowchart showing a flow of beam search processing of the second embodiment.

FIG. 16 is a flowchart showing a flow of subroutine processing of all-beam search execution determination executed in the beam search processing of the second embodiment.

FIG. 17 is a block diagram showing an internal configuration of a communication control device and a connection relationship between the communication control device and a digital signal processing device of a third embodiment.

FIG. 18 is a flowchart showing a flow of beam search processing of the third embodiment.

FIG. 19 is a block diagram showing an internal configuration of a communication control device and a connection relationship between the communication control device and a digital signal processing device of a fourth embodiment.

FIG. 20 is a flowchart showing a flow of beam search processing of the fourth embodiment.

FIG. 21 is a block diagram showing an internal configuration of a communication control device and a connection relationship between the communication control device and a digital signal processing device of a fifth embodiment.

FIG. 22 is a flowchart showing a flow of beam search processing of the fifth embodiment.

FIG. 23 is a block diagram showing an internal configuration of a communication control device and a connection relationship between the communication control device and a digital signal processing device of a sixth embodiment.

FIG. 24 is a flowchart showing a flow of beam search processing of the sixth embodiment.

FIG. 25 is a block diagram showing an internal configuration of a communication control device and a connection relationship between the communication control device and a digital signal processing device of a seventh embodiment.

FIG. 26 is a flowchart showing a flow of beam search processing of the seventh embodiment.

FIG. 27 is a block diagram showing an internal configuration of a terminal device of the seventh embodiment.

FIG. 28 is a flowchart (part 1) showing a flow of processing performed by the terminal device of the seventh embodiment.

FIG. 29 is a flowchart (part 2) showing the flow of processing performed by the terminal device of the seventh embodiment.

FIG. 30 is a block diagram showing an internal configuration of a communication control device and a connection relationship between the communication control device and a digital signal processing device of an eighth embodiment.

FIG. 31 is a flowchart showing a flow of beam search processing of the eighth embodiment.

FIG. 32 is a block diagram showing an internal configuration of a communication control device and a connection relationship between the communication control device and a digital signal processing device of a ninth embodiment.

FIG. 33 is a flowchart showing a flow of subroutine processing of all-beam search execution determination executed in the beam search processing of the ninth embodiment.

FIG. 34 is a block diagram showing an internal configuration of a communication control device and a connection relationship between the communication control device and a digital signal processing device of a tenth embodiment.

FIG. 35 is a flowchart showing a flow of subroutine processing of all-beam search execution determination executed in the beam search processing of the tenth embodiment.

FIG. 36 is a block diagram showing a configuration of a conventional general wireless communication system.

FIG. 37 is a block diagram showing a configuration of an example of a high-frequency band distributed antenna system.

FIG. 38 is a diagram (part 1) for describing an outline of the technique disclosed in NPL 6.

FIG. 39 is a diagram (part 2) for explaining an outline of the technique disclosed in NPL 6.

FIG. 40 is a diagram (part 1) for describing problems in the technique disclosed in NPL 6.

FIG. 41 is a diagram (part 2) for explaining the problem in the technique disclosed in NPL 6.

### DESCRIPTION OF EMBODIMENTS

### First Embodiment

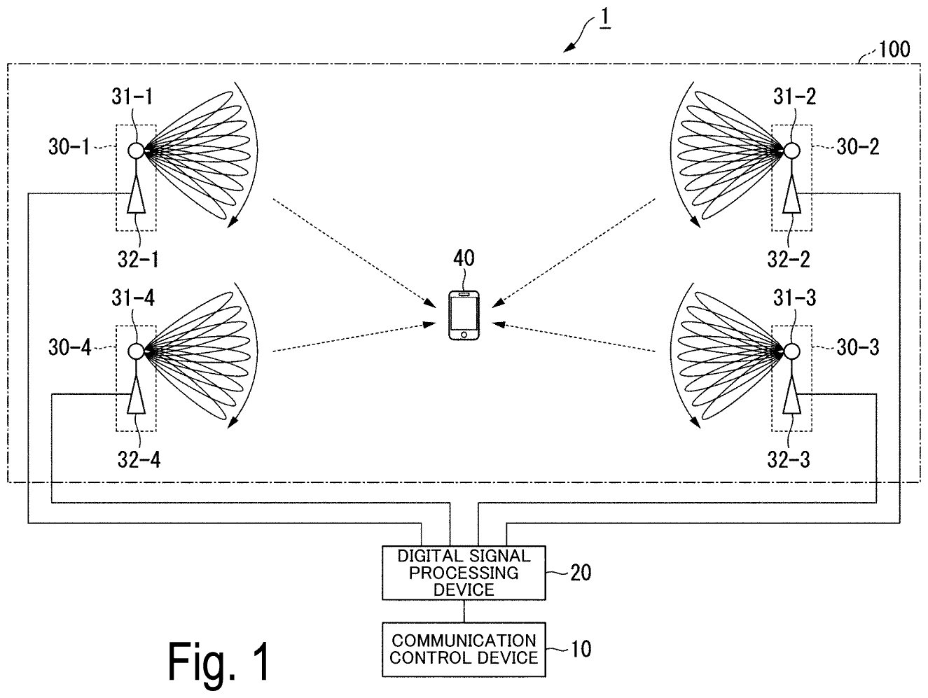

Hereinafter, an embodiment of the present invention will be described with reference to the drawings. FIG. 1 is a block diagram showing an example of the configuration of a wireless communication system 1 in a first embodiment. The wireless communication system 1 includes at least one cell 100. Distributed antenna devices 30-1, 30-2, 30-3, and 30-4 and a terminal device 40 are provided within the area of the cell 100. The wireless communication system 1 includes a communication control device 10 and a digital signal processing device 20. The communication control device 10 is connected to the digital signal processing device 20. The digital signal processing device 20 is connected to each of the distributed antenna devices 30-1 to 30-4. The communication control device 10, the digital signal processing device 20, and the distributed antenna devices 30-1 to 30-4 constitute a so-called base station device.

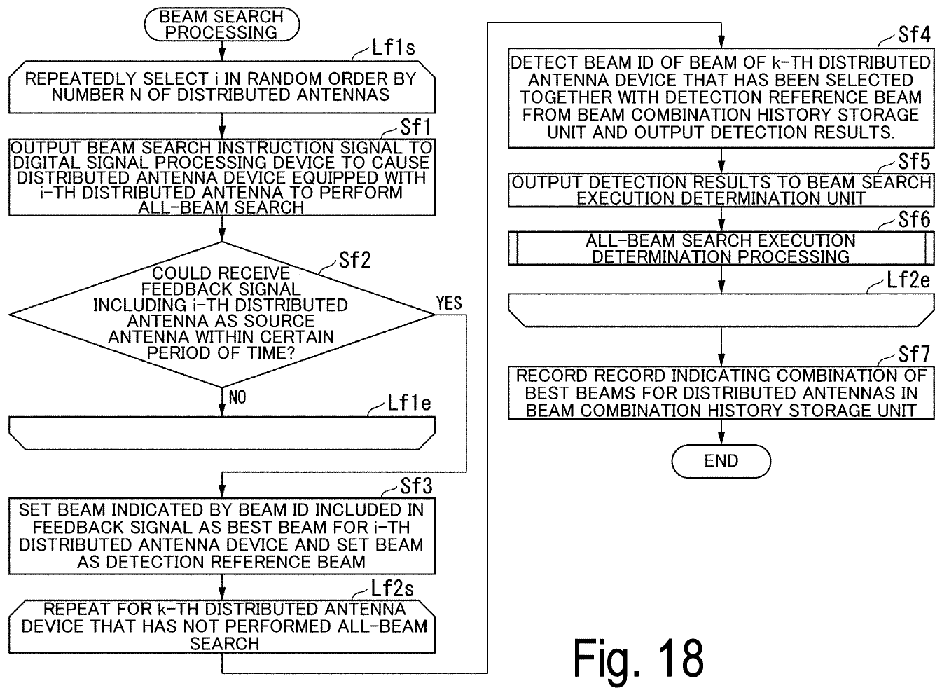

Note that the wireless communication system 1 shown in FIG. 1 is an exemplary configuration, and the wireless communication system 1 may be configured such that a plurality of distributed antenna devices 30-1 to 30-N are provided in the cell 100, and the digital signal processing device 20 is connected to each of the distributed antenna devices 30-1 to 30-N. Here, N is an integer of 2 or more. The wireless communication system 1 may have a configuration as shown in FIG. 18, that is, a configuration including a plurality of cells 100, and in this case, the wireless communication system 1 includes as many digital signal processing devices 20 and communication control devices 10 as the number of cells 100, each of the communication control devices 10 is connected to a corresponding digital signal processing device 20, and each of the digital signal processing devices 20 is connected to the distributed antenna devices 30-1 to 30-N in the corresponding cell 100.

Each of the distributed antenna devices 30-1 to 30-4 is capable of beamforming in which beams of radio waves are formed while switching directions, and is connected to the terminal device 40 by radio waves. Note that although FIG. 1 shows an example in which the distributed antenna devices 30-1 to 30-4 form beams in nine directions, the number of directions in which the distributed antenna devices 30-1 to 30-4 can form beams may be two or more. The maximum number of directions in which the distributed antenna devices 30-1 to 30-4 can form beams is determined in advance by the specifications of the distributed antenna devices 30-1 to 30-4, and the operator may be able to arbitrarily determine the number of beams. The distributed antenna devices 30-1 to 30-4 include distributed antennas 31-1 to 31-4 and main devices 32-1 to 32-4, respectively. Each of the distributed antennas 31-1 to 31-4 is given a distributed antenna ID in advance that allows each distributed antenna to be uniquely identified.

The main devices 32-1 to 32-4 transmit and receive radio-frequency analog signals through the distributed antennas 31-1 to 31-4 connected to the main devices 32-1 to 32-4, respectively. That is, each of the main devices 32-1 to 32-4 modulates a carrier wave on the basis of a digital signal of transmission data output by the digital signal processing device 20 to generate a radio-frequency analog signal. The main devices 32-1 to 32-4 transmit generated analog signals using radio waves from the distributed antennas 31-1 to 31-4 connected to the main devices 32-1 to 32-4. The main devices 32-1 to 32-4 demodulate the analog signals that the distributed antennas 31-1 to 31-4 connected thereto output by receiving radio waves into digital signals. The main devices 32-1 to 32-4 output the converted digital signals to the digital signal processing device 20.

From the perspective of beamforming, each of the main devices 32-1 to 32-4 receives a digital signal of a beam search signal as transmission data output by the digital signal processing device 20. Each of the main devices 32-1 to 32-4 modulates a carrier wave on the basis of the beam search signal to form a beam in a direction corresponding to a beam ID included in the received beam search signal. The main devices 32-1 to 32-4 transmit radio-frequency analog signals carrying beam search signals generated by modulation through the distributed antennas 31-1 to 31-4 connected thereto.

Here, a beam ID is, for example, an identifier in which a character string “beam ID #” is added to a continuous integer value starting from 1, and is an identifier determined in advance for each of the distributed antenna devices 30-1 to 30-4. For example, if the distributed antenna device 30-1 can form beams in 40 different directions, beam IDs “beam ID #1” to “beam ID #40” are fixedly assigned in advance to the beams in 40 directions, and data indicating the correspondence between the beam IDs and the directions is stored in advance in a storage area inside the main device 32-1. In other words, when “beam ID #1” is designated by the beam search signal for the main device 32-1 of the distributed antenna device 30-1, the direction of the beam formed by the distributed antenna 31-1 of the distributed antenna device 30-1 will be uniquely determined. This also applies to the other distributed antenna devices 30-2 to 30-4, and in this case, the same beam ID may be present in the distributed antenna devices 30-1 to 30-4.

The digital signal processing device 20 outputs a digital signal of transmission data to the main devices 32-1 to 32-4. Upon receiving a beam search instruction signal from the communication control device 10, the digital signal processing device 20 sets a distributed antenna ID included in the beam search instruction signal as a source antenna ID, and generates a beam search signal including the source antenna ID and the beam ID included in the beam search instruction signal. The digital signal processing device 20 outputs the generated beam search signal to the main devices 32-1 to 32-4 corresponding to the distributed antenna ID included in the beam search instruction signal. As a result, the terminal device 40 that receives the beam carrying the beam search signal can identify the source distributed antennas 31-1 to 31-4 of the beam search signal by referring to the source antenna ID included in the beam search signal and can identify the beam carrying the beam search signal by referring to the beam ID included in the beam search signal.

The digital signal processing device 20 detects reception data included in the digital signals output by the main devices 32-1 to 32-4. If the detected reception data is a feedback signal transmitted by the terminal device 40 on radio waves, the digital signal processing device 20 outputs the feedback signal to the communication control device 10.

### (Configuration of Communication Control Device of First Embodiment)

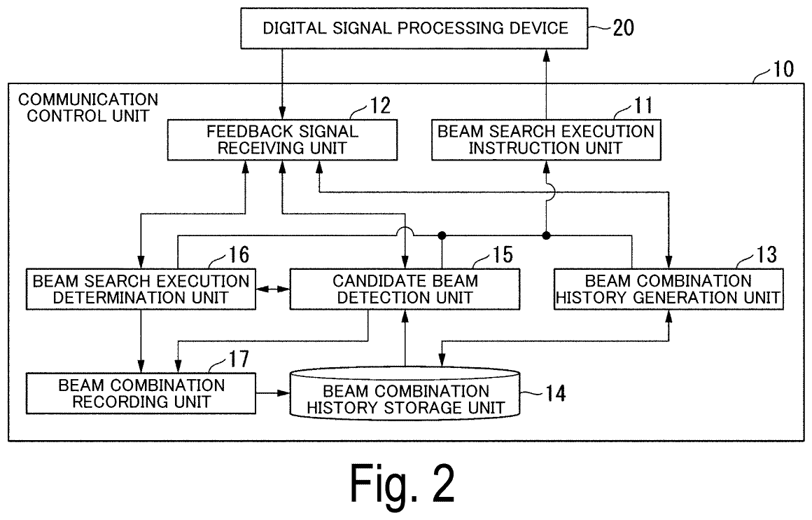

As shown in FIG. 2, the communication control device 10 includes a beam search execution instruction unit 11, a feedback signal receiving unit 12, a beam combination history generation unit 13 (a beam combination history generator), a beam combination history storage unit 14, a candidate beam detection unit 15 (a candidate beam detector), a beam search execution determination unit 16 (a beam search execution determiner), and a beam combination recording unit 17 (a beam combination recorder).

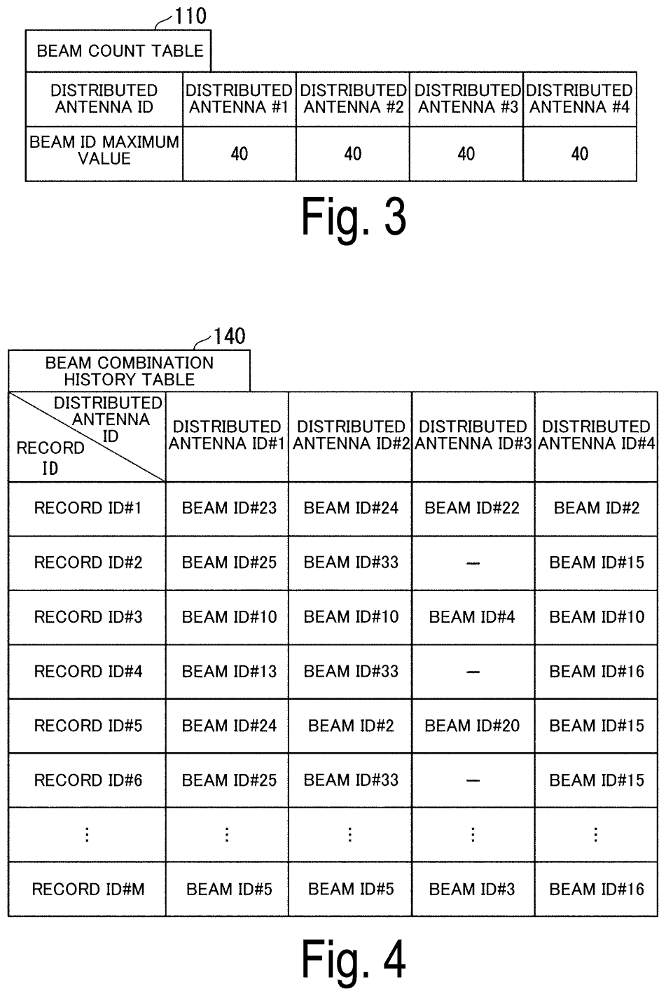

The beam search execution instruction unit 11 causes each of the distributed antenna devices 30-1 to 30-4, via the digital signal processing device 20, to perform an all-beam search for transmitting beams while switching time in each of all directions in which each distributed antenna device can transmit beams or perform a partial beam search for transmitting beams while switching time in one or more specific directions. The beam search execution instruction unit 11 has a beam count table 110 shown in FIG. 3 stored in an internal storage area in advance. The beam count table 110 has items of “distributed antenna ID” and “beam ID maximum value”. In the “distributed antenna ID” item, “distributed antenna ID #1,” “distributed antenna ID #2,” “distributed antenna ID ID #3,” and “distributed antenna ID #4” which are assigned to the distributed antennas 31-1 to 31-4 are written in advance. Here, “distributed antenna ID #1” corresponds to the distributed antenna ID assigned to the distributed antenna 31-1, “distributed antenna ID #2” corresponds to the distributed antenna ID assigned to the distributed antenna 31-2, “distributed antenna ID #3” corresponds to the distributed antenna ID assigned to the distributed antenna 31-3, and “distributed antenna ID #4” corresponds to the distributed antenna ID assigned to the distributed antenna 31-4.

In the “beam ID maximum value” item, the maximum value of the beam ID for each of the distributed antennas 31-1 to 31-4, that is, the number of transmission directions in which each of the distributed antennas 31-1 to 31-4 can transmit beams, is written in advance. Note that in FIG. 3, the values of the “beam ID maximum value” of the distributed antennas 31-1 to 31-4 are all “40”, but they may be different values.

Upon receiving an all-beam search request signal including a distributed antenna ID, the beam search execution instruction unit 11 refers to the beam count table 110 to read a beam ID maximum value corresponding to the distributed antenna ID included in the all-beam search request signal. The beam search execution instruction unit 11 generates a number of beam search instruction signals corresponding to the read beam ID maximum value, the beam search instruction signals each including one beam ID between 1 and the beam ID maximum value such that the beam IDs included therein are all different beam IDs. The beam search execution instruction unit 11 writes the distributed antenna ID included in the all-beam search request signal into each of the generated beam search instruction signals.

For example, when an all-beam search request signal in which the distributed antenna ID is “distributed antenna ID #1” is received, the beam search execution instruction unit 11 generates 40 beam search instruction signals. More specifically, since the beam search execution instruction unit 11 generates “beam ID #1” to “beam ID #40,” each of the generated 40 beam search instruction signals includes (“distributed antenna ID #1,” “beam ID #1”), (“distributed antenna ID #1,” “beam ID #2”), . . . , and (“distributed antenna ID #1,” “beam ID #40”). Note that, as described above, “beam ID #1” to “beam ID #40” generated by the beam search execution instruction unit 11 are fixedly associated with the beams in the 40 directions formed by the distributed antenna 31-1 in the main device 32-1 of the distributed antenna device 30-1. Therefore, beam ID generation processing performed by the beam search execution instruction unit 11 involves just generating a number of beam IDs for all directions rather than generating a new beam ID and associating the beam ID with the direction of the beam transmitted by the distributed antenna device 30-1.

Upon receiving a partial beam search request signal including a distributed antenna ID and one or more beam IDs, the beam search execution instruction unit 11 generates a number of beam search instruction signals corresponding to the number of beam IDs included in the partial beam search request signal. The beam search execution instruction unit 11 writes the beam IDs included in the partial beam search request signal one by one into the beam search instruction signals such that the beam IDs included in each of the generated beam search instruction signals are all different beam IDs. The beam search execution instruction unit 11 writes the distributed antenna ID included in the partial beam search request signal into each of the generated beam search instruction signals. The beam search execution instruction unit 11 outputs the beam search instruction signals generated by receiving the all-beam search request signal or the partial beam search request signal one by one to the digital signal processing device 20 in the order of generation at predetermined fixed time intervals.

When beam combination generation processing for generating beam combinations is started, the beam combination history generation unit 13 causes all of the distributed antenna devices 30-1 to 30-4 to perform all-beam searches in each trial cycle, thereby generating a record indicating a combination of beam IDs indicating beam determined to be the best beams for the distributed antenna devices 30-1 to 30-4.

The beam combination history storage unit 14 stores, for example, a beam combination history table 140 shown in FIG. 4. As shown in FIG. 4, the beam combination history table 140 has an item “distributed antenna ID” on the horizontal axis and an item “record ID” on the vertical axis. In the “distributed antenna ID” item, “distributed antenna ID #1”, “distributed antenna ID #2”, “distributed antenna ID ID #3”, and “distributed antenna ID #4” which are distributed antenna IDs assigned to the distributed antennas 31-1 to 31-4 are written in advance.

In the “record” item, record IDs that are assigned to records generated in each trial cycle and are different identifiers are written. For example, “record ID #1” is a record ID assigned to a record generated in the first trial cycle, and “record ID #2” is a record ID assigned to a record generated in the second trial cycle. Information indicating a beam ID is written in each element identified by the distributed antenna ID on the horizontal axis and the record ID on the vertical axis. In other words, “beam ID #23” of “record 1” element of “distributed antenna ID #1” indicates that the beam ID indicating the beam determined to be the best beam for the distributed antenna device 30-1 in the first trial cycle is “beam ID #23.”

Upon receiving an output destination switching instruction signal, the feedback signal receiving unit 12 sets any one of the beam combination history generation unit 13, candidate beam detection unit 15, and beam search execution determination unit 16 designated by the output destination switching instruction signal as the output destination of the feedback signal. When the feedback signal receiving unit 12 receives a feedback signal output from the digital signal processing device 20, the feedback signal receiving unit 12 outputs the received feedback signal to the set output destination.

When beam search processing for searching for a beam is started, the candidate beam detection unit 15 causes the distributed antenna devices 30-1 to 30-4 to sequentially perform all-beam searches one by one. That is, the candidate beam detection unit 15 sequentially designates the distributed antenna IDs of the distributed antennas 31-1 to 31-4 one by one, and outputs an all-beam search request signal including designated one distributed antenna ID to the beam search execution instruction unit 11. When the candidate beam detection unit 15 receives the first feedback signal after the beam search processing is started, the candidate beam detection unit 15 stops the all-beam search and sets the beam identified by a beam ID and a source antenna ID included in the feedback signal as a detection reference beam. The candidate beam detection unit 15 detects, from the beam combination history table 140, the beam IDs of the distributed antenna devices 30-1 to 30-4 that have not performed the all-beam searches during a beam search period, the beam IDs corresponding to the beams that have been selected together with the detection reference beam, and the distributed antenna IDs corresponding to the beam IDs. Here, the beam search period is, for example, the time allocated to one beam search processing. The beam search processing is processing that is performed periodically, and this period is referred to as a beam search period. Each beam search period includes a beam search period in which one beam search processing is performed, and a period of data transmission performed between the distributed antennas 31-1 to 31-4 of the distributed antenna devices 30-1 to 30-4 and terminal antennas 41-1 to 41-M of the terminal device 40 after the beam search period. In addition, the aforementioned “beam search period” and “beam search period” which will be described below refer to one beam search period included in one beam search period, unless otherwise stated. The candidate beam detection unit 15 sets detected beam IDs as beam IDs (hereinafter also referred to as candidate beam IDs) indicating candidate beams in the distributed antenna devices 30-1 to 30-4 corresponding to the detected distributed antenna IDs and outputs a combination of the detected distributed antenna IDs and candidate beam IDs as detection results.

The beam search execution determination unit 16 determines whether or not to cause the distributed antenna devices 30-1 to 30-4, which have not performed all-beam searches in the beam search period, to perform all-beam searches on the basis of the detection results from the candidate beam detection unit 15. More specifically, the beam search execution determination unit 16 determines the distributed antenna devices 30-1 to 30-4 which have not performed the all-beam searches in the beam search period and have candidate beam IDs that are not included in the detection results from the candidate beam detection unit 15 as distributed antenna devices 30-1 to 30-4 to be caused to perform the all-beam search.

The beam search execution determination unit 16 causes the distributed antenna devices 30-1 to 30-4 having candidate beam IDs included in the detection results from the candidate beam detection unit 15 to perform a partial beam search based on the candidate beam IDs included in the detection results. That is, the beam search execution determination unit 16 outputs a partial beam search request signal including the distributed antenna IDs included in the detection results and the candidate beam IDs to the beam search execution instruction unit 11. The beam search execution determination unit 16 determines, on the basis of a reception power value included in a feedback signal transmitted by the terminal device 40 that has received beams according to the partial beam search and a predetermined threshold, whether or not to cause the distributed antenna devices 30-1 to 30-4 corresponding to source antenna IDs included in the feedback signal to perform all-beam searches. Upon determining that the all-beam search is to be performed, the beam search execution determination unit 16 designates a source antenna ID included in the feedback signal that is a determination target. The beam search execution determination unit 16 outputs an all-beam search request signal including the designated source antenna ID to the beam search execution instruction unit 11.

The beam combination recording unit 17 generates one record on the basis of the combination of the beam ID of the beam finally determined to be the best beam in each of the distributed antenna devices 30-1 to 30-4 in the beam search period and the source antenna ID corresponding to the beam ID. The beam combination recording unit 17 assigns a new record ID to the generated record and writes it into the beam combination history table 140.

### (Configuration of Terminal Device of First Embodiment)

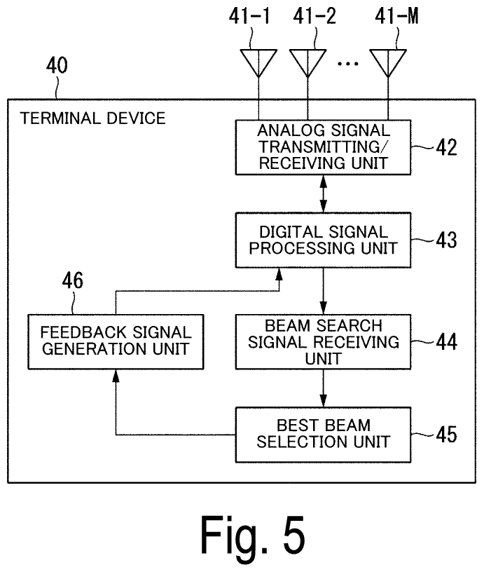

FIG. 5 is a block diagram showing the configuration of the terminal device 40. The terminal device 40 includes M terminal antennas 41-1 to 41-M, an analog signal transmitting/receiving unit 42, a digital signal processing unit 43, a beam search signal receiving unit 44, a best beam selection unit 45, and a feedback signal generation unit 46. Here, M is an integer of 2 or more. Wireless communication using distributed MIMO is performed between the terminal antennas 41-1 to 41-M and the distributed antennas 31-1 to 31-4 included in the distributed antenna devices 30-1 to 30-4.

The analog signal transmitting/receiving unit 42 generates a radio-frequency analog signal by modulating a carrier wave on the basis of a digital signal of transmission data output by the digital signal processing unit 43. The analog signal transmitting/receiving unit 42 transmits the generated analog signal using radio waves through the terminal antennas 41-1 to 41-M. The analog signal transmitting/receiving unit 42 demodulates analog signals output by the terminal antennas 41-1 to 41-M receiving radio waves and converts them into digital signals. The analog signal transmitting/receiving unit 42 outputs the converted digital signals to the digital signal processing unit 43. The analog signal transmitting/receiving unit 42 measures reception power of beams received by the terminal antennas 41-1 to 41-M. The analog signal transmitting/receiving unit 42 associates a reception power value obtained through the measurement with a digital signal corresponding to a beam to be measured, and outputs it to the digital signal processing unit 43.

The digital signal processing unit 43 outputs a digital signal of a feedback signal output by the feedback signal generation unit 46 to the analog signal transmitting/receiving unit 42. The digital signal processing unit 43 receives the digital signal output from the analog signal transmitting/receiving unit 42 and the reception power value associated with the digital signal. The digital signal processing unit 43 associates the received reception power value with a beam search signal included as reception data in the received digital signal, and outputs it to the beam search signal receiving unit 44.

The beam search signal receiving unit 44 receives the beam search signal output by the digital signal processing unit 43 and the reception power value associated with the beam search signal. The beam search signal receiving unit 44 combines the source antenna ID and beam ID included in the received beam search signal and the received reception power value, and writes and stores the combination in an internal storage area as one set of data. When the beam search signal receiving unit 44 receives all beam search signals for any one of the distributed antenna devices 30-1 to 30-4, the beam search signal receiving unit 44 detects and reads all pieces of data including the source antenna IDs corresponding to the distributed antenna devices 30-1 to 30-4 that have received all the beam search signals among the pieces of data stored in the internal storage area. The beam search signal receiving unit 44 outputs all the read data to the best beam selection unit 45 as one set of data.

The best beam selection unit 45 receives the one set of data output by the beam search signal receiving unit 44. The best beam selection unit 45 selects data corresponding to the maximum reception power value from among the received set of data. In other words, the best beam selection unit 45 selects the beam indicated by the beam ID corresponding to the selected maximum reception power value as the best beam for the distributed antenna devices 30-1 to 30-4 corresponding to the source antenna ID. The best beam selection unit 45 outputs the source antenna ID, beam ID, and reception power value included in the selected data to the feedback signal generation unit 46. The feedback signal generation unit 46 generates a feedback signal including the source antenna ID, beam ID, and reception power value output by the best beam selection unit 45. The feedback signal generation unit 46 outputs the generated feedback signal to the digital signal processing unit 43.

### (Processing Performed by Terminal Device of First Embodiment)

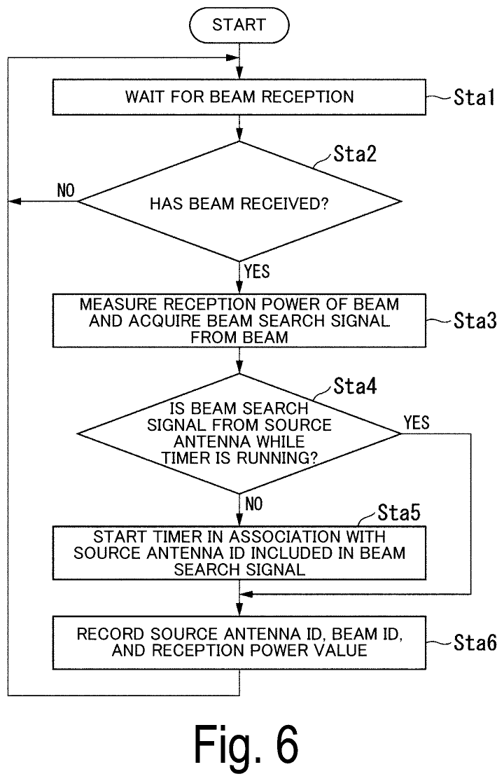

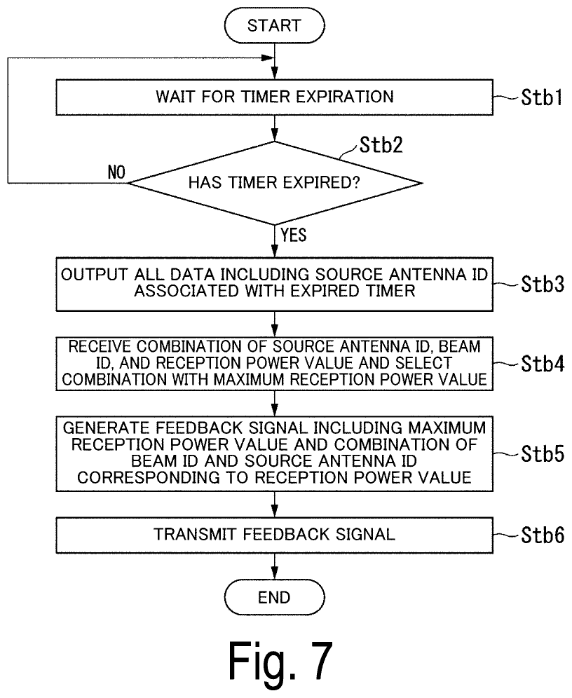

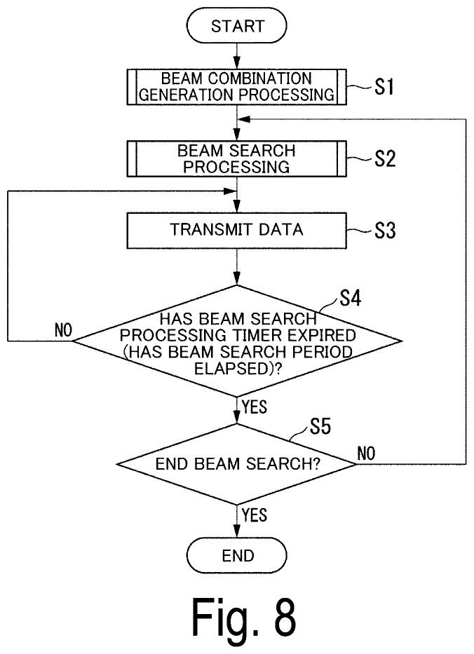

Processing performed by the terminal device 40 will be described with reference to FIGS. 6 and 7. FIG. 6 is a flowchart showing a flow of processing performed when the terminal device 40 receives beams transmitted by the distributed antenna devices 30-1 to 30-4.

The analog signal transmitting/receiving unit 42 waits for reception of beams transmitted by the distributed antennas 31-1 to 31-4 of the distributed antenna devices 30-1 to 30-4 (step Sta1), and repeatedly determines whether beams have been received through the terminal antennas 41-1 to 41-M (step Sta2). When the analog signal transmitting/receiving unit 42 determines that beams are not received (No in step Sta2), the analog signal transmitting/receiving unit 42 continues to perform the processing of step Sta1, that is, waits for beam reception.

On the other hand, when the analog signal transmitting/receiving unit 42 determines that beams have been received (Yes in step Sta2), the analog signal transmitting/receiving unit 42 measures reception power of the beams received through the terminal antennas 41-1 to 41-M. The analog signal transmitting/receiving unit 42 converts the received beam into a digital signal. The analog signal transmitting/receiving unit 42 associates the reception power value obtained through measurement with a digital signal obtained through conversion, and outputs the digital signal to the digital signal processing unit 43. The digital signal processing unit 43 receives the digital signal output from the analog signal transmitting/receiving unit 42 and the reception power value associated with the digital signal. The digital signal processing unit 43 acquires a beam search signal included in the digital signal as reception data by detecting reception data from the received digital signal. The digital signal processing unit 43 associates the received reception power value with the acquired beam search signal and outputs the beam search signal to the beam search signal receiving unit 44.

The beam search signal receiving unit 44 receives the beam search signal output from digital signal processing unit 43 and the reception power value associated with the beam search signal. The beam search signal receiving unit 44 reads the beam ID and the source antenna ID included in the received beam search signal (step Sta3).

The beam search signal receiving unit 44 is capable of generating a plurality of timers internally, and determines whether or not the read source antenna ID is associated with any of the timers (step Sta4). If the beam search signal receiving unit 44 determines that the read source antenna ID is not associated with any timer (No in step Sta4), the beam search signal receiving unit 44 generates one timer in association with the read source antenna ID and starts the timer. When starting the timer, the beam search signal receiving unit 44 sets, in the timer, the time required for the distributed antenna device 30-1 to 30-4 that transmits the largest number of beams to transmit all beams. Note that the time is assumed to be a predetermined time (step Sta5).

On the other hand, if the beam search signal receiving unit 44 determines that the read source antenna ID is associated with any timer (Yes in step Sta4), or after the processing in step Sta5, the beam search signal receiving unit 44 combines the read source antenna ID and beam ID with the received reception power value into one set of data, and writes and stores the one set of data in an internal storage area (step Sta6). Thereafter, processing after step Sta1 is repeated.

In other words, regarding the determination processing in step Sta4 above, the beam search signal receiving unit 44 determines in the determination processing whether the received beam search signal is the first beam search signal in the all-beam search or the partial beam search performed by each of the distributed antenna devices 30-1 to 30-4 based on whether the timer is started. If a timer is not generated in association with the source antenna ID included in the beam search signal received by the beam search signal receiving unit 44, the beam search signal is the first beam search signal, and if the timer is generated, the beam search signal is the second or subsequent beam search signal.

FIG. 7 is a flowchart showing a flow of processing performed when the timer started by the beam search signal receiving unit 44 has expired. The beam search signal receiving unit 44 waits for the timer started in the processing of step Sta5 in FIG. 6 to expire. It is assumed that the timer outputs a timer expiration notification signal when the time being measured reaches a set time and the timer expires (step Stb1).

The beam search signal receiving unit 44 repeatedly determines whether or not a timer expiration notification has been received from any timer (step Stb2), and if it is determined that a timer expiration notification is not received (No in step Stb2), the beam search signal receiving unit 44 continues the processing of step Stb1, that is, waits for the timer to expire. On the other hand, if the beam search signal receiving unit 44 determines that a timer expiration notification has been received from any timer (Yes in step Stb2), the beam search signal receiving unit 44 acquires the source antenna ID associated with the expired timer and erases the timer. The beam search signal receiving unit 44 detects and reads all pieces of data including the acquired source antenna ID, that is, data which is a combination of the source antenna ID, the beam ID, and the reception power value, from among the data stored in the internal storage area. After reading, the beam search signal receiving unit 44 deletes the read data from the internal storage area. The beam search signal receiving unit 44 outputs all the read data to the best beam selection unit 45 as one set of data (step Stb3).

The best beam selection unit 45 receives one set of data output by the beam search signal receiving unit 44. The best beam selection unit 45 selects data including the maximum reception power value from among the received set of data (step Stb4). The best beam selection unit 45 outputs the source antenna ID, beam ID, and reception power value included in the selected data to the feedback signal generation unit 46. The feedback signal generation unit 46 receives the source antenna ID, beam ID, and reception power value output by the best beam selection unit 45, and generates a feedback signal including the received source antenna ID, beam ID, and reception power value. The feedback signal generation unit 46 outputs the generated feedback signal to the digital signal processing unit 43 (step Stb5).

In the first embodiment, the feedback signal generation unit 46 does not necessarily include the reception power value in the feedback signal. The feedback signal generation unit 46 may generate a feedback signal including the received source antenna ID and beam ID. Similarly to third, fifth, seventh, and ninth embodiments which will be described later, the feedback signal generation unit 46 does not necessarily include the reception power value in the feedback signal.

The digital signal processing unit 43 receives the feedback signal output from the feedback signal generation unit 46. The digital signal processing unit 43 outputs the received feedback signal to the analog signal transmitting/receiving unit 42. The analog signal transmitting/receiving unit 42 generates a radio-frequency analog signal from the feedback signal output by the digital signal processing unit 43. The analog signal transmitting/receiving unit 42 transmits the generated analog signal using radio waves through the terminal antennas 41-1 to 41-M (step Stb6).

### (Processing Performed by Wireless Communication System of First Embodiment)

FIG. 8 is a flowchart showing the entire processing performed by the wireless communication system 1. In the communication control device 10, for example, in response to an operation by an operator who operates the wireless communication system 1, first, the beam combination history generation unit 13 performs beam combination generation processing in order to generate the beam combination history table 140 (step S1). When the beam combination generation processing performed by the beam combination history generation unit 13 ends, the candidate beam detection unit 15 starts beam search processing in response to an operation of the operator (step S2). When the beam search processing ends, for example, data transmission processing using beams of the distributed antenna devices 30-1 to 30-4, selected by the beam search processing, is started between the communication device connected to the digital signal processing device 20 and the terminal device 40 (step S3). During the data transmission processing, the candidate beam detection unit 15 repeatedly determines whether or not a beam search period timer which will be described later has expired at regular intervals in order to determine whether or not a beam search period has elapsed (step S4). If the candidate beam detection unit 15 determines that the beam search period timer has not expired (No in step S4), the data transmission processing is performed continuously. On the other hand, if the candidate beam detection unit 15 determines that the beam search period timer has expired (Yes in step S4), the candidate beam detection unit 15 outputs a data transmission termination instruction signal to the digital signal processing device 20 to terminate the data transmission processing. Upon receiving the data transmission termination instruction signal, the digital signal processing device 20 stops outputting data to be transmitted to the distributed antenna devices 30-1 to 30-4. As a result, the data transmission processing performed between the communication device connected to the digital signal processing device 20 and the terminal device 40 via the distributed antenna devices 30-1 to 30-4 ends.

The operator determines whether or not to stop the beam search processing by the communication control device 10 (step S5). If the operator determines not to stop the beam search processing by the communication control device 10 (No in step S5), processing proceeds to step S2, and the candidate beam detection unit 15 starts processing for the next beam search period. On the other hand, if the operator determines that the beam search processing by the communication control device 10 is stopped (Yes in step S5), the operator operates the communication control device 10 to stop the beam search processing. Details of the beam combination generation processing in step S1 and the beam search processing in step S2 will be described below.

### (Beam Combination Generation Processing of First Embodiment)

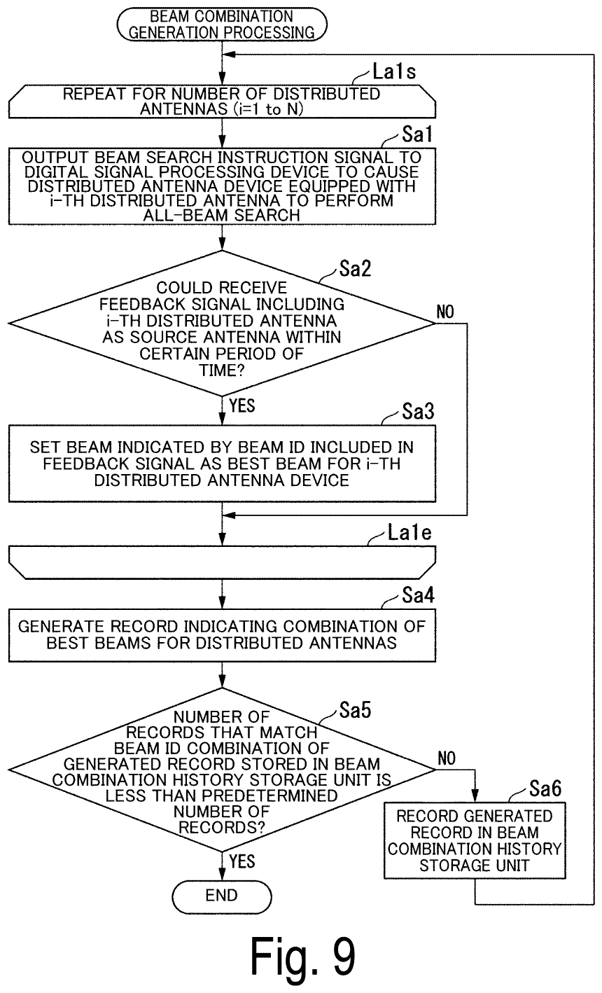

FIG. 9 is a flowchart showing the flow of the beam combination generation processing performed in the processing of step S1 in FIG. 8. In response to an operation by the operator of the wireless communication system 1, the beam combination history generation unit 13 of the communication control device 10 starts processing for the first trial cycle of beam combination generation processing. The beam combination history generation unit 13 reads all distributed antenna IDs written in the distributed antenna ID item of the beam combination history table 140 stored in the beam combination history storage unit 14. The beam combination history generation unit 13 provides a counter i in its internal storage area and initializes it to i=1. Here, although i is an integer value from 1 to N, the wireless communication system 1 in FIG. 1 includes the four distributed antenna devices 30-1 to 30-4, and the beam combination history generation unit 13 reads four distributed antenna IDs, “distributed antenna ID #1,” “distributed antenna ID #2,” “distributed antenna ID #3,” and “distributed antenna ID #4” from the beam combination history table 140, and thus it is assumed that N=4 in the following description. The following description will be made on the assumption that the i-th distributed antenna device is a distributed antenna device 30-i, the i-th distributed antenna is a distributed antenna 31-i, and the i-th main device is a main device 32-i.

The beam combination history generation unit 13 outputs an output destination switching instruction signal for setting the output destination to the beam combination history generation unit 13 to the feedback signal receiving unit 12. When the feedback signal receiving unit 12 receives the output destination switching instruction signal for setting the output destination to the beam combination history generation unit 13 from the beam combination history generation unit 13 t, the feedback signal receiving unit 12 sets the output destination of the feedback signal to the beam combination history generation unit 13.

The beam combination history generation unit 13 generates an all-beam search request signal including the distributed antenna ID assigned to the i-th distributed antenna 31-i to the beam search execution instruction unit 11 in order to cause the distributed antenna device 30-i including the i-th distributed antenna 31-i to perform an all-beam search. After outputting the all-beam search request signal to the beam search execution instruction unit 11, the beam combination history generation unit 13 starts an internal feedback signal timer. When starting the feedback signal timer, the beam combination history generation unit 13 sets the time required to acquire a feedback signal through the all-beam search performed by distributed antenna devices 30-1 to 30-4 that transmit the largest number of beams after the beam combination history generation unit 13 outputs the all-beam search request signal to the beam search execution instruction unit 11 in the feedback signal timer. Note that this time is a predetermined time and is set in the beam combination history generation unit 13 in advance.

The beam search execution instruction unit 11 receives the all-beam search request signal output by the beam combination history generation unit 13, and reads the distributed antenna ID of the i-th distributed antenna 31-i included in the received all-beam search request signal. The beam search execution instruction unit 11 reads the beam ID maximum value corresponding to the distributed antenna ID of the i-th distributed antenna 31-i read from the beam count table 110 in the internal storage area. Here, as an example, it is assumed that the beam search execution instruction unit 11 reads “40” as the beam ID maximum value.

The beam search execution instruction unit 11 generates a number of beam search instruction signals corresponding to the read beam ID maximum value (that is, “40”), the beam search instruction signals each containing one beam ID between 1 and the beam ID maximum value so that the beam IDs contained therein are all different beam IDs. The beam search execution instruction unit 11 writes the read distributed antenna ID of the i-th distributed antenna 31-i into each of the generated beam search instruction signals. The beam search execution instruction unit 11 outputs the generated 40 beam search instruction signals one by one to the digital signal processing device 20 in the order of generation at predetermined fixed time intervals.

The digital signal processing device 20 sequentially receives the 40 beam search instruction signals output from the beam search execution instruction unit 11. The digital signal processing device 20 generates a beam search signal from the received beam search instruction signal. The digital signal processing device 20 outputs the generated beam search signals to the i-th main device 32-i corresponding to the distributed antenna ID included in the beam search instruction signal in the order of generation. The i-th main device 32-i receives the beam search signal output from the digital signal processing device 20. The i-th main device 32-i modulates a carrier wave on the basis of the beam search signal to form a beam in the direction corresponding to the beam ID included in the received beam search signal. The i-th main device 32-i generates a radio-frequency analog signal carrying the beam search signal generated by modulation. The i-th main device 32-i outputs the generated radio-frequency analog signal to the i-th distributed antenna 31-i, whereby the i-th distributed antenna 31-i transmits a beam carrying the beam search signal in the direction of the beam ID included in the beam search signal (step Sa1).

The terminal device 40 receives all beams transmitted by the distributed antenna 31-i. The terminal device 40 performs the processing described with reference to FIGS. 6 and 7 on each of the received beams. The distributed antenna 31-i receives radio waves carrying a feedback signal transmitted by the terminal device 40. The distributed antenna 31-i outputs the received radio waves as an analog signal to the main device 32-i. The main device 32-i converts the analog signal including the feedback signal into a digital signal and outputs the digital signal to the digital signal processing device 20. The digital signal processing device 20 detects and acquires the feedback signal included in the digital signal output by the main device 32-i. The digital signal processing device 20 outputs the acquired feedback signal to the feedback signal receiving unit 12 of the communication control device 10. The feedback signal receiving unit 12 receives the feedback signal output by the digital signal processing device 20, and outputs the received feedback signal to the beam combination history generation unit 13 set as an output destination.

The beam combination history generation unit 13 determines whether or not the feedback signal including the distributed antenna ID of the i-th distributed antenna 31-i as the source antenna ID has been received before the time measured by the feedback signal timer reaches the time set in the feedback signal timer and the feedback signal timer expires (step Sa2).

If the beam combination history generation unit 13 determines that the feedback signal including the distributed antenna ID of the i-th distributed antenna 31-i as the source antenna ID has been received before the feedback signal timer expires (Yes in step Sa2), the beam combination history generation unit 13 sets the beam ID included in the received feedback signal as the beam ID indicating the best beam in the i-th distributed antenna device 30-i. The beam combination history generation unit 13 writes and records data which is a combination of the beam ID and the source antenna ID included in the received feedback signal into an internal storage area (step Sa3).

On the other hand, it is assumed that the beam combination history generation unit 13 determines that the feedback signal including the distributed antenna ID of the i-th distributed antenna 31-i as the source antenna ID has not been received before the feedback signal timer expires (No in step Sa2). Here, examples of the case where the beam combination history generation unit 13 cannot receive the feedback signal include: a case where there is no prospect between the i-th distributed antenna 31-i and the terminal device 40, and the beam transmitted by the i-th distributed antenna 31-i has not reached the terminal device 40; a case where the beam transmitted by the i-th distributed antenna 31-i has reached the terminal device 40 but since the reception level of the beam that has reached the terminal device 40 is lower than the reception sensitivity of the terminal device 40, the analog signal transmitting/receiving unit 42 of the terminal device 40 cannot demodulate and thus discards the signal; a case where, since the reception level of the radio wave carrying the feedback signal transmitted by the terminal device 40 is lower than the reception sensitivity of the distributed antenna device 30-i, the main device 32-i cannot demodulate the signal and thus discards the signal; and a case where transmission of radio waves carrying the feedback signal is delayed due to internal processing of the terminal device 40, and the feedback signal receiving unit 12 outputs the feedback signal to the beam combination history generation unit 13 after the feedback signal timer expires.

After processing of step Sa3 or after determining “No” in processing of step Sa2, if the value of i at that time is not N (here, N=4), the beam combination history generation unit 13 performs processing of steps Sa1 to Sa3 again using the value obtained by adding 1 to i as a new value of i (loop La1s to La1e). If the value of i at that time is N (here, N=4), the beam combination history generation unit 13 ends the processing of loop La1s to La1e. The beam combination history generation unit 13 reads all the data written in the internal storage area, and after reading, deletes all the data from the internal storage area. The beam combination history generation unit 13 generates a record indicating the best beam combination in the distributed antenna devices 30-1 to 30-4 on the basis of all the read data (step Sa4).

The beam combination history generation unit 13 detects the number of records that match the beam ID combinations included in the generated records from the beam ID combinations of the records already recorded in the beam combination history table 140, and determines whether the detected number is less than a predetermined number of records (step Sa5). When the beam combination history generation unit 13 determines that the detected number is less than the predetermined number of records (No in step Sa5), the beam combination history generation unit 13 generates a new row in the beam combination history table 140. The beam combination history generation unit 13 generates a new record ID. The beam combination history generation unit 13 writes the generated new record ID in the “record ID” item on a new row. The beam combination history generation unit 13 writes the corresponding beam ID in each element of “distributed antenna ID #1,” “distributed antenna ID #2,” “distributed antenna ID #3,” and “distributed antenna ID #4” in the new row on the basis of the combination of the source antenna ID and the beam ID (step Sa6). Thereafter, the beam combination history generation unit 13 performs the processing of loop La1s to La1e again as processing of the next trial cycle.

On the other hand, it is assumed that the beam combination history generation unit 13 determines that the detected number is not less than the predetermined number of records (Yes in step Sa5). In this case, it can be considered that a sufficiently large number of best beam combination patterns in the distributed antenna devices 30-1 to 30-4 are obtained within the range in which the terminal device 40 moves within the cell 100 during beam combination generation processing. Therefore, the beam combination history generation unit 13 ends the processing. Note that, if there are a plurality of records with the same combination of beam IDs stored in the beam combination history table 140 before the processing ends, the beam combination history generation unit 13 may leave any one record and delete the other records. In addition, in the beam combination generation processing, if it is also allowable that a sufficiently large number of best beam combination patterns in the distributed antenna devices 30-1 to 30-4 are not obtained, the beam combination history generation unit 13 may perform processing of step Sa6 until the number of records stored in the beam combination history table 140 reaches a predetermined number of records, and when the number of records reaches the predetermined number of records, perform determination processing for ending the processing shown in FIG. 9 instead of the determination in step Sa5. By doing so, the beam search processing of step S2 in FIG. 8 can be started in a state in which the number of records stored in the beam combination history table 140 has reached a predetermined number of records.

As a result, for example, when the beam combination history generation unit 13 repeats the processing of loop La1s to La1e M times, that is, when M trial cycles have ended, M records are generated in the beam combination history table 140, as shown in FIG. 4. In addition, in the beam combination history table 140 shown in FIG. 4, no beam ID is written in “record ID #2,” “record ID #4,” and “record ID #6” of “distributed antenna ID #3”. This indicates that any of the above-mentioned events in cases where the beam combination history generation unit 13 cannot receive the feedback signal in trial cycles of “record ID #2,” “record ID #4,” and “record ID #6” has occurred, and thus the beam combination history generation unit 13 was unable to acquire a feedback signal according to the all-beam search performed by the distributed antenna device 30-3 corresponding to “distributed antenna ID #3.”

### (Beam Search Processing of First Embodiment)

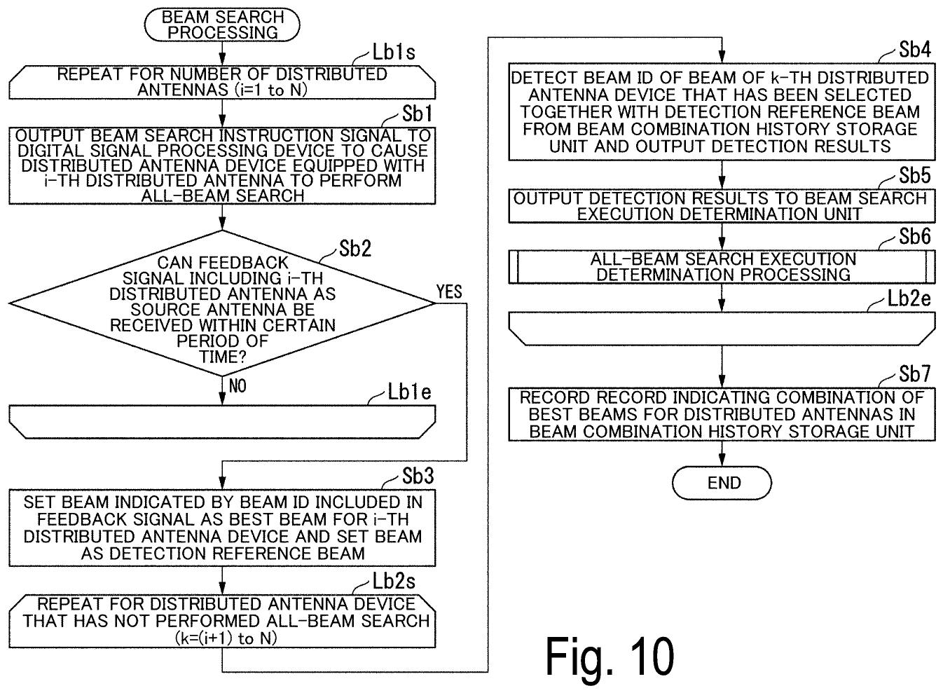

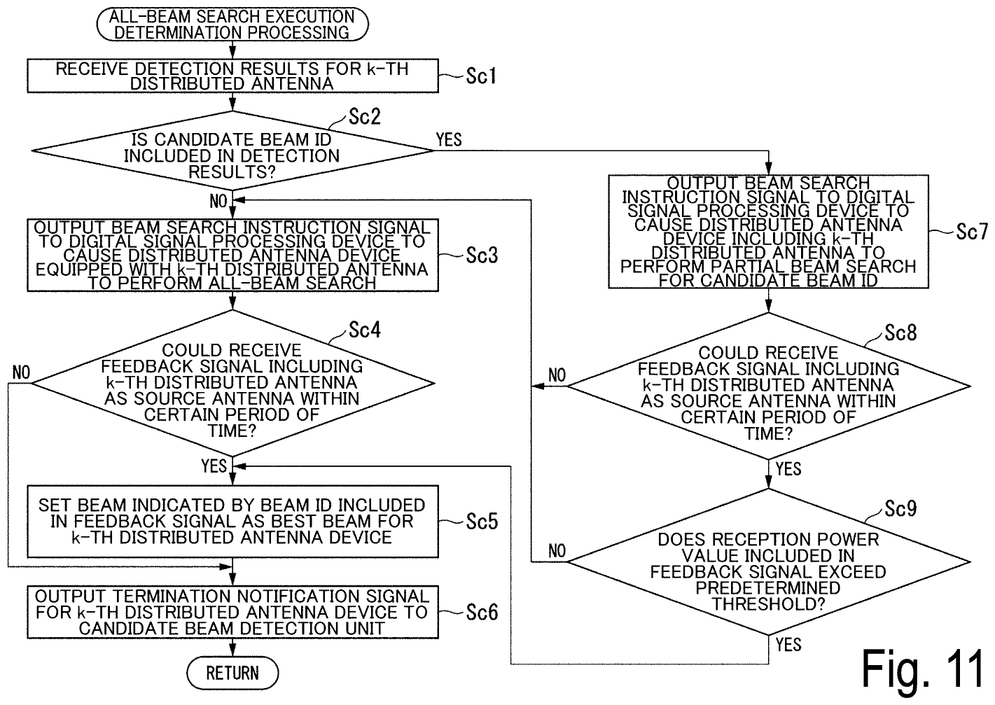

FIG. 10 is a flowchart showing the flow of the beam search processing performed in the processing of step S2 in FIG. 8. As a premise for starting the beam search processing shown in FIG. 8, it is assumed that the beam combination history table 140 shown in FIG. 4 has been generated in the beam combination history storage unit 14.

In response to an operation of the operator of the wireless communication system 1, the candidate beam detection unit 15 of the communication control device 10 starts beam search processing. The candidate beam detection unit 15 starts an internal beam search cycle timer. When starting the beam search cycle timer, the candidate beam detection unit 15 sets a time indicating the length of one predetermined beam search cycle.

The candidate beam detection unit 15 reads all distributed antenna IDs written in the distributed antenna ID item of the beam combination history table 140 stored in the beam combination history storage unit 14. The candidate beam detection unit 15 provides a counter i in the internal storage area thereof and initializes it to i=1. Here, although i is an integer value from 1 to N, the wireless communication system 1 in FIG. 1 includes the four distributed antenna devices 30-1 to 30-4, and the candidate beam detection unit 15 reads four distributed antenna IDs, “distributed antenna ID #1,” “distributed antenna ID #2,” “distributed antenna ID #3,” and “distributed antenna ID #4” from the beam combination history table 140, and thus it is assumed that N=4 in the following description. The following description will be made assuming that the i-th distributed antenna device is a distributed antenna device 30-i, the i-th distributed antenna is a distributed antenna 31-i, and the i-th main device is a main device 32-i.

The candidate beam detection unit 15 outputs an output destination switching instruction signal to the feedback signal receiving unit 12 to set the output destination to the candidate beam detection unit 15. When the feedback signal receiving unit 12 receives an output destination switching instruction signal from the candidate beam detection unit 15 that sets the output destination to the candidate beam detection unit 15, the feedback signal receiving unit 12 sets the candidate beam detection unit 15 as the output destination of the feedback signal.

The candidate beam detection unit 15 performs the following processing when i=1. That is, in order to cause the distributed antenna device 30-1 including the first distributed antenna 31-1 to perform an all-beam search, the candidate beam detection unit 15 outputs an all-beam search request signal including “distributed antenna ID #1” which is the distributed antenna ID assigned to the first distributed antenna 31-1 to the beam search execution instruction unit 11. After outputting the all-beam search request signal to the beam search execution instruction unit 11, the candidate beam detection unit 15 starts an internal feedback signal timer. When starting the feedback signal timer, the candidate beam detection unit 15 sets the same time as that set in the feedback signal timer by the beam combination history generation unit 13 in the processing of step Sa1 in FIG. 9. Note that this time is a predetermined time and is set in the candidate beam detection unit 15 in advance. When the beam search execution instruction unit 11 receives the all-beam search request signal output by the candidate beam detection unit 15, the processing after the beam search execution instruction unit 11 receives the all-beam search request signal in the processing of step Sa1 of FIG. 9 is performed by the beam search execution instruction unit 11, the digital signal processing device 20, the main device 32-1, the distributed antenna 31-1, and the terminal device 40 with i=1 (step Sb1 when i=1).

The candidate beam detection unit 15 determines whether the feedback signal including “distributed antenna ID #1” which is the distributed antenna ID of the first distributed antenna 31-1 as the source antenna ID has been received before the feedback signal timer expires (step Sb2 when i=1).

Here, it is assumed that any of the above-mentioned events in cases where the beam combination history generation unit 13 cannot receive the feedback signal has occurred. In this case, the candidate beam detection unit 15 determines that the feedback signal including “distributed antenna ID #1” which is the distributed antenna ID of the first distributed antenna 31-1 as the source antenna ID has not been received before the feedback signal timer expires (No in step Sb2). If the value of i at that time is not N (here, N=4), the candidate beam detection unit 15 sets the value obtained by adding 1 to i as a new value of i, and performs processing of steps Sb1 and Sb2 again (loop Lb1s to Lb1e). Here, since the value of i at that time is “1,” the candidate beam detection unit 15 sets “2” as a new value of i.

When i=2, the candidate beam detection unit 15 performs the following processing as the second processing of loop Lb1s to Lb1e. That is, in order to cause the distributed antenna device 30-2 including the second distributed antenna 31-2 to perform an all-beam search, the candidate beam detection unit 15 outputs an all-beam search request signal including “distributed antenna ID #2” which is the distributed antenna ID assigned to the second distributed antenna 31-2 to the beam search execution instruction unit 11. After outputting the all-beam search request signal to the beam search execution instruction unit 11, the candidate beam detection unit 15 starts an internal feedback signal timer. When starting the feedback signal timer, the candidate beam detection unit 15 sets the same time as that set in the feedback signal timer by the beam combination history generation unit 13 in the processing of step Sa1 in FIG. 9. When the beam search execution instruction unit 11 receives the all-beam search request signal output by the candidate beam detection unit 15, processing after the beam search execution instruction unit 11 receives the all-beam search request signal in the processing of step Sa1 in FIG. 9 is performed by the beam search execution instruction unit 11, the digital signal processing device 20, the main device 32-2, the distributed antenna 31-2, and the terminal device 40 with i=2 (steps Sb1 when i=2).

The candidate beam detection unit 15 determines whether the feedback signal including “distributed antenna ID #2” which is the distributed antenna ID of the second distributed antenna 31-2 as the source antenna ID has been received before the feedback signal timer expires (step Sb2 when i=2). Here, it is assumed that any of the above-described events in cases where the beam combination history generation unit 13 cannot receive the feedback signal has not occurred, and the feedback signal receiving unit 12 outputs the feedback signal to the candidate beam detection unit 15. In this case, the candidate beam detection unit 15 determines that the feedback signal including “distributed antenna ID #2” which is the distributed antenna ID of the second distributed antenna 31-2 as the source antenna ID has been received before the feedback signal timer expires (Yes in step Sb2 when i=2).

The candidate beam detection unit 15 exits the processing of loop Lb1s to Lb1e and sets the beam ID included in the received feedback signal as the beam ID indicating the best beam for the second distributed antenna device 30-2. The candidate beam detection unit 15 sets the beam identified by the beam ID and “distributed antenna ID #2” which is the source antenna ID included in the feedback signal as a detection reference beam. Here, it is assumed that the beam ID included in the feedback signal received by the candidate beam detection unit 15 is “beam ID #33.”

The candidate beam detection unit 15 combines the source antenna ID, beam ID, and reception power value included in the feedback signal into one set of data, and outputs the one set of data to the beam combination recording unit 17. The beam combination recording unit 17 receives the one set of data output by the candidate beam detection unit 15. The candidate beam detection unit 15 outputs an output destination switching instruction signal for setting the output destination to the beam search execution determination unit 16 to the feedback signal receiving unit 12. When the feedback signal receiving unit 12 receives the output destination switching instruction signal for setting the output destination to the beam search execution determination unit 16 from the candidate beam detection unit 15, the feedback signal receiving unit 12 sets the output destination of the feedback signal to the beam search execution determination unit 16 (step Sb3).

In other words, regarding the processing in steps Sb2 and Sb3 above, the candidate beam detection unit 15 performs processing of causing all the distributed antenna devices 30-1 to 30-4 to perform all-beam searches in order, and when one feedback signal is received during the processing, the candidate beam detection unit 15 ends the processing of loop Lb1s to Lb1e and sets the beam identified by the source antenna ID and beam ID included in the received feedback signal as a detection reference beam.

At this time, there are only two distributed antenna devices 30-3 and 30-4 that have not performed the all-beam search in the beam search period. If the wireless communication system 1 includes N distributed antenna devices 30-1 to 30-N, the number of distributed antenna devices 30-1 to 30-N that have not performed the all-beam search is represented by N-i using the value of i at the time of exiting loop Lb1s to Lb1e and the value of N. The candidate beam detection unit 15 provides a counter k in an internal storage area and initializes it to k=i+1. k is an integer value from (i+1) to N, and here, k have values of “3” and “4”.

The candidate beam detection unit 15 performs the following processing when k=3. That is, the candidate beam detection unit 15 detects the beam of the third distributed antenna device 30-3, which has been selected together with the detection reference beam, as a candidate beam from the beam combination history table 140. Here, the detection reference beam is a beam identified by “beam ID #33” of “distributed antenna ID #2.” In the beam combination history table 140, “beam ID #33” of “distributed antenna ID #2” corresponding to the detection reference beam is included in “record ID #2,” “record ID #4,” and “record ID #6,” but the “distributed antenna ID #3” items of “record ID #2”, “record ID #4”, and “record ID #6” are blank. Therefore, the candidate beam detection unit 15 outputs detection results that there is no candidate beam ID indicating a candidate beam that is a beam of the third distributed antenna device 30-3 and has been selected together with the detection reference beam. The candidate beam detection unit 15 generates data indicating detection results including only “distributed antenna ID #3” (step Sb4 when k=3).

The candidate beam detection unit 15 outputs data indicating the detection results including only “distributed antenna ID #3” to the beam search execution determination unit 16 (step Sb5 when k=3). When the beam search execution determination unit 16 receives the data indicating the detection results from the candidate beam detection unit 15, the beam search execution determination unit 16 starts a subroutine for all-beam search execution determination processing shown in FIG. 11 (step Sb6 when k=3).

The beam search execution determination unit 16 receives the data indicating the detection results output by the candidate beam detection unit 15 (step Sc1 when k=3). The beam search execution determination unit 16 determines whether the candidate beam ID is included in the received data indicating the detection results (step Sc2 in the case of k=3). Here, since the candidate beam ID is not included in the data indicating the detection results, the beam search execution determination unit 16 determines that the candidate beam ID is not included in the received data indicating the detection results (No in step Sc2 when k=3).

The processing of steps Sc3 to Sc6 will be described below. The beam search execution determination unit 16 reads the “distributed antenna ID #k” included in the data indicating the detection results, and outputs an all-beam search request signal including “distributed antenna ID #k” to the beam search execution instruction unit 11 in order to cause the distributed antenna device 30-k including the k-th distributed antenna 31-k to perform an all-beam search based on the read “distributed antenna ID #k”. After outputting the all-beam search request signal to the beam search execution instruction unit 11, the beam search execution determination unit 16 starts an internal feedback signal timer. When starting the feedback signal timer, the beam search execution determination unit 16 sets the same time as that set in the feedback signal timer by the beam combination history generation unit 13 in the processing of step Sa1 in FIG. 9. Note that this time is a predetermined time, and is set in advance in the beam search execution determination unit 16. When the beam search execution instruction unit 11 receives the all-beam search request signal output by the beam search execution determination unit 16, processing after the beam search execution instruction unit 11 receives the all-beam search request signal in the processing of step Sa1 in FIG. 9 is performed by the beam search execution instruction unit 11, the digital signal processing device 20, the main device 32-k, the distributed antenna 31-k, and the terminal device 40 with i=k (step Sc3).

The beam search execution determination unit 16 determines whether the feedback signal including “distributed antenna ID #k” which is the distributed antenna ID of the k-th distributed antenna 31-k as the source antenna ID has been received before the feedback signal timer expires (step Sc4).

For example, it is assumed that any of the above-described events in cases where the beam combination history generation unit 13 cannot receive the feedback signal has not occurred, and the feedback signal receiving unit 12 outputs the feedback signal to the beam search execution determination unit 16. In this case, the beam search execution determination unit 16 determines that the feedback signal including “distributed antenna ID #k” which is the distributed antenna ID of the k-th distributed antenna 31-k as the source antenna ID has been received before the feedback signal timer expires (Yes in step Sc4). The beam search execution determination unit 16 sets the beam ID included in the feedback signal as the beam ID indicating the best beam for the k-th distributed antenna device 30-k. The beam search execution determination unit 16 combines the source antenna ID, beam ID, and reception power value included in the feedback signal into one set of data, and outputs the one set of data to the beam combination recording unit 17. The beam combination recording unit 17 receives the one set of data output by the beam search execution determination unit 16. (Step Sc5).

On the other hand, it is assumed that any of the above-mentioned events in cases where the beam combination history generation unit 13 cannot receive the feedback signal has occurred. In this case, the beam search execution determination unit 16 determines that the feedback signal including “distributed antenna ID #k” which is the distributed antenna ID of the k-th distributed antenna 31-k as the source antenna ID has been received before the feedback signal timer expires (No in step Sc4).

After the processing in step Sc5 or after determining “No” in the processing in step Sc4, the beam search execution determination unit 16 outputs a termination notification signal indicating that the processing for the k-th distributed antenna device 30-k has ended and including the value of the counter k to the candidate beam detection unit 15 (step Sc6), and ends the subroutine processing.

Referring back to FIG. 10, when the candidate beam detection unit 15 receives the termination notification signal output from the beam search execution determination unit 16, if the value of k at that time is not N (here, N=4), the candidate beam detection unit 15 performs the processing of steps Sb4 to Sb6 again using the value obtained by adding 1 to the value of k as a new value of k (loop Lb2s to Lb2e). Here, since the value of k at that time is “3”, the candidate beam detection unit 15 sets “4” as the new value of k.

The candidate beam detection unit 15 performs the following processing when k=4. That is, the candidate beam detection unit 15 detects the beam ID of the beam of the fourth distributed antenna device 30-4 that has been selected together with the detection reference beam from the beam combination history table 140. Here, the detection reference beam is a beam identified by “beam ID #33” of “distributed antenna ID #2”. In the beam combination history table 140, “beam ID #33” of “distributed antenna ID #2” corresponding to the detection reference beam is included in “record ID #2,” “record ID #4,” and “record ID #6.” “Beam ID #15,” “beam ID #16,” and “beam ID #15” are written in the “distributed antenna ID #4” items of “record ID #2,” “record ID #4,” and “record ID #6.”

Therefore, the candidate beam detection unit 15 detects “beam ID #15” and “beam ID #16” from the beam combination history table 140 as the beam IDs of beams of the fourth distributed antenna device 30-4 that have been selected together with the detection reference beam. The candidate beam detection unit 15 sets “beam ID #15” and “beam ID #16” as candidate beam IDs indicating candidate beams of the distributed antenna device 30-4 corresponding to “distributed antenna ID #4.” The candidate beam detection unit 15 generates data indicating detection results including “distributed antenna ID #4,” and candidate beam IDs “beam ID #15” and “beam ID #16” (step Sb4 when k=4). The candidate beam detection unit 15 outputs the generated data indicating the detection results to the beam search execution determination unit 16 (step Sb5 when k=4). When the beam search execution determination unit 16 receives the data indicating the detection results from the candidate beam detection unit 15, the beam search execution determination unit 16 starts a subroutine for all-beam search execution determination processing shown in FIG. 11 (step Sb6 when k=4).

The beam search execution determination unit 16 receives data indicating the detection results output by the candidate beam detection unit 15 (step Sc1 when k=4). The beam search execution determination unit 16 determines whether the candidate beam ID is included in the received data indicating the detection results (step Sc2 in the case of k=4). Here, since the data indicating the detection results includes “beam ID #15” and “beam ID #16,” the beam search execution determination unit 16 determines that a candidate beam ID is included in the data indicating the received detection results (Yes in step Sc2 when k=4).

The beam search execution determination unit 16 outputs a partial beam search request signal including “distributed antenna ID #4,” “beam ID #15,” and “beam ID #16” to the beam search execution instruction unit 11 in order to cause the distributed antenna device 30-4 including the fourth distributed antenna 31-4 to perform a partial beam search. After outputting the partial beam search request signal to the beam search execution instruction unit 11, the beam search execution determination unit 16 starts an internal feedback signal timer. When starting the feedback signal timer, the beam search execution determination unit 16 sets the same time as that set in the feedback signal timer by the beam combination history generation unit 13 in the processing of step Sa1 in FIG. 9.

The beam search execution instruction unit 11 receives the partial beam search request signal output by the beam search execution determination unit 16, and reads “distributed antenna ID #4,” “beam ID #15,” and “beam ID #16” included in the partial beam search request signal. The beam search execution instruction unit 11 generates a beam search instruction signal including “distributed antenna ID #4” and “beam ID #15,” and a beam search instruction signal including “distributed antenna ID #4” and “beam ID #16.” The beam search execution instruction unit 11 outputs the two generated beam search instruction signals one by one to the digital signal processing device 20 at predetermined fixed time intervals in the order of generation. The digital signal processing device 20 sequentially receives the two beam search instruction signals output by the beam search execution instruction unit 11. Thereafter, processing after the digital signal processing device 20 receives the beam search instruction signal in the processing of step Sa1 in FIG. 9, is performed by the digital signal processing device 20, the main device 32-4, the distributed antenna 31-4, and the terminal device 40 with i=4 (step Sc7 when k=4).

The beam search execution determination unit 16 determines whether a feedback signal including “distributed antenna ID #4” which is the distributed antenna ID of the fourth distributed antenna 31-4 as the source antenna ID has been received before the feedback signal timer expires (step Sc8).

For example, it is assumed that any of the above-mentioned events in cases where the beam combination history generation unit 13 cannot receive the feedback signal has occurred. In this case, the beam search execution determination unit 16 determines that the feedback signal including “distributed antenna ID #4,” which is the distributed antenna ID of the fourth distributed antenna 31-4, as the source antenna ID has not been received before the feedback signal timer expires (No in step Sc8 when k=4), and the processing proceeds to step Sc3.

On the other hand, it is assumed that any of the above-described events in cases where the beam combination history generation unit 13 cannot receive the feedback signal has not occurred, and the feedback signal receiving unit 12 outputs the feedback signal to the beam search execution determination unit 16. In this case, the beam search execution determination unit 16 determines that the feedback signal including “distributed antenna ID #4,” which is the distributed antenna ID of the fourth distributed antenna 31-4, as the source antenna ID has been received before the feedback signal timer expires (Yes in step Sc8 when k=4).

In this case, the beam search execution determination unit 16 determines whether the reception power value included in the feedback signal exceeds a predetermined threshold (step Sc9 when k=4). When the beam search execution determination unit 16 determines that the reception power value included in the feedback signal does not exceed the predetermined threshold (No in step Sc9 when k=4), the processing proceeds to step Sc3. On the other hand, if the beam search execution determination unit 16 determines that the reception power value included in the feedback signal exceeds the predetermined threshold (Yes in step Sc9 when k=4), the processing proceeds to step Sc5.

In other words, regarding the processing of steps Sc7, Sc8, and Sc9, the beam search execution determination unit 16 performs a partial beam search to cause the distributed antenna device 30-4 corresponding to “distributed antenna ID #4” to transmit a beam corresponding to “beam ID #15” and a beam corresponding to “beam ID #16.” If no feedback signal is obtained by the partial beam search, the beam search execution determination unit 16 advances the processing to step Sc3 and causes the distributed antenna device 30-4 corresponding to “distributed antenna ID #4” to perform an all-beam search to search for the best beam for the distributed antenna device 30-4 again. Further, in all-beam search in this case, the beam search execution determination unit 16 searches for only beams other than the beam corresponding to the “beam ID #15” and the beam corresponding to the “beam ID #16.”

Then, in a case where a feedback signal in which “distributed antenna ID #4” is included as a source antenna ID is received before a feedback signal timer expires in step Sc4, the beam search execution determination unit 16 advances the processing to step Sc5 to set the beam ID included in the feedback signal as a target data to be added to the beam combination history table 140.

On the other hand, in a case where a feedback signal is obtained by the partial beam search, when the reception power value included in the feedback signal, that is, the reception power value of the beam selected as the best beam for the terminal device 40, does not exceed the threshold, the beam search execution determination unit 16 determines that the beam indicated by the feedback signal is an inappropriate beam that cannot be used for normal operation. Therefore, the beam search execution determination unit 16 advances the processing to step Sc3 and causes the distributed antenna device 30-4 corresponding to “distributed antenna ID #4” to perform an all-beam search to search for the best beam for the distributed antenna device 30-4 again. Further, in all-beam search in this case, the beam search execution determination unit 16 searches for only beams other than the beam corresponding to the “beam ID #15” and the beam corresponding to the “beam ID #16.”

Then, in a case where a feedback signal in which “distributed antenna ID #4” is included as a source antenna ID is received before a feedback signal timer expires in step Sc4, the beam search execution determination unit 16 advances the processing to step Sc5 to set the beam ID included in the feedback signal as a target data to be added to the beam combination history table 140.

On the other hand, when the reception power value included in the feedback signal exceeds the threshold, the beam search execution determination unit 16 advances the processing to step Sc5 to determine that the beam is the best beam for the distributed antenna device 30-4. In this case, since the beam search execution determination unit 16 can determine that the beam is an appropriate beam that can be used for normal operation without performing an all-beam search for the distributed antenna device 30-4, the number of beam searches can be reduced.

Referring back to FIG. 10, when the candidate beam detection unit 15 receives the termination notification signal output from the beam search execution determination unit 16, if the value of k at that time is N (here, N=4), the candidate beam detection unit 15 ends the processing of loop Lb2s to Lb2e, and advances the processing to step Sb7.

The beam combination recording unit 17 removes the reception power value from the set of data received in the processing of step Sb3 and the processing of step Sc5, that is, the data that is a combination of the source antenna ID, beam ID, and reception power value, and generates one record in the beam combination history table 140 based on the remaining data. That is, the beam combination recording unit 17 generates a new row in the beam combination history table 140, thereby generating “record ID #M+1” as a new record ID. The beam combination recording unit 17 writes “record ID #M+1” which is the generated new record ID in the “record ID” item of the generated new row. The beam combination recording unit 17 records the corresponding beam ID in each element of “distributed antenna ID #1,” “distributed antenna ID #2,” “distributed antenna ID #3,” and “distributed antenna ID #4” in the row of “record ID #M+1” on the basis of the combination of the source antenna ID and the beam ID (step Sb7).

In the wireless communication system 1 of the first embodiment described above, the candidate beam detection unit 15 causes each of the plurality of distributed antennas 31-1 to 31-4 to perform an all-beam search performed by transmitting beams in all transmittable directions in a beam search period for searching for a beam to be used for wireless communication with the terminal device 40, stops the all-beam search when one beam identifier indicating the best beam among beams according to the all-beam search has been acquired, sets a beam identified by the acquired beam identifier and information indicating distributed antennas 31-1 to 31-4 that have transmitted the beam indicated by the beam identifier as a detection reference beam, and detects, from the beam combination history storage unit 14, beam identifiers of distributed antennas 31-1 to 31-4 that have not performed the all-beam search in the beam search period, which have been selected together with the detection reference beam, as candidate beam identifiers for the distributed antennas 31-1 to 31-4. The beam search execution determination unit 16 determines whether or not to cause the distributed antennas 31-1 to 31-4 that have not performed the all-beam search in the beam search period to perform the all-beam search on the basis of the detection results from the candidate beam detection unit 15. The beam combination recording unit 17 generates a record indicating a combination of beam identifiers indicating beams determined to be the best beams for the distributed antennas in the beam search period. The beam combination recording unit 17 records the generated record in the beam combination history storage unit. As a result, it is possible to obtain an effect that in the beam combination generation processing performed by the beam combination history generation unit 13, even when it is not possible to generate sufficient records indicating a history of beam combinations while moving the terminal device 40 little by little at intervals that do not reduce the transmission capacity throughout the cell 100 in the service providing area, it is possible to store a sufficiently large number of records to reduce the number of beam searches without reducing transmission capacity when performing beam search processing.

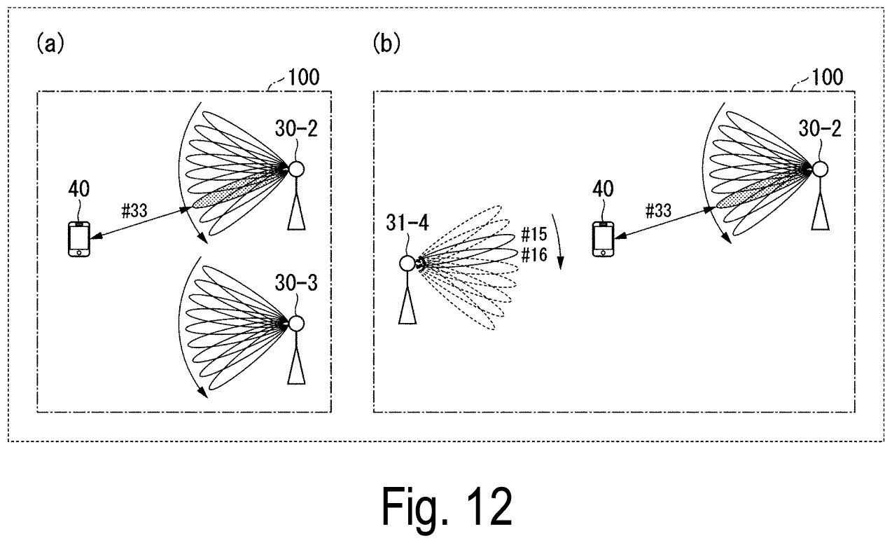

Details of beam search processing in the first embodiment will be summarized with reference to FIG. 12. Regarding the distributed antenna device 30-1, in the processing of step Sb2 when i=1, the candidate beam detection unit 15 cannot acquire a feedback signal before the feedback signal timer expires through the all-beam search performed by the distributed antenna device 30-1, and thus beams cannot be searched. Regarding the distributed antenna device 30-2, in the processing of step Sb2 when i=2, the candidate beam detection unit 15 can acquire a feedback signal through the all-beam search performed by the distributed antenna device 30-2, and thus the beam indicated by the beam ID “beam ID #33” included in the acquired feedback signal can be searched as the best beam for the distributed antenna device 30-2.

Regarding the distributed antenna device 30-3, the candidate beam detection unit 15 cannot detect, from the beam combination history table 140, the beam ID of a beam that has been selected together with “beam ID #33,” which is the best beam for the distributed antenna device 30-2. Therefore, as shown in FIG. 12(a), the beam search execution determination unit 16 proceeds to processing of step Sc3 in FIG. 11 and causes the distributed antenna device 30-3 to perform an all-beam search. If the beam search execution determination unit 16 can acquire a feedback signal through the all-beam search performed by the distributed antenna device 30-3, it is possible to search for the best beam for the distributed antenna device 30-3, and if the feedback signal cannot be acquired, it is not possible to search for the best beam for the distributed antenna device 30-3.

Regarding the distributed antenna device 30-4, the candidate beam detection unit 15 can detect, from the beam combination history table 140, “beam ID #15” and “beam ID #16” as the beam IDs of beams that have been selected together with “beam ID #33” which is the best beam for the distributed antenna device 30-2. Therefore, as shown in FIG. 12(b), the beam search execution determination unit 16 causes the distributed antenna device 30-4 to perform a partial beam search using the beams indicated by “beam ID #15” and “beam ID #16” as candidate beams in step Sc7 of FIG. 11. If the beam search execution determination unit 16 has acquired a feedback signal through the partial beam search by the distributed antenna device 30-4, and the reception power value included in the acquired feedback signal exceeds a predetermined threshold, it is possible to search for the beam ID included in the feedback signal as the best beam for the distributed antenna device 30-4. On the other hand, if the beam search execution determination unit 16 cannot acquire a feedback signal through the partial beam search by the distributed antenna device 30-4, or if the reception power value included in the feedback signal does not exceed the predetermined threshold in a case where the feedback signal has been acquired, the beam search execution determination unit 16 proceeds to processing of step Sc3 in FIG. 11 and causes the distributed antenna device 30-4 to perform an all-beam search. If the beam search execution determination unit 16 can acquire a feedback signal through the all-beam search by the distributed antenna device 30-4, it is possible to search for the best beam for the distributed antenna device 30-4, and if the feedback signal cannot be acquired, the best beam for the antenna device 30-4 cannot be searched for.

Therefore, all-beam search processing performed in the processing of steps Sb1 and Sb2 in FIG. 10 and the processing of steps Sc3 and Sc4 in FIG. 11 can be said to be processing for covering the lack of records when a sufficiently large number of records are not recorded in the beam combination history table 140 by the beam combination generation processing of the beam combination history generation unit 13. On the other hand, although partial beam search processing performed in the processing of steps Sc7 to Sc9 in FIG. 11 is processing for searching for beams while reducing the number of beam searches, if a sufficiently large number of records are not recorded in the beam combination history table 140, the best beam may not be included in narrowed-down candidate beams when the candidate beams are narrowed down, resulting in a reduction in transmission capacity. In such a case, processing proceeds to step Sc3 to perform an all-beam search to newly select the best beam. As a result, even if a sufficiently large number of records are not recorded in the beam combination history table 140, it is possible to store a number of records sufficient for reducing the number of beam searches without reducing transmission capacity when performing beam search processing.

### Second Embodiment

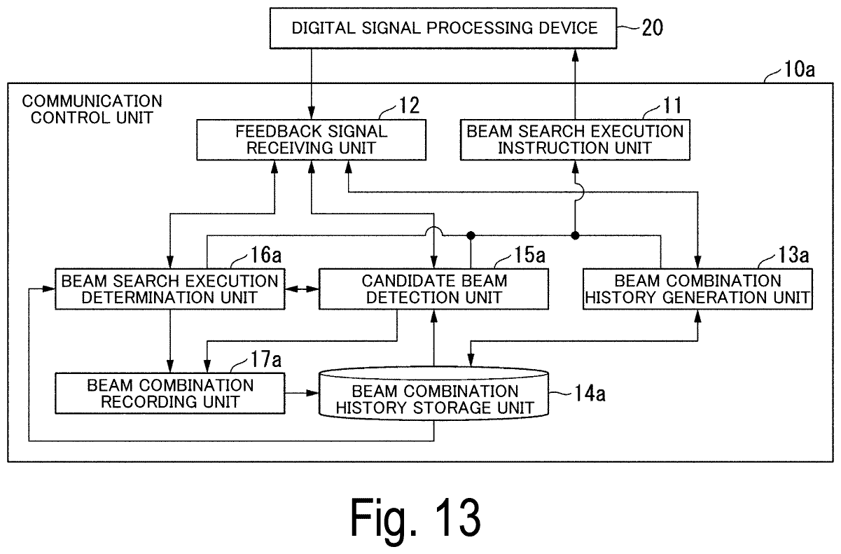

FIG. 13 is a block diagram showing the configuration of a communication control device 10a according to the second embodiment. The communication control device 10a is a device used in place of the communication control device 10 of the first embodiment, and for convenience of description, the wireless communication system 1 including the communication control device 10a instead of the communication control device 10 will be referred to as a wireless communication system 1a hereinafter. In the communication control device 10a, the same components as those of the communication control device 10 of the first embodiment are denoted by the same reference numerals, and different components will be described below.

The communication control device 10a includes a beam search execution instruction unit 11, a feedback signal receiving unit 12, a beam combination history generation unit 13a, a beam combination history storage unit 14a, a candidate beam detection unit 15a, a beam search execution determination unit 16a, and a beam combination recording unit 17a.

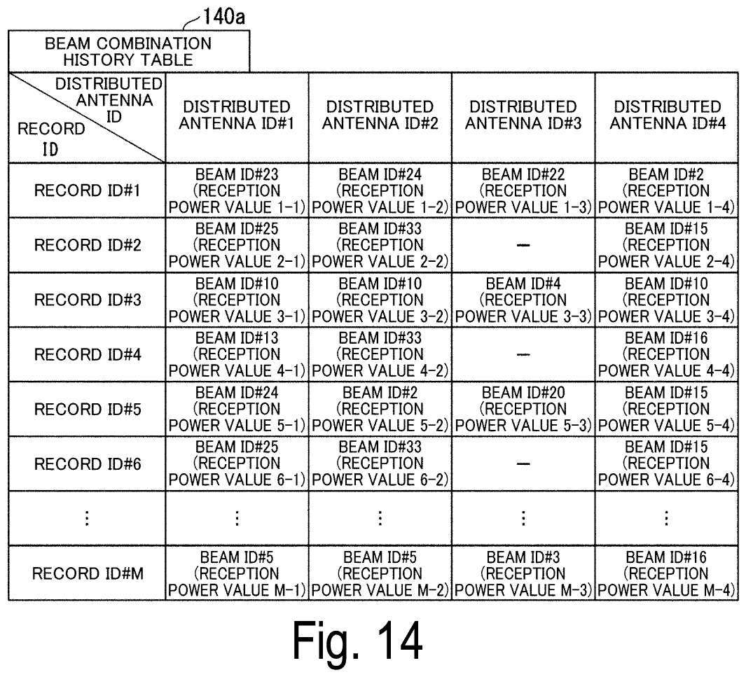

The beam combination history storage unit 14a stores a beam combination history table 140a shown in FIG. 14. The beam combination history table 140a has the same data format as the beam combination history table 140 of the first embodiment shown in FIG. 4, except that data written into elements is different. The beam combination history table 140 of the first embodiment has a data configuration in which only beam IDs are written as elements. In contrast, in the beam combination history table 140a of the second embodiment, a beam ID and a reception power value measured by the terminal device 40 when the terminal device 40 receives the beam indicated by the beam ID are written as elements. Note that, as the reception power value, for example, a numerical value expressed in the unit of “dBm” is written.

The beam combination history generation unit 13a has the same configuration as the beam combination history generation unit 13 of the first embodiment except for the configuration described below. In the processing of step Sa3 in FIG. 9, the beam combination history generation unit 13 of the first embodiment writes and records data which is a combination of the beam ID and the source antenna ID included in the received feedback signal into an internal storage area. On the other hand, in the processing of step Sa3 of FIG. 9, the beam combination history generation unit 13a of the second embodiment adds the reception power value included in the received feedback signal and writes and records data which is a combination of the source antenna ID, the beam ID, and the reception power value into an internal storage area.

A record generated by the beam combination history generation unit 13 of the first embodiment in the processing of step Sa4 in FIG. 9 does not include the reception power value. On the other hand, the beam combination history generation unit 13a of the second embodiment generates a record in which the reception power value is added to the source antenna ID and beam ID in the processing of step Sa4 in FIG. 9. Therefore, in the processing of step Sa6, the beam combination history generation unit 13a writes a record including the reception power value into the beam combination history table 140a. At this time, the beam combination history generation unit 13a writes each piece of data that is a combination of the beam ID and reception power value included in the record as elements at the location identified by a row newly generated for the record in the beam combination history table 140a and a row of the source antenna ID corresponding to the data which is a combination of the beam ID and the reception power value. Note that in the first embodiment, if there are a plurality of records with the same combination of beam IDs stored in the beam combination history table 140 before the processing ends, the beam combination history generation unit 13 may leave any one record and delete the other records, but in the second embodiment, even if the combinations of beam IDs are the same, it is necessary to leave all records written in the beam combination history table 140a since the reception power values may be different.

The candidate beam detection unit 15a has the same configuration as the candidate beam detection unit 15 of the first embodiment except for the configuration described below. When detecting, from the beam combination history table 140a, the beam IDs of the distributed antenna devices 30-1 to 30-4 that have not performed the all-beam search in the beam search period, which have been selected together with the detection reference beam, and distributed antenna IDs corresponding to the beam IDs, the candidate beam detection unit 15a detects reception power values written as an element together with the detected beam IDs in the beam combination history table 140a. The candidate beam detection unit 15a calculates the average values of the reception power values for each beam ID on the basis of the combination of the detected beam IDs and the detected reception power values, and sets the maximum value of the calculated average values as the average reception power value for the detected distributed antenna IDs. The candidate beam detection unit 15a includes the calculated average reception power value in data indicating the detection results.

The beam search execution determination unit 16a has the same configuration as the beam search execution determination unit 16 of the first embodiment except for the configuration described below. The beam search execution determination unit 16a performs the following processing when the data indicating the detection results output by the candidate beam detection unit 15 includes a candidate beam ID. That is, the beam search execution determination unit 16a reads the average reception power value included in the data indicating the detection results, and sets a value obtained by adding a margin to the read average reception power value as a threshold for the distributed antenna IDs included in the data indicating the detection results. Here, the reason why a value obtained by adding a margin to the average reception power value is set as the threshold is to allow a reception power value that is slightly smaller than the average reception power value. Specifically, the beam search execution determination unit 16a sets the value of an error occurring in the reception power value calculated in advance as a predetermined value, and sets a subtraction value obtained by subtracting the predetermined value from the average reception power value as a threshold.

The beam search execution determination unit 16a selects, from among calculated thresholds, the threshold for source antenna IDs included in the feedback signal obtained when any of the distributed antenna devices 30-1 to 30-4 is caused to perform a partial beam search, and determines whether or not to cause the distributed antenna devices 30-1 to 30-4 corresponding to the source antenna IDs included in the feedback signal to perform an all-beam search on the basis of the selected threshold and the reception power value included in the feedback signal.

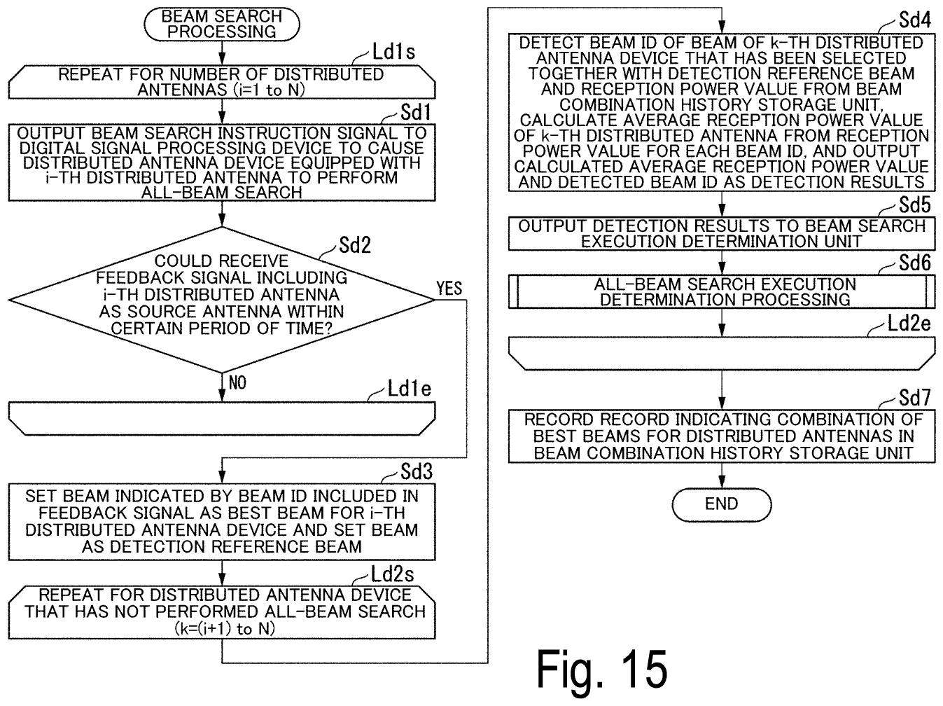

The beam combination recording unit 17a has the same configuration as the beam combination recording unit 17 of the first embodiment except for the configuration described below. In processing of step Sb7 in FIG. 10, the beam combination recording unit 17 of the first embodiment removes the reception power value from the data that is a combination of the source antenna ID, beam ID, and reception power value, and generates one record based on the remaining data. On the other hand, in processing of step Sd7 in FIG. 15, which corresponds to the processing in step Sb7 of FIG. 10, the beam combination recording unit 17a of the second embodiment does not remove the reception power value and generates one record from the data that is a combination of the beam ID and the reception power value. The beam combination recording unit 17a writes each piece of data that is a combination of the beam ID and reception power value included in the record as elements at the location identified by a row newly generated for the record in the beam combination history table 140a and a row of the source antenna ID corresponding to the data which is a combination of the beam ID and the reception power value.

### (Processing Performed by Wireless Communication System of Second Embodiment)

Similarly to the first embodiment, in the wireless communication system 1a of the second embodiment, the beam combination generation processing in step S1 and the beam search processing in step S2, shown in FIG. 8, are also performed. However, the beam combination generation processing and beam search processing performed in the second embodiment differ from the processing performed in the first embodiment in the points described below.

### (Beam Combination Generation Processing of Second Embodiment)

In the beam combination generation processing shown in FIG. 9, the same processing as in the first embodiment is performed by the beam search execution instruction unit 11, the feedback signal receiving unit 12, the digital signal processing device 20, and the distributed antenna devices 30-1 to 30-4 and the processing performed by the beam combination history generation unit 13 is performed by the beam combination history generation unit 13a, except that the processing in steps Sa3, Sa4, and Sa6 is replaced with the processing described above.

### (Beam Search Processing of Second Embodiment)

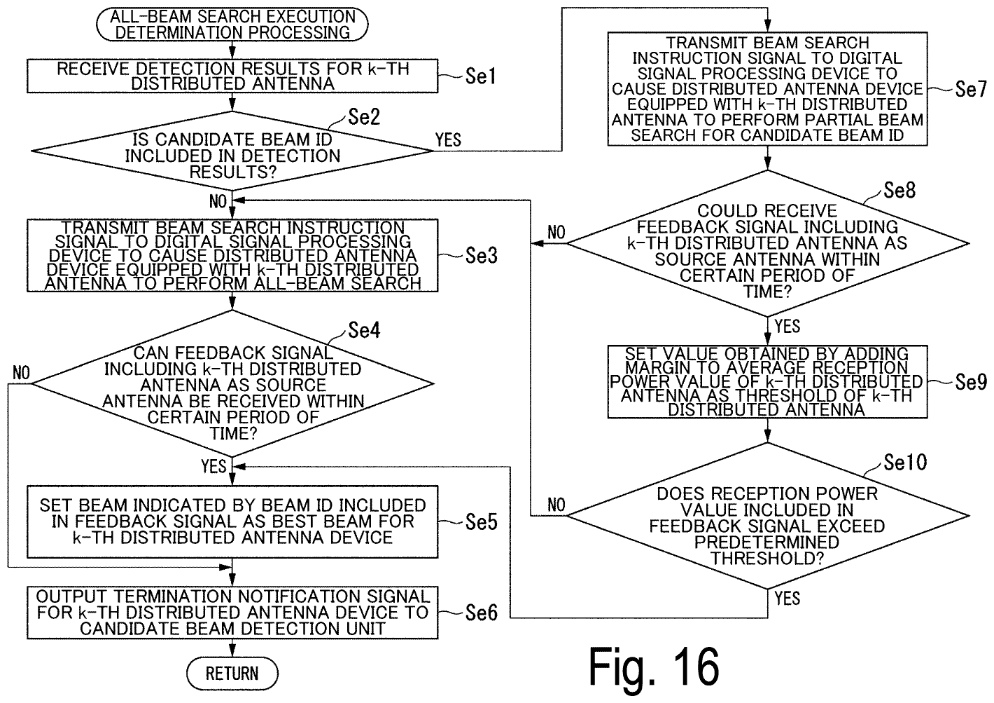

FIG. 15 is a flowchart showing the beam search processing of the second embodiment, and FIG. 16 is a flowchart showing the subroutine of the all-beam search execution determination performed in step Sd6 of FIG. 15. In FIG. 15, in processing of steps Sd1 and Sd2, processing of loop Ld1s to Ld1e for repeating the processing of steps Sd1 and Sd2, and processing of step Sd3, the same processing as the processing of steps Sb1 and Sb2, the processing of loop Lb1s to Lb1e for repeating the processing of steps Sb1 and Sb2, and the processing of step Sb3 in FIG. 10 is performed by the beam search execution instruction unit 11, the feedback signal receiving unit 12, the digital signal processing device 20, and the distributed antenna devices 30-1 to 30-4, and processing performed by the candidate beam detection unit 15 is performed by the candidate beam detection unit 15a. In the processing of step Sd7, the above-described processing is performed by the beam combination recording unit 17a.

In the processing of loop Ld2s to Ld2e, when k=3, the candidate beam detection unit 15a cannot detect the candidate beam ID corresponding to “distributed antenna ID #3” from the beam combination history table 140a as in the first embodiment. Therefore, in this case, the candidate beam detection unit 15a cannot detect the reception power value. Therefore, the candidate beam detection unit 15a does not calculate the average reception power value and outputs detection results that there is no candidate beam ID indicating a candidate beam which is the beam of the third distributed antenna device 30-3 and has been selected together with the detection reference beam similarly to the processing of step Sb4 of the first embodiment. The candidate beam detection unit 15a generates data indicating the detection results including only “distributed antenna ID #3” (step Sd4 when k=3).

The candidate beam detection unit 15a outputs data indicating the detection results including only “distributed antenna ID #3” to the beam search execution determination unit 16a (step Sb5 when k=3). When the beam search execution determination unit 16a receives data indicating the detection results from the candidate beam detection unit 15a, the beam search execution determination unit 16a starts a subroutine for all-beam search execution determination processing shown in FIG. 16 (step Sd6 when k=3).

The subroutine of the all-beam search execution determination processing performed in step Sd6 of the beam search processing of the second embodiment will be described with reference to FIG. 16. In the processing of steps Se1 to Se6, the same processing as steps Sc1 to Sc6 shown in FIG. 11 is performed by the beam search execution instruction unit 11, the feedback signal receiving unit 12, the digital signal processing device 20, and the distributed antenna devices 30-1 to 30-4, and processing performed by the beam search execution determination unit 16 is performed by the beam search execution determination unit 16a. Therefore, in the case of k=3, the beam search execution determination unit 16a determines “No” in the determination processing of step Se2, and the processing proceeds to step Se3. After that, the same processing as in the case of k=3 in the first embodiment is performed.

Assume that the processing of loop Ld2s to Ld2e shown in FIG. 15 has progressed to the processing in the case of k=4. Similarly to the first embodiment, the candidate beam detection unit 15a detects the beam ID of the beam of the fourth distributed antenna device 30-4 that has been selected together with the detection reference beam from the beam combination history table 140a. Here, the detection reference beam is a beam identified by “beam ID #33” of “distributed antenna ID #2.” In the beam combination history table 140a, “beam ID #33” of “distributed antenna ID #2” corresponding to the detection reference beam is included in “record ID #2,” “record ID #4,” and “record ID #6.” “Beam ID #15,” “beam ID #16,” and “beam ID #15” are written in the “distributed antenna ID #4” items of “record ID #2,” “record ID #4,” and “record ID #6.”

Therefore, the candidate beam detection unit 15a detects “beam ID #15” and “beam ID #16” as the beam IDs of beams of the fourth distributed antenna device 30-4 that have been selected together with the detection reference beam from the beam combination history table 140. The candidate beam detection unit 15a sets “beam ID #15” and “beam ID #16” as candidate beam IDs indicating candidate beams of the distributed antenna device 30-4 corresponding to “distributed antenna ID #4.”

The candidate beam detection unit 15a further detects “(reception power value 2-4)” of “record ID #2” and “(reception power value 6-4)” of “record ID6” for “beam ID #15” and detects “(reception power value 4-4)” of “record ID #4” for “beam ID #16.” The candidate beam detection unit 15a calculates the average value of “(reception power value 2-4)” and “(reception power value 6-4)” corresponding to “beam ID #15.” Since there is only “(reception power value 4-4)” for “beam ID #16,” “(reception power value 4-4)” is used as the average value. The candidate beam detection unit 15a sets the maximum average value of the average value corresponding to “beam ID #15” and the average value of “beam ID #16” as the average reception power value for “distributed antenna ID #4.” The candidate beam detection unit 15 generates data indicating detection results including “distributed antenna ID #4,” “beam ID #15,” which is a candidate beam ID, “beam ID #16,” and the calculated average reception power value (step Sd4 when k=4). The candidate beam detection unit 15a outputs the generated data indicating the detection results to the beam search execution determination unit 16a (step Sd5 when k=4).

In the processing of step Se1 of the subroutine for all-beam search execution determination processing in FIG. 16, which is performed in the subsequent processing of step Sd6, the beam search execution determination unit 16a receives the detection result data output by the candidate beam detection unit 15a, and determines that a candidate beam ID is included in the received data indicating the detection results in the processing of step Se2 (Yes in step Se2 when k=4).

In the processing in steps Se7 and Se8, the same processing as steps Sc7 and Sc8 in FIG. 11 is performed by the beam search execution instruction unit 11, the feedback signal receiving unit 12, the digital signal processing device 20, and the distributed antenna device 30-4, and the processing performed by the beam search execution determination unit 16 is performed by the beam search execution determination unit 16a. If the beam search execution determination unit 16a determines “Yes” in the determination processing of step Se8, the beam search execution determination unit 16a reads the average reception power value included in the data indicating the detection results, adds a margin to the read average reception power value, and calculates a threshold for “distributed antenna ID #4” (step Se9). The beam search execution determination unit 16a determines whether the reception power value included in the feedback signal exceeds the threshold calculated for the source antenna ID (here, “distributed antenna ID #4”) included in the feedback signal (step Se10 when k=4).

If the beam search execution determination unit 16a determines that the reception power value included in the feedback signal exceeds the threshold calculated for the source antenna ID included in the feedback signal (Yes in step Se10), then the processing proceeds to step Se5. On the other hand, if the beam search execution determination unit 16a determines that the reception power value included in the feedback signal does not exceed the threshold calculated for the source antenna ID included in the feedback signal (No in step Se10), then the processing proceeds to step Se3.

As a result, in the second embodiment, in a case where the beam search execution determination unit 16a determines that any of the distributed antenna devices 30-1 to 30-4 is caused to perform a partial beam search, if the reception power value included in the feedback signal acquired through the partial beam search is approximately equal to the past average reception power value of the distributed antenna devices 30-1 to 30-4 for the partial beam search, the beam indicated by the beam ID included in the feedback signal can be searched for as the best beam of the distributed antenna devices 30-1 to 30-4 corresponding to the source antenna ID included in the feedback signal. The beam search execution determination unit 16a can add data related to the beam to the beam combination history table 140a. On the other hand, if the reception power value included in the feedback signal acquired through the partial beam search is not approximately equal to the past average reception power value of the distributed antenna devices 30-1 to 30-4 for the partial beam search, the beam search execution determination unit 16a causes the distributed antenna devices 30-1 to 30-4 corresponding to the source antenna ID included in the feedback signal to perform all-beam search. If the beam search execution determination unit 16 can acquire a feedback signal through the all-beam search, it is possible to search for the best beam for the distributed antenna devices 30-1 to 30-4 for the all-beam search, and if it is not possible to acquire the feedback signal, it is impossible to search for the best beam for the distributed antenna devices 30-1 to 30-4 for all-beam search. Therefore, in the second embodiment, in addition to the effects achieved by the communication control device 10 of the first embodiment, the best beam can be searched more accurately than in the first embodiment when performing a partial beam search.

In the first embodiment described above, it is possible to further reduce the possibility that a beam which is not best in terms of communication quality is selected by setting a predetermined threshold of a reception power value higher. However, in this case, the all-beam search is performed with respect to more distributed antenna devices in the first embodiment, and thus it is difficult to reduce the number of beam searches. Further, since the optimum threshold changes depending on the position of a terminal device or the like, it is difficult to set a threshold for selecting the best beam as a uniform value while reducing the number of beam searches. On the other hand, in the second embodiment, the threshold is substantially changed for each position of the terminal device 40 by changing the threshold for each combination of beams, and thus the threshold is adaptively set.

Although the method in which the average value of reception power values for each detected beam ID is used as a reference has been described in the second embodiment, the reference is not limited to the average value. For example, the value used as the reference may be a median value, a mode value, a maximum value, or a minimum value. Further, when a maximum value, a minimum value or an average value is used as the reference among these values, other records may be deleted by calculating the value every time by a combination of the same beam IDs.

In the first embodiment described above, in the beam search processing shown in FIG. 10, the candidate beam detection unit 15 performs processing of causing all the distributed antenna devices 30-1 to 30-4 to perform all-beam search in order. Upon receiving one feedback signal during the processing, the candidate beam detection unit 15 ends the processing of loop Lb1s to Lb1e and sets the best beam identified by the source antenna ID and the beam ID included in the received feedback signal as a detection reference beam. Then, the candidate beam detection unit 15 detects a beam that has been selected together with the detection reference beam as a candidate beam from the beam combination history table 140.

Similarly, in the second embodiment, in the beam search processing shown in FIG. 15, the candidate beam detection unit 15a also performs processing of causing all the distributed antenna devices 30-1 to 30-4 to perform all-beam search in order. Upon receiving one feedback signal during the processing, the candidate beam detection unit 15 ends the processing of loop Ld1s to Ld1e and sets the best beam identified by the source antenna ID and the beam ID included in the received feedback signal as a detection reference beam. Then, the candidate beam detection unit 15a detects a beam that has been selected together with the detection reference beam as a candidate beam from the beam combination history table 140a.

In this manner, in the first and second embodiments, processing of causing all the distributed antenna devices 30-1 to 30-4 to perform all-beam search in order, and a detection reference beam is selected. Then, partial beam search is performed on a candidate beam which is a beam that has been selected together with the detection reference beam. Then, if the reception power value included in the feedback signal exceeds a predetermined threshold in the partial beam search, a beam based on the feedback signal is selected.

However, the beam selected in this manner is a beam in which the reception power value exceeds the predetermined threshold, and is not always the best beam in terms of communication quality. In a case where a beam in which the reception power value exceeds a threshold is selected, all-beam search is not performed for a distributed antenna device which is a beam search target, and the beam combination history table is not updated. Therefore, in a case where all-beam search is performed in a fixed order for the distributed antenna devices 30-1 to 30-4, a combination of beams which are not best may be continuously selected.

On the other hand, the possibility that a beam which is not best in terms of communication quality is selected can be further reduced by setting a threshold to be high. However, in this case, since all-beam search is performed for more distributed antenna devices, it is difficult to reduce the number of beam searches.

A wireless communication system 1b in a third embodiment and a wireless communication system 1c in a fourth embodiment which will be described below do not perform all-beam searches in a fixed order for the distributed antenna devices 30-1 to 30-4 but perform all-beam searches in a random order for the distributed antenna devices 30-1 to 30-4 at the first stage of beam search processing. With such a configuration, in the third and fourth embodiments which will be described below, all-beam search is performed at random timing even for a distributed antenna device in which all-beam search has not been performed by selecting a beam which is not the best beam but whose reception power value exceeds a threshold by partial beam search. Accordingly, the beam combination history table is also updated. Therefore, according to the third and fourth embodiments which will be described below, it is possible to reduce the number of beam searches and prevent a combination of beams which are not best from being continuously selected fixedly.

### Third Embodiment

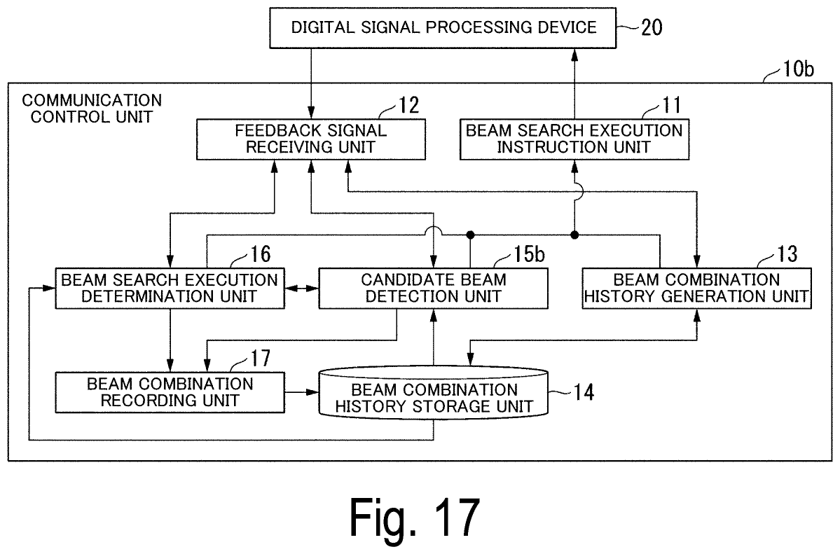

FIG. 17 is a block diagram showing a configuration of a communication control device 10b in the third embodiment. The communication control device 10b is a device used in place of the communication control device 10 of the first embodiment, and for convenience of description, the wireless communication system 1 including the communication control device 10b instead of the communication control device 10 will be referred to as a wireless communication system 1b hereinafter. In the communication control device 10b, the same components as those of the communication control device 10 of the first embodiment are denoted by the same reference numerals, and different components will be described below.

The configurations of the wireless communication system 1b in the third embodiment differs from the configuration of the wireless communication system 1 in the first embodiment in that all-beam searches are not performed by a plurality of distributed antennas in a fixed order, but a distributed antenna device is randomly selected and an all-beam search is performed at the first stage of beam search processing.

The communication control device 10b includes a beam search execution instruction unit 11, a feedback signal receiving unit 12, a beam combination history generation unit 13, a beam combination history storage unit 14, a candidate beam detection unit 15b, a beam search execution determination unit 16, and a beam combination recording unit 17.

When beam search processing for searching for a beam is started, the candidate beam detection unit 15b causes the distributed antenna devices 30-1 to 30-4 to perform all-beam search one by one in a random order. That is, the candidate beam detection unit 15b designates the distributed antenna IDs of the distributed antennas 31-1 to 31-4 one by one in random order, and outputs an all-beam search request signal including designated one distributed antenna ID to the beam search execution instruction unit 11. Upon receiving the first feedback signal after the beam search processing is started, the candidate beam detection unit 15b stops the all-beam search and sets a beam identified by a source antenna ID and a beam ID included in the feedback signal as a detection reference beam.

The candidate beam detection unit 15b detects, from the beam combination history table 140, the beam IDs of the distributed antenna devices 30-1 to 30-4 that have not performed the all-beam search during a beam search period, the beam IDs corresponding to beams that have been selected together with the detection reference beam, and the distributed antenna IDs corresponding to the beam IDs. The candidate beam detection unit 15b sets the detected beam IDs as beam IDs indicating candidate beams in the distributed antenna devices 30-1 to 30-4 corresponding to the detected distributed antenna IDs and outputs a combination of the detected distributed antenna IDs and candidate beam IDs as a detection result.

### (Processing Performed by Wireless Communication System of Third Embodiment)

Similarly to the first embodiment, the beam combination generation processing in step S1 and the beam search processing in step S2, shown in FIG. 8, are also performed in the wireless communication system 1b of the third embodiment. However, the beam combination generation processing performed in the third embodiment differ from the processing performed in the first embodiment with respect to the points described below.

### (Beam Combination Generation Processing of Third Embodiment)

Beam combination generation processing shown in FIG. 9, which is the same processing as in the first embodiment, is performed by the beam search execution instruction unit 11, the feedback signal receiving unit 12, the beam combination history generation unit 13, the digital signal processing device 20, and the distributed antenna devices 30-1 to 30-4.

### (Beam Search Processing of Third Embodiment)

FIG. 18 is a flowchart showing a flow of beam search processing of the third embodiment. FIG. 18 is a flowchart showing the flow of the beam search processing performed in the processing of step S2 in FIG. 8. As a premise for starting the beam search processing shown in FIG. 8, it is assumed that the beam combination history table 140 shown in FIG. 4 has been generated in the beam combination history storage unit 14.

In FIG. 18, in processing of steps Sf1 and Sf2 and processing of loop Lf1s to Lf1e for repeating the processing of steps Sf1 and Sf2, the aforementioned processing is performed by the candidate beam detection unit 15b. In processing of step Sf3, processing of steps Sf4 to Sf6, processing of loop Lf2s to Lf2e for repeating the processing of steps Sf4 to Sf6, and processing of step Sf7, the same processing as the processing of step Sb3, the processing of Sb4 to Sb6, the processing of loop Lb2s to Lb2e for repeating the processing of steps Sb4 and Sb6, and the processing of step Sb7 in FIG. 10 is performed by the beam search execution instruction unit 11, the feedback signal receiving unit 12, the beam combination recording unit 17, the digital signal processing device 20, and the distributed antenna devices 30-1 to 30-4, and processing performed by the candidate beam detection unit 15 is performed by the candidate beam detection unit 15b.

In response to an operation of the operator of the wireless communication system 1b, the candidate beam detection unit 15b of the communication control device 10b starts beam search processing. The candidate beam detection unit 15b starts an internal beam search cycle timer. When starting the beam search cycle timer, the candidate beam detection unit 15b sets a time indicating the duration of one predetermined beam search cycle.

The candidate beam detection unit 15b reads all distributed antenna IDs written in the distributed antenna ID item of the beam combination history table 140 stored in the beam combination history storage unit 14. The candidate beam detection unit 15b provides a variable i in an internal storage area thereof. Here, although i is a variable that is an integer value from 1 to N, the wireless communication system 1 in FIG. 1 includes four distributed antenna devices 30-1 to 30-4, and the candidate beam detection unit 15b reads four distributed antenna IDs, “distributed antenna ID #1,” “distributed antenna ID #2,” “distributed antenna ID #3,” and “distributed antenna ID #4” from the beam combination history table 140, and thus it is assumed that N=4 in the following description. The following description will be made assuming that the i-th distributed antenna device is a distributed antenna device 30-i, the i-th distributed antenna is a distributed antenna 31-i, and the i-th main device is a main device 32-i.

The candidate beam detection unit 15b outputs an output destination switching instruction signal for setting an output destination to the candidate beam detection unit 15b to the feedback signal receiving unit 12. Upon receiving the output destination switching instruction signal for setting the output destination to the candidate beam detection unit 15b from the candidate beam detection unit 15b, the feedback signal receiving unit 12 sets the candidate beam detection unit 15b as the output destination of the feedback signal.

The candidate beam detection unit 15b randomly selects one of 1 to N as the value of the variable i. The candidate beam detection unit 15b writes and records possible values (i.e., 1 to N) of the variable i and values which have already been selected in the internal storage area. Here, it is assumed that “4” is selected as the value of the variable i, for example. When i=4, the following processing is performed. That is, in order to cause the distributed antenna device 30-4 including the fourth distributed antenna 31-4 to perform all-beam search, the candidate beam detection unit 15b outputs an all-beam search request signal including “distributed antenna ID #4” which is the distributed antenna ID assigned to the fourth distributed antenna 31-4 to the beam search execution instruction unit 11.

After outputting the all-beam search request signal to the beam search execution instruction unit 11, the candidate beam detection unit 15b starts an internal feedback signal timer. When starting the feedback signal timer, the candidate beam detection unit 15b sets the same time as that set in the feedback signal timer by the beam combination history generation unit 13 in the processing of step Sa1 in FIG. 9. Note that the time is a predetermined time and is set in the candidate beam detection unit 15b in advance. When the beam search execution instruction unit 11 receives the all-beam search request signal output by the candidate beam detection unit 15b, processing after the beam search execution instruction unit 11 receives the all-beam search request signal in the processing of step Sa1 in FIG. 9 is performed by the beam search execution instruction unit 11, the digital signal processing device 20, the main device 32-4, the distributed antenna 31-4, and the terminal device 40 with i=4 (steps Sf1 when i=4).

The candidate beam detection unit 15b determines whether a feedback signal including “distributed antenna ID #4,” which is the distributed antenna ID of the fourth distributed antenna 31-4, as the source antenna ID has been received before the feedback signal timer expires (step Sf2 when i=4).

Here, it is assumed that any of the events in cases where the beam combination history generation unit 13 cannot receive the feedback signal has occurred. In this case, the candidate beam detection unit 15b determines that the feedback signal including “distributed antenna ID #4,” which is the distributed antenna ID of the fourth distributed antenna 31-4 as the source antenna ID has not been received before the feedback signal timer expires (No in step Sf2). Unless as many values of the variable i as the number N of distributed antennas have been selected in a random order at that time (that is, unless all possible values of the variable i have been selected), the candidate beam detection unit 15b randomly selects one value which is not selected among 1 to N as the value of the variable i. Here, it is assumed that “2” is selected as the value of the variable i, for example. Then, the processing of steps Sf1 and Sf2 is performed again (loops Lf1s to Lf1e).

When i=2, the candidate beam detection unit 15b performs the following processing as the second processing of loop Lf1s to Lf1e. That is, in order to cause the distributed antenna device 30-2 including the second distributed antenna 31-2 to perform all-beam search, the candidate beam detection unit 15b outputs an all-beam search request signal including “distributed antenna ID #2,” which is the distributed antenna ID assigned to the second distributed antenna 31-2, to the beam search execution instruction unit 11. After outputting the all-beam search request signal to the beam search execution instruction unit 11, the candidate beam detection unit 15b starts an internal feedback signal timer. When starting the feedback signal timer, the candidate beam detection unit 15b sets the same time as that set in the feedback signal timer by the beam combination history generation unit 13 in the processing of step Sa1 in FIG. 9. When the beam search execution instruction unit 11 receives the all-beam search request signal output by the candidate beam detection unit 15b, processing after the beam search execution instruction unit 11 receives the all-beam search request signal in the processing of step Sa1 in FIG. 9 is performed by the beam search execution instruction unit 11, the digital signal processing device 20, the main device 32-2, the distributed antenna 31-2, and the terminal device 40 with i=2 (steps Sf1 when i=2).

The candidate beam detection unit 15b determines whether a feedback signal including “distributed antenna ID #2,” which is the distributed antenna ID of the second distributed antenna 31-2, as the source antenna ID has been received before the feedback signal timer expires (step Sf2 when i=2). Here, it is assumed that any of the above-described events in cases where the beam combination history generation unit 13 cannot receive the feedback signal has not occurred, and the feedback signal receiving unit 12 outputs the feedback signal to the candidate beam detection unit 15b. In this case, the candidate beam detection unit 15b determines that the feedback signal including “distributed antenna ID #2,” which is the distributed antenna ID of the second distributed antenna 31-2, as the source antenna ID has been received before the feedback signal timer expires (Yes in step Sf2 when i=2).

The candidate beam detection unit 15b exits the processing of loop Lf1s to Lf1e and sets the beam ID included in the received feedback signal as the beam ID indicating the best beam for the second distributed antenna device 30-2. The candidate beam detection unit 15b sets the beam identified by the beam ID and “distributed antenna ID #2,” which is the source antenna ID included in the feedback signal, as a detection reference beam. Here, it is assumed that the beam ID included in the feedback signal received by the candidate beam detection unit 15b is “beam ID #33.”

The candidate beam detection unit 15b combines the source antenna ID, beam ID, and reception power value included in the feedback signal into one set of data, and outputs the one set of data to the beam combination recording unit 17. The beam combination recording unit 17 receives the one set of data output by the candidate beam detection unit 15b. The candidate beam detection unit 15b outputs an output destination switching instruction signal for setting the output destination to the beam search execution determination unit 16 to the feedback signal receiving unit 12. Upon receiving the output destination switching instruction signal for setting the output destination to the beam search execution determination unit 16 from the candidate beam detection unit 15b, the feedback signal receiving unit 12 sets the output destination of the feedback signal to the beam search execution determination unit 16 (step SB).

In other words, regarding the processing in steps Sf2 and Sf3 above, the candidate beam detection unit 15b performs processing of causing all the distributed antenna devices 30-1 to 30-4 to perform all-beam search in a random order, and when one feedback signal is received during the processing, the candidate beam detection unit 15b ends the processing of loop Lf1s to Lf1e and sets the beam identified by the source antenna ID and beam ID included in the received feedback signal as a detection reference beam.

At this time, there are only two distributed antenna devices 30-1 and 30-3 that have not performed the all-beam search in the beam search period. If the wireless communication system 1b includes N distributed antenna devices 30-1 to 30-N, at the time of exiting loop Lf1s to Lf1e, a distributed antenna device 30-k that has not performed all-beam search is identified using values of the variable i that have been selected up to that time and the value of N. Here, the variable k has values of “1” and “3.” The candidate beam detection unit 15b writes and records possible values of the variable k and values that have already been selected in an internal storage area.

The candidate beam detection unit 15b performs the following processing when k=1. That is, the candidate beam detection unit 15b detects the beam ID of the beam of the first distributed antenna device 30-1, which has been selected together with the detection reference beam, from the beam combination history table 140. Here, the detection reference beam is a beam identified by “beam ID #33” of “distributed antenna ID #2.” In the beam combination history table 140, “beam ID #33” of “distributed antenna ID #1” corresponding to the detection reference beam is included in “record ID #2,” “record ID #4,” and “record ID #6.” “Beam ID #13” and “beam ID #25” are written in the “distributed antenna ID #1” of “Record ID #2,” “record ID #4,” and “record ID #6.”

Therefore, the candidate beam detection unit 15b detects “beam ID #13” and “beam ID #25” as the beam ID of the beam of the first distributed antenna device 30-1, which has been selected together with the detection reference beam, from the beam combination history table 140. The candidate beam detection unit 15b sets “beam ID #13” and “beam ID #25” as candidate beam IDs indicating candidate beams of the distributed antenna device 30-1 corresponding to “distributed antenna ID #1.” The candidate beam detection unit 15b generates data indicating detection results including “distributed antenna ID #1,” “beam ID #13” and “beam ID #25 that are candidate beam IDs (step Sf4 when k=1). The candidate beam detection unit 15b outputs the generated data indicating the detection results to the beam search execution determination unit 16 (step Sf5 when k=1). Upon receiving the data indicating the detection results from the candidate beam detection unit 15b, the beam search execution determination unit 16 starts a subroutine for all-beam search execution determination processing shown in FIG. 11 (step Sf6 when k=1).

The beam search execution determination unit 16 receives the data indicating the detection results output by the candidate beam detection unit 15b (step Sc1 when k=1). The beam search execution determination unit 16 determines whether the candidate beam ID is included in the received data indicating the detection results (step Sc2 when k=1). Here, since the data indicating the detection results includes “beam ID #13” and “beam ID #25,” the beam search execution determination unit 16 determines that candidate beam IDs are included in the received data indicating the detection results (Yes in step Sc2 when k=1).

The beam search execution determination unit 16 outputs a partial beam search request signal including “distributed antenna ID #1,” “beam ID #13,” and “beam ID #25” to the beam search execution instruction unit 11 in order to cause the distributed antenna device 30-1 including the first distributed antenna 31-1 to perform partial beam search. After outputting the partial beam search request signal to the beam search execution instruction unit 11, the beam search execution determination unit 16 starts an internal feedback signal timer. When starting the feedback signal timer, the beam search execution determination unit 16 sets the same time as that set in the feedback signal timer by the beam combination history generation unit 13 in the processing of step Sa1 in FIG. 9.

The beam search execution instruction unit 11 receives the partial beam search request signal output by the beam search execution determination unit 16, and reads “distributed antenna ID #1,” “beam ID #13,” and “beam ID #25” included in the partial beam search request signal. The beam search execution instruction unit 11 generates a beam search instruction signal including “distributed antenna ID #1” and “beam ID #13” and a beam search instruction signal including “distributed antenna ID #1” and “beam ID #25.” The beam search execution instruction unit 11 outputs the two generated beam search instruction signals one by one to the digital signal processing device 20 at predetermined fixed time intervals in the order of generation. The digital signal processing device 20 sequentially receives the two beam search instruction signals output by the beam search execution instruction unit 11. Thereafter, the processing after the digital signal processing device 20 receives the beam search instruction signal in the processing of step Sa1 in FIG. 9, is performed by the digital signal processing device 20, the main device 32-1, the distributed antenna 31-1, and the terminal device 40 with i=1 (step Sc7 when k=1).

The beam search execution determination unit 16 determines whether a feedback signal including “distributed antenna ID #1,” which is the distributed antenna ID of the first distributed antenna 31-1, as the source antenna ID has been received before the feedback signal timer expires (step Sc8).

For example, it is assumed that one of the above-mentioned events of the case where the beam combination history generation unit 13 could not receive the feedback signal has occurred. In this case, the beam search execution determination unit 16 determines that the feedback signal including “distributed antenna ID #1,” which is the distributed antenna ID of the first distributed antenna 31-1, as the source antenna ID has not been received before the feedback signal timer expires (No in step Sc8 when k=1), and processing proceeds to step Sc3.

On the other hand, it is assumed that any of the above-described events of the case where the beam combination history generation unit 13 could not receive the feedback signal has not occurred, and the feedback signal receiving unit 12 outputs the feedback signal to the beam search execution determination unit 16. In this case, the beam search execution determination unit 16 determines that the feedback signal including “distributed antenna ID #1,” which is the distributed antenna ID of the first distributed antenna 31-1, as the source antenna ID has been received before the feedback signal timer expires (Yes in step Sc8 when k=1).

In this case, the beam search execution determination unit 16 determines whether the reception power value included in the feedback signal exceeds a predetermined threshold (step Sc9 when k=1). When the beam search execution determination unit 16 determines that the reception power value included in the feedback signal does not exceed the predetermined threshold (No in step Sc9 when k=1), the processing proceeds to step Sc3. On the other hand, if the beam search execution determination unit 16 determines that the reception power value included in the feedback signal exceeds the predetermined threshold (Yes in step Sc9 when k=1), the processing proceeds to step Sc5.

In other words, regarding the processing of steps Sc7, Sc8, and Sc9, the beam search execution determination unit 16 causes the distributed antenna device 30-1 corresponding to “distributed antenna ID #1” to perform partial beam search for transmitting a beam corresponding to “beam ID #13” and a beam corresponding to “beam ID #25.” If no feedback signal is obtained by the partial beam search, the beam search execution determination unit 16 advances the processing to step Sc3 and causes the distributed antenna device 30-1 corresponding to “distributed antenna ID #1” to perform all-beam search to search for the best beam for the distributed antenna device 30-1 again. In the all-beam search in this case, the beam search execution determination unit 16 searches for only the beam corresponding to the “beam ID #13” and the beam other than the beam corresponding to the “beam ID #25”.

Then, when a feedback signal in which “distributed antenna ID #1” is included as a source antenna ID is captured before a feedback signal timer expires in step SC4, a beam search execution determination unit 16 advances processing to step SC5, the beam ID included in the feedback signal is defined as data to be added to the beam combination history table 140.

On the other hand, in a case where a feedback signal is obtained by the partial beam search, when the reception power value included in the feedback signal, that is, the reception power value of the beam selected as the best beam for the terminal device 40, does not exceed the threshold, the beam search execution determination unit 16 determines that the beam indicated by the feedback signal is an inappropriate beam that cannot be used for normal operation. Therefore, the beam search execution determination unit 16 advances the processing to step Sc3 and causes the distributed antenna device 30-1 corresponding to “distributed antenna ID #1” to perform all-beam search to search for the best beam for the distributed antenna device 30-1 again. In the all-beam search in this case, the beam search execution determination unit 16 searches for only the beam corresponding to the “beam ID #13” and the beam other than the beam corresponding to the “beam ID #25”.

Then, when a feedback signal in which “distributed antenna ID #1” is included as a source antenna ID is captured before a feedback signal timer expires in step SC4, a beam search execution determination unit 16 advances processing to step SC5, the beam ID included in the feedback signal is defined as data to be added to the beam combination history table 140.

On the other hand, when the reception power value included in the feedback signal exceeds the threshold, the beam search execution determination unit 16 advances the processing to step Sc5 to determine that the beam is the best beam for the distributed antenna device 30-1. In this case, since the beam search execution determination unit 16 can determine that the beam is an appropriate beam that can be used for normal operation without performing an all-beam search for the distributed antenna device 30-1, the number of beam searches can be reduced.

If there is a value that has never been selected among possible values (here, “1” and “3”) of the variable k at that time, the candidate beam detection unit 15b detects the value that has never been selected, and processing of steps Sf4 to Sf6 is performed again (loop Lf2s to Lf2e). Here, since “3” is not selected yet among the possible values (here, “1” and “3”) of the variable k, the candidate beam detection unit 15b sets “3” as a new value of k.

The candidate beam detection unit 15b performs the following processing when k=3 (with respect to the case of “3” which is another possible value of the variable k). That is, the candidate beam detection unit 15b detects the beam of the third distributed antenna device 30-3, which has been selected together with the detection reference beam, as a candidate beam from the beam combination history table 140. Here, the detection reference beam is a beam identified by “beam ID #33” of “distributed antenna ID #2”. In the beam combination history table 140, “beam ID #33” of “distributed antenna ID #2” corresponding to the detection reference beam is included in “record ID #2,” “record ID #4,” and “record ID #6,” but the “distributed antenna ID #3” items of “record ID #2”, “record ID #4”, and “record ID #6” are blank. Therefore, the candidate beam detection unit 15b outputs detection results that there is no candidate beam ID indicating a candidate beam that is a beam of the third distributed antenna device 30-3 and has been selected together with the detection reference beam. The candidate beam detection unit 15b generates data indicating the detection results including only “distributed antenna ID #3” (step Sf4 when k=3).

The candidate beam detection unit 15b outputs data indicating the detection results including only “distributed antenna ID #3” to the beam search execution determination unit 16 (step Sf5 when k=3). Upon receiving the data indicating the detection results from the candidate beam detection unit 15b, the beam search execution determination unit 16 starts a subroutine for all-beam search execution determination processing shown in FIG. 11 (step Sf6 when k=3).

When the candidate beam detection unit 15b receives a termination notification signal output from the beam search execution determination unit 16, if there is a value that has never been selected among the possible values (here, “1” and “3”) of the variable k at that time, the candidate beam detection unit 15b selects the value that has never been selected, and the processing of steps Sf4 to Sf6 is performed again (loop Lf2s to Lf2e).

When the candidate beam detection unit 15b receives the termination notification signal output from the beam search execution determination unit 16, if there is a value that has never been selected among the possible values (here, “1” and “3”) of the variable k at that time, the candidate beam detection unit 15b ends the processing of loop Lf2s to Lf2e and advances the processing to step Sf7. Here, since there is no value which has never been selected among the possible values of the variable k at that time, the processing of loop Lf2s to Lf2e ends and processing proceeds to processing of step SF7.

The beam combination recording unit 17 removes the reception power value from the set of data received in the processing of step Sf3 and the processing of step Sc5, that is, the data that is a combination of the source antenna ID, beam ID, and reception power value, and generates one record in the beam combination history table 140 on the basis of the remaining data. That is, the beam combination recording unit 17 generates a new row in the beam combination history table 140, thereby generating “record ID #M+1” as a new record ID. The beam combination recording unit 17 writes “record ID #M+1” which is the generated new record ID in the “record ID” item of the generated new row. The beam combination recording unit 17 records the corresponding beam ID in each element of “distributed antenna ID #1”, “distributed antenna ID #2”, “distributed antenna ID #3”, and “distributed antenna ID #4” in the row of “record ID #M+1” based on the combination of the source antenna ID and the beam ID (step Sf7).

In the wireless communication system 1b of the third embodiment described above, the candidate beam detection unit 15b causes each of the plurality of distributed antennas 31-1 to 31-4 to perform all-beam search performed by transmitting beams in all transmittable directions in a beam search period for searching for a beam to be used for wireless communication with the terminal device 40, stops the all-beam search when one beam identifier indicating the best beam among beams according to the all-beam search has been acquired, sets a beam identified by the acquired beam identifier and information indicating distributed antennas 31-1 to 31-4 that have transmitted the beam indicated by the beam identifier as a detection reference beam, and detects, from the beam combination history storage unit 14, beam identifiers of distributed antennas 31-1 to 31-4 that have not performed the all-beam search in the beam search period, which have been selected together with the detection reference beam, as candidate beam identifiers for the distributed antennas 31-1 to 31-4.

The beam search execution determination unit 16 determines whether to cause the distributed antennas 31-1 to 31-4 that have not performed the all-beam search in the beam search period to perform the all-beam search on the basis of detection results from the candidate beam detection unit 15b. The beam combination recording unit 17 generates a record indicating a combination of beam identifiers indicating beams determined to be the best beams for the distributed antennas in the beam search period. The beam combination recording unit 17 records the generated record in the beam combination history storage unit 14. As a result, it is possible to obtain an effect that in the beam combination generation processing performed by the beam combination history generation unit 13, even when it is not possible to generate sufficient records indicating the history of beam combinations while moving the terminal device 40 little by little at intervals that do not reduce the transmission capacity throughout the cell 100 in the service providing area, it is possible to store a sufficiently large number of records to reduce the number of beam searches without reducing transmission capacity when performing beam search processing.

Further, the wireless communication system 1b in the third embodiment does not perform all-beam search in a fixed order for the distributed antenna devices 30-1 to 30-4 but performs all-beam search in a random order for the distributed antenna devices 30-1 to 30-4 at the first stage of beam search processing. With such a configuration, the wireless communication system 1b performs all-beam search at random timing even for a distributed antenna device in which all-beam search has not been performed by selecting a beam which is not the best beam but whose reception power value exceeds a threshold by partial beam search. Accordingly, the beam combination history table 140 is also updated. Therefore, according to the wireless communication system 1b in the third embodiment, it is possible to prevent a combination of beams which are not best from being continuously selected fixedly while reducing the number of beam searches.

### Fourth Embodiment

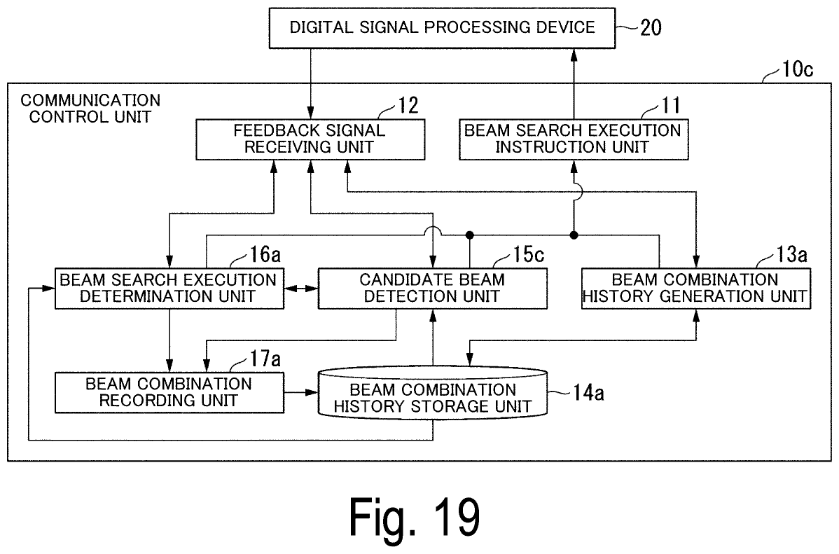

FIG. 19 is a block diagram showing a configuration of a communication control device 10c in a fourth embodiment. The communication control device 10c is a device used in place of the communication control device 10a of the second embodiment, and for convenience of description, the wireless communication system 1a including the communication control device 10c instead of the communication control device 10a will be referred to as a wireless communication system 1c below. In the communication control device 10c, the same components as whose of the communication control device 10a of the second embodiment are denoted by the same reference numerals, and different components will be described below.

The configurations of the wireless communication system 1c in the fourth embodiment differs from the configuration of the wireless communication system 1a in the second embodiment in that all-beam search is not performed by a plurality of distributed antenna devices in a fixed order, and distributed antenna devices are randomly selected and all-beam search is performed at the first stage of beam search processing.

The communication control device 10c includes a beam search execution instruction unit 11, a feedback signal receiving unit 12, a beam combination history generation unit 13a, a beam combination history storage unit 14a, a candidate beam detection unit 15c, a beam search execution determination unit 16a, and a beam combination recording unit 17a.

When beam search processing for searching for a beam is started, the candidate beam detection unit 15c causes the distributed antenna devices 30-1 to 30-4 to perform all-beam search one by one in a random order. That is, the candidate beam detection unit 15c designates the distributed antenna IDs of the distributed antennas 31-1 to 31-4 one by one in random order, and outputs an all-beam search request signal including designated one distributed antenna ID to the beam search execution instruction unit 11. Upon receiving the first feedback signal after beam search processing is started, the candidate beam detection unit 15c stops all-beam search and sets a beam identified by a source antenna ID and a beam ID included in the feedback signal as a detection reference beam. The candidate beam detection unit 15c detects, from the beam combination history table 140a shown in FIG. 14, for example, beam IDs of distributed antenna devices 30-1 to 30-4 that have not performed the all-beam search during a beam search period, the beam IDs corresponding to beams that have been selected together with the detection reference beam, and distributed antenna IDs corresponding to the beam IDs.

In such a case, the candidate beam detection unit 15c detects a reception power value written as an element together with the detected beam IDs in the beam combination history table 140a. The candidate beam detection unit 15c sets the detected beam IDs of candidate beams in the distributed antenna devices 30-1 to 30-4 corresponding to the detected distributed antenna IDs as candidate beam IDs, and outputs a combination of the detected distributed antenna IDs and the candidate beam IDs as detection results. The candidate beam detection unit 15c calculates the average values of the reception power values for each beam ID based on the combination of the detected beam ID and the detected reception power value, and sets the maximum value of the calculated average values as the average reception power value for the detected distributed antenna ID. The candidate beam detection unit 15c includes the calculated average reception power value in the data indicating the detection results.

### (Processing Performed by Wireless Communication System of Fourth Embodiment)

Similarly to the second embodiment, in the wireless communication system 1c of the fourth embodiment, the beam combination generation processing in step S1 and the beam search processing in step S2, shown in FIG. 8, are also performed. However, the beam search processing performed in the fourth embodiment differ from the processing performed in the second embodiment with respect to the points described below.

### (Beam Combination Generation Processing of Fourth Embodiment)

The same beam combination generation processing as that in the first embodiment shown in FIG. 9 is performed by the beam search execution instruction unit 11, the feedback signal receiving unit 12, the beam combination history generation unit 13a, the digital signal processing device 20, and the distributed antenna devices 30-1 to 30-4.

### (Beam Search Processing of Fourth Embodiment)

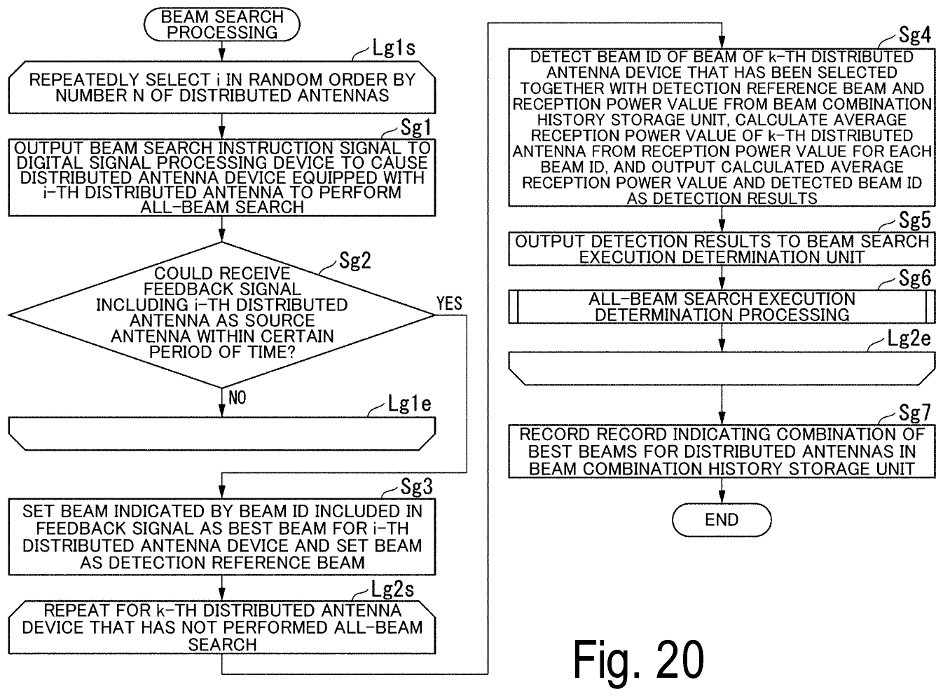

FIG. 20 is a flowchart showing a flow of beam search processing of the fourth embodiment. FIG. 20 is a flowchart showing the flow of the beam search processing performed in the processing of step S2 in FIG. 8.

In FIG. 20, in processing of steps Sg1 and Sg2, processing of loop Lg1s to Lg1e for repeating the processing of steps Sg1 and Sg2, and processing of step Sg3, the same processing as the processing of steps Sd1 and Sd2 in FIG. 15, the processing of loop Ld1s to Ld1e for repeating the processing of steps Sd1 and Sd2, and the processing of step Sd3 is performed by the beam search execution instruction unit 11, the feedback signal receiving unit 12, the digital signal processing device 20, and the distributed antenna devices 30-1 to 30-4, and processing performed by the candidate beam detection unit 15a is performed by the candidate beam detection unit 15c. In processing of step Sg7, the above-described processing is performed by the beam combination recording unit 17a.

In response to an operation of the operator of the wireless communication system 1c, the candidate beam detection unit 15c of the communication control device 10c starts beam search processing. The candidate beam detection unit 15c starts an internal beam search cycle timer. When starting the beam search cycle timer, the candidate beam detection unit 15c sets a time indicating the duration of one predetermined beam search cycle.

The candidate beam detection unit 15c reads all distributed antenna IDs written in the distributed antenna ID item of the beam combination history table 140a stored in the beam combination history storage unit 14a. The candidate beam detection unit 15c provides a variable i in an internal storage area thereof. Here, although i is a variable that is an integer value from 1 to N, the wireless communication system 1 in FIG. 1 includes four distributed antenna devices 30-1 to 30-4, and the candidate beam detection unit 15c reads four distributed antenna IDs, “distributed antenna ID #1,” “distributed antenna ID #2,” “distributed antenna ID #3,” and “distributed antenna ID #4” from the beam combination history table 140a, and thus it is assumed that N=4 in the following description. The following description will be made assuming that the i-th distributed antenna device is a distributed antenna device 30-i, the i-th distributed antenna is a distributed antenna 31-i, and the i-th main device is a main device 32-i.

The candidate beam detection unit 15c outputs an output destination switching instruction signal for setting an output destination to the candidate beam detection unit 15c to the feedback signal receiving unit 12. Upon receiving the output destination switching instruction signal for setting the output destination to the candidate beam detection unit 15c from the candidate beam detection unit 15c, the feedback signal receiving unit 12 sets the candidate beam detection unit 15c as the output destination of the feedback signal.

The candidate beam detection unit 15c randomly selects one of 1 to N as the value of the variable i. The candidate beam detection unit 15c writes and records possible values (i.e., 1 to N) of the variable i and values which have already been selected in the internal storage area. Here, it is assumed that “4” is selected as the value of the variable i, for example. When i=4, the following processing is performed. That is, in order to cause the distributed antenna device 30-4 including the fourth distributed antenna 31-4 to perform all-beam search, the candidate beam detection unit 15c outputs an all-beam search request signal including “distributed antenna ID #4” which is the distributed antenna ID assigned to the fourth distributed antenna 31-4 to the beam search execution instruction unit 11. After outputting the all-beam search request signal to the beam search execution instruction unit 11, the candidate beam detection unit 15c starts an internal feedback signal timer.

When starting the feedback signal timer, the candidate beam detection unit 15c sets the same time as that set in the feedback signal timer by the beam combination history generation unit 13a in the processing of step Sa1 in FIG. 9. Note that the time is a predetermined time and is set in the candidate beam detection unit 15c in advance. When the beam search execution instruction unit 11 receives the all-beam search request signal output by the candidate beam detection unit 15c, processing after the beam search execution instruction unit 11 receives the all-beam search request signal in the processing of step Sa1 in FIG. 9 is performed by the beam search execution instruction unit 11, the digital signal processing device 20, the main device 32-4, the distributed antenna 31-4, and the terminal device 40 with i=4 (steps Sg1 when i=4).

The candidate beam detection unit 15c determines whether a feedback signal including “distributed antenna ID #4,” which is the distributed antenna ID of the fourth distributed antenna 31-4, as the source antenna ID has been received before the feedback signal timer expires (step Sg2 when i=4).

Here, it is assumed that any of the above-mentioned events in cases where the beam combination history generation unit 13a cannot receive the feedback signal has occurred. In this case, the candidate beam detection unit 15c determines that the feedback signal including “distributed antenna ID #4,” which is the distributed antenna ID of the fourth distributed antenna 31-4 as the source antenna ID has not been received before the feedback signal timer expires (No in step Sg2). Unless as many values of the variable i as the number N of distributed antennas have been selected in a random order at that time (that is, unless all possible values of the variable i have been selected), the candidate beam detection unit 15c randomly selects one value which is not selected among 1 to N as the value of the variable i. Here, it is assumed that “2” is selected as the value of the variable i, for example. Then, the processing of steps Sg1 and Sg2 is performed again (loops Lg1s to Lg1e).

When i=2, the candidate beam detection unit 15c performs the following processing as the second processing of loop Lg1s to Lg1e. That is, in order to cause the distributed antenna device 30-2 including the second distributed antenna 31-2 to perform all-beam search, the candidate beam detection unit 15c outputs an all-beam search request signal including “distributed antenna ID #2,” which is the distributed antenna ID assigned to the second distributed antenna 31-2, to the beam search execution instruction unit 11. After outputting the all-beam search request signal to the beam search execution instruction unit 11, the candidate beam detection unit 15c starts an internal feedback signal timer. When starting the feedback signal timer, the candidate beam detection unit 15c sets the same time as that set in the feedback signal timer by the beam combination history generation unit 13a in the processing of step Sa1 in FIG. 9. When the beam search execution instruction unit 11 receives the all-beam search request signal output by the candidate beam detection unit 15c, processing after the beam search execution instruction unit 11 receives the all-beam search request signal in the processing of step Sa1 in FIG. 9 is performed by the beam search execution instruction unit 11, the digital signal processing device 20, the main device 32-2, the distributed antenna 31-2, and the terminal device 40 with i=2 (steps Sg1 when i=2).

The candidate beam detection unit 15c determines whether a feedback signal including “distributed antenna ID #2,” which is the distributed antenna ID of the second distributed antenna 31-2, as the source antenna ID has been received before the feedback signal timer expires (step Sg2 when i=2). Here, it is assumed that any of the above-described events in cases where the beam combination history generation unit 13a cannot receive the feedback signal has not occurred, and the feedback signal receiving unit 12 outputs the feedback signal to the candidate beam detection unit 15c. In this case, the candidate beam detection unit 15c determines that the feedback signal including “distributed antenna ID #2,” which is the distributed antenna ID of the second distributed antenna 31-2, as the source antenna ID has been received before the feedback signal timer expires (Yes in step Sg2 when i=2).

The candidate beam detection unit 15c exits the processing of loop Lg1s to Lg1e and sets the beam ID included in the received feedback signal as the beam ID indicating the best beam for the second distributed antenna device 30-2. The candidate beam detection unit 15c sets the beam identified by the beam ID and “distributed antenna ID #2,” which is the source antenna ID included in the feedback signal, as a detection reference beam. Here, it is assumed that the beam ID included in the feedback signal received by the candidate beam detection unit 15c is “beam ID #33.”

The candidate beam detection unit 15c combines the source antenna ID, beam ID, and reception power value included in the feedback signal into one set of data, and outputs the one set of data to the beam combination recording unit 17a. The beam combination recording unit 17a receives the one set of data output by the candidate beam detection unit 15c. The candidate beam detection unit 15c outputs an output destination switching instruction signal for setting an output destination to the beam search execution determination unit 16a to the feedback signal receiving unit 12. Upon receiving the output destination switching instruction signal for setting the output destination to the beam search execution determination unit 16a from the candidate beam detection unit 15c, the feedback signal receiving unit 12 sets the output destination of the feedback signal to the beam search execution determination unit 16a (step Sg3).

In other words, regarding the processing in steps Sg2 and Sg3 above, the candidate beam detection unit 15c performs processing of causing all the distributed antenna devices 30-1 to 30-4 to perform all-beam search in a random order, and when one feedback signal is received during the processing, the candidate beam detection unit 15c ends the processing of loop Lg1s to Lg1e and sets the beam identified by the source antenna ID and beam ID included in the received feedback signal as a detection reference beam.

At this time, there are only two distributed antenna devices 30-1 and 30-3 that have not performed the all-beam search in the beam search period. If the wireless communication system 1c includes N distributed antenna devices 30-1 to 30-N, at the time of exiting loop Lg1s to Lg1e, a distributed antenna device 30-k that has not performed all-beam search is identified using values of the variable i that have been selected up to that time and the value of N. Here, the variable k have values of “1” and “3.” The candidate beam detection unit 15c writes and records possible values of the variable k and values that have already been selected in an internal storage area.

The candidate beam detection unit 15c performs the following processing when k=1. That is, the candidate beam detection unit 15c detects, from the beam combination history table 140a, the beam ID of the beam of the first distributed antenna device 30-1, which has been selected together with the detection reference beam. Here, the detection reference beam is a beam identified by “beam ID #33” of “distributed antenna ID #2”. In the beam combination history table 140a, “beam ID #33” of “distributed antenna ID #2” corresponding to the detection reference beam is included in “record ID #2”, “record ID #4”, and “record ID #6”. “Beam ID #13” and “beam ID #25” are written in the “distributed antenna ID #1” of “Record ID #2,” “record ID #4,” and “record ID #6.”

Therefore, the candidate beam detection unit 15c detects “beam ID #13” and “beam ID #25” as the beam ID of the beam of the first distributed antenna device 30-1, which has been selected together with the detection reference beam, from the beam combination history table 140a. The candidate beam detection unit 15c sets “beam ID #13” and “beam ID #25” as candidate beam IDs indicating candidate beams of the distributed antenna device 30-1 corresponding to “distributed antenna ID #1.”

The candidate beam detection unit 15c further detects “(reception power value 2-1)” of “record ID #2”, and “(reception power value 6-1)” of “record ID #6” with respect to “beam ID #25” and detects “(reception power value 4-1)” of “record ID #4” with respect to “beam ID #13.” The candidate beam detection unit 15c calculates the average value of “(reception power value 2-1)” and “(reception power value 6-1)” corresponding to “beam ID #25.” Since there is only “(reception power value 4-1)” for “beam ID #13,” “(reception power value 4-1)” is used as the average value. The candidate beam detection unit 15c sets the maximum average value of the average value corresponding to “beam ID #13” and the average value of “beam ID #25” as the average reception power value for “distributed antenna ID #1”. The candidate beam detection unit 15c generates data indicating detection results including “distributed antenna ID #1,” “beam ID #13,” which is a candidate beam ID, “beam ID #25,” and the calculated average reception power value (step Sg4 when k=4). The candidate beam detection unit 15c outputs the generated data indicating the detection results to the beam search execution determination unit 16a (step Sg5 when k=1).

In the processing of step Se1 of the subroutine for all-beam search execution determination processing in FIG. 16, which is performed in the subsequent processing of step Sg6, the beam search execution determination unit 16a receives the detection result data output by the candidate beam detection unit 15c. In the processing of step Se2, the beam search execution determination unit 16a determines that the candidate beam ID is included in the received data indicating the detection results (step Se2 when k=1, Yes).

If the beam search execution determination unit 16a determines “Yes” in the determination processing of step Se8, the beam search execution determination unit 16a reads the average reception power value included in the data indicating the detection results, adds a margin to the read average reception power value, and calculates a threshold for “distributed antenna ID #1” (step Se9). The beam search execution determination unit 16a determines whether the reception power value included in the feedback signal exceeds the threshold calculated for the source antenna ID (here, “distributed antenna ID #1”) included in the feedback signal (step Se10 when k=1).

If the beam search execution determination unit 16a determines that the reception power value included in the feedback signal exceeds the threshold calculated for the source antenna ID included in the feedback signal (Yes in step Se10), then the processing proceeds to step Se5. On the other hand, if the beam search execution determination unit 16a determines that the reception power value included in the feedback signal does not exceed the threshold calculated for the source antenna ID included in the feedback signal (No in step Se10), then the processing proceeds to step Se3.

If there is a value that has never been selected among possible values (here, “1” and “3”) of the variable k at that time, the candidate beam detection unit 15c selects the value that has never been selected, and the processing of steps Sg4 to Sg6 is performed again (loop Lg2s to Lg2e). Here, since “3” is not selected yet among the possible values (here, “1” and “3”) of the variable k, the candidate beam detection unit 15c sets “3” as a new value of k.

The candidate beam detection unit 15c performs the following processing when k=3 (with respect to the case of “3” which is another possible value of the variable k). In the processing of loop Lg2s to Lg2e, when k=3, the candidate beam detection unit 15c cannot detect the candidate beam ID corresponding to “distributed antenna ID #3” from the beam combination history table 140a as in the first embodiment and the third embodiment. Therefore, in this case, the candidate beam detection unit 15c cannot detect the reception power value. Accordingly, the candidate beam detection unit 15c does not calculate the average reception power value and outputs detection results that there is no candidate beam ID indicating a candidate beam which is the beam of the third distributed antenna device 30-3 and has been selected together with the detection reference beam, similarly to the processing of step Sb4 of the first embodiment and the processing of step Sd4 of the third embodiment. The candidate beam detection unit 15c generates data indicating the detection results including only “distributed antenna ID #3” (step Sg4 when k=3).

The candidate beam detection unit 15c outputs data indicating the detection results including only “distributed antenna ID #3” to the beam search execution determination unit 16a (step Sg5 when k=3). When the beam search execution determination unit 16a receives data indicating the detection results from the candidate beam detection unit 15c, the beam search execution determination unit 16a starts a subroutine for all-beam search execution determination processing shown in FIG. 16 (step Sg6 when k=3).

A subroutine of the all-beam search execution determination processing performed in step Sg6 of the beam search processing of the fourth embodiment will be described with reference to FIG. 16. In processing of steps Se1 to Se6, the same processing as steps Sc1 to Sc6 shown in FIG. 11 is performed by the beam search execution instruction unit 11, the feedback signal receiving unit 12, the digital signal processing device 20, and the distributed antenna devices 30-1 to 30-4, and processing performed by the beam search execution determination unit 16 is performed by the beam search execution determination unit 16a. Therefore, in the case of k=3, the beam search execution determination unit 16a determines “No” in the determination processing of step Se2, and the processing proceeds to step Se3, and thus the same processing as in the case of k=3 in the first embodiment and in the case of k=3 in the third embodiment is performed thereafter.

As a result, in the fourth embodiment, in a case where the beam search execution determination unit 16a determines that any of the distributed antenna devices 30-1 to 30-4 is caused to perform partial beam search, if the reception power value included in the feedback signal acquired through the partial beam search is approximately equal to the past average reception power value of the distributed antenna devices 30-1 to 30-4 for partial beam search, the beam indicated by the beam ID included in the feedback signal can be searched for as the best beam of the distributed antenna devices 30-1 to 30-4 corresponding to the source antenna ID included in the feedback signal. The beam search execution determination unit 16a can add data related to the beam to the beam combination history table 140a.

On the other hand, if the reception power value included in the feedback signal acquired through the partial beam search is not approximately equal to the past average reception power value of the distributed antenna devices 30-1 to 30-4 for the partial beam search, the beam search execution determination unit 16a causes the distributed antenna devices 30-1 to 30-4 corresponding to the source antenna ID included in the feedback signal to perform all-beam search. If the beam search execution determination unit 16a can acquire a feedback signal through the all-beam search, it is possible to search for the best beam in the distributed antenna devices 30-1 to 30-4 for all-beam search, and if it is not possible to acquire the feedback signal, it is impossible to search for the best beam for the distributed antenna devices 30-1 to 30-4 for all-beam search. Therefore, in the fourth embodiment, in addition to the effects achieved by the communication control device 10 of the first embodiment and the communication control device 10b of the third embodiment, it is possible to search for the best beam more accurately than in the first embodiment and the third embodiment at the time of performing partial beam search.

In the third embodiment described above, it is possible to lower the possibility that a beam which is not best in terms of communication quality is selected by setting a predetermined threshold of a reception power value higher. However, in this case, since all-beam search is performed for more distributed antenna devices in the third embodiment, it is difficult to reduce the number of beam searches. Further, since the optimum threshold changes depending on the position of a terminal device or the like, it is difficult to set a threshold for selecting the best beam as a uniform value while reducing the number of beam searches. On the other hand, in the fourth embodiment, the threshold is substantially changed for each position of the terminal device 40 by changing the threshold for each combination of beams, and thus the threshold is adaptively set.

Although the method in which the average value of reception power values for each detected beam ID is used as a reference has been described in the fourth embodiment, the reference is not limited to the average value. For example, the value used as the reference may be a median value, a mode value, a maximum value, or a minimum value. Further, when a maximum value, a minimum value or an average value is used as the reference among these values, other records may be deleted by calculating the value every time by a combination of the same beam IDs.

In addition, the wireless communication system 1c in the fourth embodiment does not perform all-beam search in a fixed order for the distributed antenna devices 30-1 to 30-4 but performs all-beam search in a random order for the distributed antenna devices 30-1 to 30-4 at the first stage of beam search processing. With such a configuration, the wireless communication system 1c performs all-beam search at random timing even for a distributed antenna device in which all-beam search has not been performed by selecting a beam which is not the best beam but whose reception power value exceeds a threshold by partial beam search. Accordingly, the beam combination history table 140a is also updated. Therefore, according to the wireless communication system 1c in the fourth embodiment, it is possible to prevent a combination of beams which are not best from being continuously selected fixedly while reducing the number of beam searches.

As described above, the wireless communication system 1b in the third embodiment and the wireless communication system 1c in the fourth embodiment are configured to perform all-beam search in a random order for the distributed antenna devices 30-1 to 30-4 one by one at the first stage of beam search processing. By randomly selecting the distributed antenna devices 30-1 to 30-4 for performing all-beam search, a combination of beams which are not best can be prevented from being continuously selected fixedly.

On the other hand, instead of performing all-beam search in order one by one in a random order for the distributed antenna devices 30-1 to 30-4, all-beam searches may be performed simultaneously using a plurality of distributed antenna devices randomly selected from among the distributed antenna devices 30-1 to 30-4. Also in this case, since a combination of the distributed antenna devices 30-1 to 30-4 for performing all-beam search is selected randomly, it is possible to prevent a combination of beams which are not best from being continuously selected fixedly.

As a method of simultaneously performing all-beam searches using distributed antenna devices, for example, a technique such as frequency multiplexing or code multiplexing may be used. In addition, in a case where interference between distributed antenna devices is small, and the like, all-beam search using the same resource may be performed in a plurality of distributed antenna devices.

A wireless communication system 1d in a fifth embodiment and a wireless communication system 1e in a sixth embodiment which will be described below perform all-beam searches simultaneously using a plurality of distributed antenna devices randomly selected from among the distributed antenna devices 30-1 to 30-4 at the first stage of beam search processing. With such a configuration, in the fifth and sixth embodiments which will be described below, all-beam search is performed at random timing even for a distributed antenna device in which all-beam search has not been performed by selecting a beam which is not the best beam but whose reception power value exceeds a threshold through partial beam search. Thus, the beam combination history table 140 and the beam combination history table 140a are also updated. Therefore, according to the fifth and sixth embodiments which will be described below, it is possible to prevent a combination of beams which are not best from being continuously selected fixedly while reducing the number of beam searches.

### Fifth Embodiment

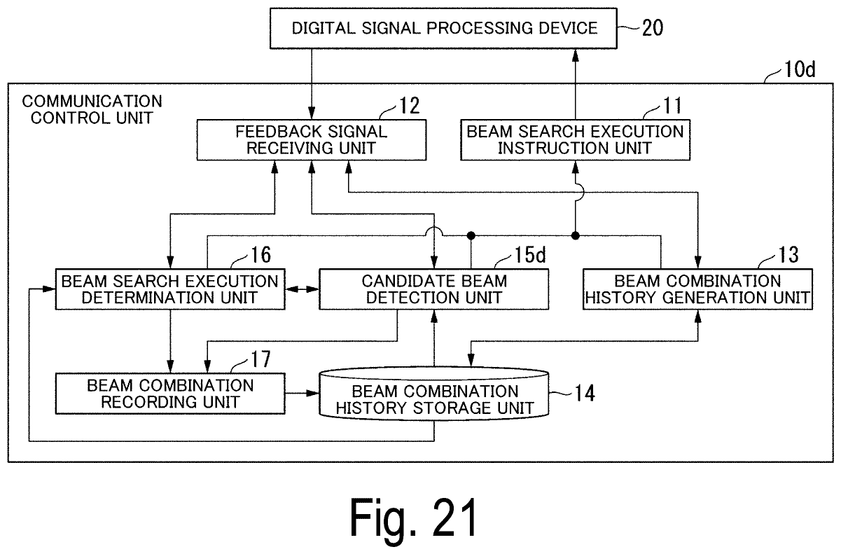

FIG. 21 is a block diagram showing a configuration of a communication control device 10d in the fifth embodiment. The communication control device 10d is a device used in place of the communication control device 10 of the first embodiment. Hereinafter, for convenience of explanation, the wireless communication system 1 including the communication control device 10d instead of the communication control device 10 will be referred to as a wireless communication system 1d. In the communication control device 10d, the same components as the communication control device 10 of the first embodiment are given the same reference numerals, and different components will be explained below.

The configurations of the wireless communication system 1d in the fifth embodiment differs from the configuration of the wireless communication system 1 in the first embodiment in that all-beam search is not performed for a plurality of distributed antenna devices in a fixed order one by one, but all-beam searches are performed simultaneously by some of the plurality of distributed antenna devices selected randomly.

The communication control device 10d includes a beam search execution instruction unit 11, a feedback signal receiving unit 12, a beam combination history generation unit 13, a beam combination history storage unit 14, a candidate beam detection unit 15d, a beam search execution determination unit 16, and a beam combination recording unit 17.

When beam search processing for searching a beam is started, the candidate beam detection unit 15d randomly selects a plurality of (X) distributed antenna devices from among N distributed antenna devices 30-1 to 30-N. For example, the candidate beam detection unit 15d randomly selects two (X=2) distributed antenna devices from among four (N=4) distributed antenna devices 30-1 to 30-4. Each time beam search processing is performed, the same number of distributed antenna devices (for example, two devices (X=2)) may be selected randomly, or different numbers of distributed antenna devices (for example, two and three devices (X=2 and 3)) may be selected randomly.

The candidate beam detection unit 15d causes the selected plurality of distributed antenna devices to perform all-beam searches simultaneously. That is, the candidate beam detection unit 15d designates distributed antenna IDs of the randomly selected two distributed antennas, for example, the distributed antennas 31-1 and 31-4, and outputs an all-beam search request signal including the designated two distributed antenna IDs to the beam search execution instruction unit 11. Upon receiving the first feedback signal after beam search processing is started, the candidate beam detection unit 15d stops all-beam search and sets a beam identified by a source antenna ID and a beam ID included in the feedback signal as a detection reference beam.

The candidate beam detection unit 15d detects, from the beam combination history table 140, the beam IDs of distributed antenna devices that have not performed all-beam search during a beam search period among the distributed antenna devices 30-1 to 30-4, the beam IDs corresponding to beams that have been selected together with the detection reference beam, and the distributed antenna IDs corresponding to the beam IDs. The candidate beam detection unit 15d sets the detected beam IDs as candidate beam IDs indicating candidate beams in the distributed antenna devices 30-1 to 30-4 corresponding to the detected distributed antenna IDs and outputs a combination of the detected distributed antenna IDs and candidate beam IDs as detection results.

### (Processing Performed by Wireless Communication System of Fifth Embodiment)

Similarly to the first embodiment, in the wireless communication system 1d of the fifth embodiment, the beam combination generation processing in step S1 and the beam search processing in step S2, shown in FIG. 8, are also performed. However, the beam search processing performed in the fifth embodiment differ from the processing performed in the first embodiment with respect to the points described below.

### (Beam Combination Generation Processing of Fifth Embodiment)

Beam combination generation processing shown in FIG. 9, which is the same processing as in the first embodiment, is performed by the beam search execution instruction unit 11, the feedback signal receiving unit 12, the beam combination history generation unit 13, the digital signal processing device 20, and the distributed antenna devices 30-1 to 30-4.

### (Beam Search Processing of Fifth Embodiment)

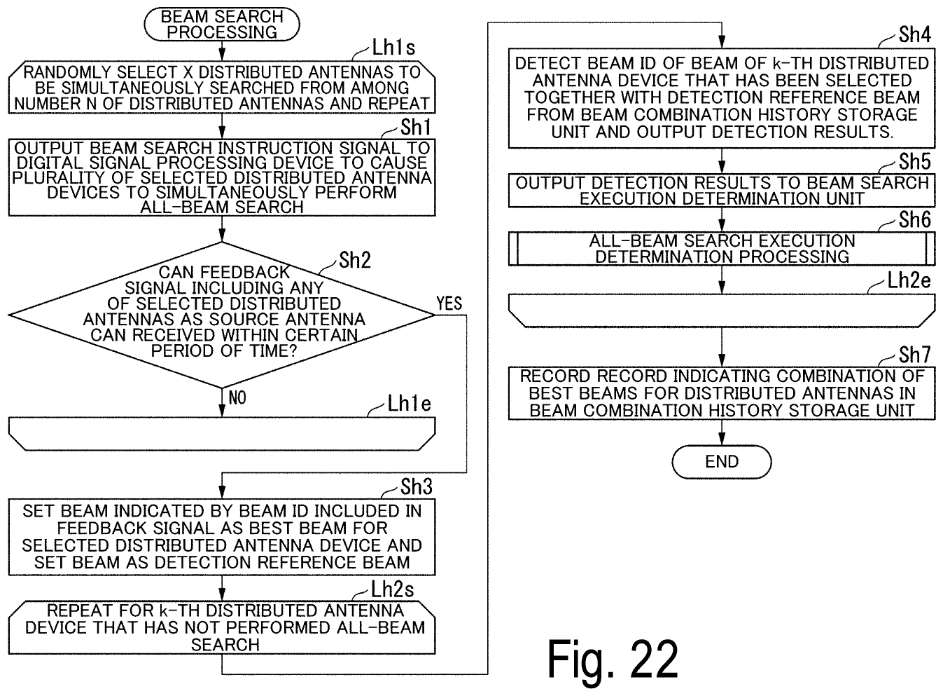

FIG. 22 is a flowchart showing a flow of beam search processing of the fifth embodiment. FIG. 22 is a flowchart showing the flow of the beam search processing performed in the processing of step S2 in FIG. 8. As a premise for starting the beam search processing shown in FIG. 8, it is assumed that the beam combination history table 140 shown in FIG. 4 has been generated in the beam combination history storage unit 14.

In FIG. 22, in processing of steps Sh1 and Sh2 and processing of loop Lh1s to Lh1e for repeating the processing of steps Sh1 and Sh2, the aforementioned processing is performed by the candidate beam detection unit 15d. In processing of step Sh3, processing of steps Sh4 to Sh6, processing of loop Lh2s to Lh2e for repeating the processing of steps Sh4 to Sh6, and processing of step Sh7, the same processing as the processing of step Sb3, the processing of Sb4 to Sb6, the processing of loop Lb2s to Lb2e for repeating the processing of steps Sb4 and Sb6, and the processing of step Sb7 in FIG. 10 is performed by the beam search execution instruction unit 11, the feedback signal receiving unit 12, the beam combination recording unit 17, the digital signal processing device 20, and the distributed antenna devices 30-1 to 30-4, and processing performed by the candidate beam detection unit 15 is performed by the candidate beam detection unit 15d.

In response to an operation of the operator of the wireless communication system 1d, the candidate beam detection unit 15d of the communication control device 10d starts beam search processing. The candidate beam detection unit 15d starts an internal beam search cycle timer. When starting the beam search cycle timer, the candidate beam detection unit 15d sets a time indicating the duration of one predetermined beam search cycle.

The candidate beam detection unit 15d reads all distributed antenna IDs written in the distributed antenna ID item of the beam combination history table 140 stored in the beam combination history storage unit 14. The candidate beam detection unit 15d provides a variable i in an internal storage area thereof. Here, although i is a variable that is an integer value from 1 to N, the wireless communication system 1 in FIG. 1 includes four distributed antenna devices 30-1 to 30-4, and the candidate beam detection unit 15d reads four distributed antenna IDs, “distributed antenna ID #1,” “distributed antenna ID #2,” “distributed antenna ID #3,” and “distributed antenna ID #4” from the beam combination history table 140, and thus it is assumed that N=4 in the following description. The following description will be made assuming that the i-th distributed antenna device is a distributed antenna device 30-i, the i-th distributed antenna is a distributed antenna 31-i, and the i-th main device is a main device 32-i.

Further, the candidate beam detection unit 15d provides a variable X in an internal storage area. Here, X is a variable that is an integer equal to or greater than 2. X represents the number of distributed antenna devices in which all beam searches are simultaneously performed. As an example, X=2 in the following description.

The candidate beam detection unit 15d outputs an output destination switching instruction signal for setting an output destination to the candidate beam detection unit 15d to the feedback signal receiving unit 12. Upon receiving the output destination switching instruction signal for setting the output destination to the candidate beam detection unit 15d from the candidate beam detection unit 15d, the feedback signal receiving unit 12 sets the candidate beam detection unit 15d as the output destination of the feedback signal.

The candidate beam detection unit 15d randomly selects two (X=2) values from among 1 to N as values of the variable i. The candidate beam detection unit 15d writes and records possible values (i.e., 1 to N) of the variable i and values which have already been selected in the internal storage area. Here, it is assumed that “1” and “3” are selected as values of the variable i. When i=1 and 3, the following processing is performed. That is, in order to cause the distributed antenna device 30-1 including the first distributed antenna 31-1 and the distributed antenna device 30-3 including the third distributed antenna 31-3 to perform all-beam searches simultaneously, the candidate beam detection unit 15d outputs an all-beam search request signal including “distributed antenna ID #1” which is the distributed antenna ID assigned to the first distributed antenna 31-1 and “distributed antenna ID #3” which is the distributed antenna ID assigned to the third distributed antenna 31-3 to the beam search execution instruction unit 11.

After outputting the all-beam search request signal to the beam search execution instruction unit 11, the candidate beam detection unit 15d starts an internal feedback signal timer. When starting the feedback signal timer, the candidate beam detection unit 15d sets the same time as that set in the feedback signal timer by the beam combination history generation unit 13 in the processing of step Sa1 in FIG. 9. Note that the time is a predetermined time and is set in the candidate beam detection unit 15d in advance. When the beam search execution instruction unit 11 receives the all-beam search request signal output by the candidate beam detection unit 15d, processing after the beam search execution instruction unit 11 receives the all-beam search request signal in the processing of step Sa1 of FIG. 9 is performed by the beam search execution instruction unit 11, the digital signal processing device 20, the main device 32-1, the main device 32-3, the distributed antenna 31-1, the distributed antenna 31-3, and the terminal device 40 with i=1 and 3 (step Sh1 when i=1 and 3).

The candidate beam detection unit 15d determines whether a feedback signal including any of “distributed antenna ID #1” which is the distributed antenna ID of the distributed antenna 31-1 or “distributed antenna ID #3” which is the distributed antenna ID of the distributed antenna 31-3 as a source antenna ID has been received before the feedback signal timer expires (step Sh2 when i=1 and 3).

Here, it is assumed that any of the above-mentioned events in cases where the beam combination history generation unit 13 cannot receive the feedback signal has occurred. In this case, the candidate beam detection unit 15d determines that the feedback signal including “distributed antenna ID #1” which is the distributed antenna ID of the first distributed antenna 31-1 and “distributed antenna ID #3” which is the distributed antenna ID of the third distributed antenna 31-3 as source antenna IDs has not been received before the feedback signal timer expires (No in step Sh2). The candidate beam detection unit 15d randomly selects two (X=2) values from 1 to N as values of the variable i unless as many values of the variable i as the number N of distributed antennas have been selected at that time (that is, unless all possible values of the variable i have been selected). Here, the remaining “2” and “4” are selected as values of the variable i. Then, the processing of steps Sh1 and Sh2 is performed again (loop Lh1s to Lh1e).

The candidate beam detection unit 15d performs the following processing as the second processing of loop Lh1s to Lh1e. That is, in order to cause the distributed antenna device 30-2 including the second distributed antenna 31-2 and the distributed antenna device 30-4 including the fourth distributed antenna 31-4 to perform all-beam searches simultaneously, the candidate beam detection unit 15d outputs an all-beam search request signal including “distributed antenna ID #2,” which is the distributed antenna ID assigned to the second distributed antenna 31-2, and “distributed antenna ID #4,” which is the distributed antenna ID assigned to the fourth distributed antenna 31-4 to the beam search execution instruction unit 11.

After outputting the all-beam search request signal to the beam search execution instruction unit 11, the candidate beam detection unit 15d starts an internal feedback signal timer. When starting the feedback signal timer, the candidate beam detection unit 15d sets the same time as that set in the feedback signal timer by the beam combination history generation unit 13 in the processing of step Sa1 in FIG. 9. When the beam search execution instruction unit 11 receives the all-beam search request signal output by the candidate beam detection unit 15d, then processing after the beam search execution instruction unit 11 receives the all-beam search request signal in the processing of step Sa1 in FIG. 9 is performed by the beam search execution instruction unit 11, the digital signal processing device 20, the main device 32-2, and the main device 32-4, the distributed antenna 31-2, the distributed antenna 31-4, and the terminal device 40 with i=2 and 4 (steps Sh1 when i=2 and 4).

The candidate beam detection unit 15d determines whether a feedback signal including “distributed antenna ID #2,” which is the distributed antenna ID of the second distributed antenna 31-2, or “distributed antenna ID #4,” which is the distributed antenna ID of the fourth distributed antenna 31-4, as a source antenna ID has been received before the feedback signal timer expires (step Sh2 when i=2 and 4). Here, it is assumed that any of the above-described events in cases where the beam combination history generation unit 13 cannot receive the feedback signal has not occurred, and the feedback signal receiving unit 12 has output the feedback signal including “distributed antenna ID #2,” which is the distributed antenna ID of the second distributed antenna 31-2, as a source antenna ID to the candidate beam detection unit 15d. In this case, the candidate beam detection unit 15d determines that the feedback signal including “distributed antenna ID #2,” which is the distributed antenna ID of the second distributed antenna 31-2, as a source antenna ID has been received before the feedback signal timer expires (Yes in step Sh2 when i=2 and 4).

The candidate beam detection unit 15d exits the processing of loop Lh1s to Lh1e and sets the beam ID included in the received feedback signal as the beam ID indicating the best beam for the second distributed antenna device 30-2. The candidate beam detection unit 15d sets the beam identified by the beam ID and “distributed antenna ID #2,” which is the source antenna ID included in the feedback signal, as a detection reference beam. Here, it is assumed that the beam ID included in the feedback signal received by the candidate beam detection unit 15d is “beam ID #33.”

The candidate beam detection unit 15d combines the source antenna ID, beam ID, and reception power value included in the feedback signal into one set of data, and outputs the one set of data to the beam combination recording unit 17. The beam combination recording unit 17 receives the one set of data output by the candidate beam detection unit 15d. The candidate beam detection unit 15d outputs an output destination switching instruction signal for setting the output destination to the beam search execution determination unit 16 to the feedback signal receiving unit 12. Upon receiving the output destination switching instruction signal for setting the output destination to the beam search execution determination unit 16 from the candidate beam detection unit 15d, the feedback signal receiving unit 12 sets the output destination of the feedback signal to the beam search execution determination unit 16 (step Sh3).

In other words, regarding the processing of steps Sh2 and Sh3 above, the candidate beam detection unit 15d simultaneously performing all-beam searches using a plurality of distributed antenna devices randomly selected from among the distributed antenna devices 30-1 to 30-4. Upon receiving one feedback signal during that processing, the candidate beam detection unit 15d ends the processing of loop Lh1s to Lh1e and sets a beam identified by the source antenna ID and beam ID included in the received feedback signal as a detection reference beam.

If the wireless communication system 1d includes N distributed antenna devices 30-1 to 30-N, at the time of exiting loop Lh1s to Lh1e, a distributed antenna device 30-k that has not performed all-beam search is identified using values of the variable i that have been selected up to that time and the value of N. The candidate beam detection unit 15d writes and records possible values of the variable k and values that have already been selected in an internal storage area.

The candidate beam detection unit 15d performs the following processing when k=1. That is, the candidate beam detection unit 15d detects the beam ID of the beam of the first distributed antenna device 30-1, which has been selected together with the detection reference beam, from the beam combination history table 140. Here, the detection reference beam is a beam identified by “beam ID #33” of “distributed antenna ID #2”. In the beam combination history table 140, “beam ID #33” of “distributed antenna ID #1” corresponding to the detection reference beam is included in “record ID #2,” “record ID #4,” and “record ID #6.” “Beam ID #13” and “beam ID #25” are written in the “distributed antenna ID #1” of “Record ID #2,” “record ID #4,” and “record ID #6.”

Therefore, the candidate beam detection unit 15d detects “beam ID #13” and “beam ID #25” as the beam ID of the beam of the first distributed antenna device 30-1, which has been selected together with the detection reference beam, from the beam combination history table 140. The candidate beam detection unit 15d sets “beam ID #13” and “beam ID #25” as candidate beam IDs indicating candidate beams of the distributed antenna device 30-1 corresponding to “distributed antenna ID #1.” The candidate beam detection unit 15d generates data indicating detection results including “distributed antenna ID #1,” “beam ID #13” and “beam ID #25 that are candidate beam IDs (step Sh4 when k=1). The candidate beam detection unit 15d outputs the generated data indicating the detection results to the beam search execution determination unit 16 (step Sh5 when k=1). Upon receiving the data indicating the detection results from the candidate beam detection unit 15d, the beam search execution determination unit 16 starts a subroutine for all-beam search execution determination processing shown in FIG. 11 (step Sh6 when k=1).

The beam search execution determination unit 16 receives the data indicating the detection results output by the candidate beam detection unit 15d (step Sc1 when k=1). The beam search execution determination unit 16 determines whether the candidate beam ID is included in the received data indicating the detection results (step Sc2 when k=1). Here, since the data indicating the detection results includes “beam ID #13” and “beam ID #25,” the beam search execution determination unit 16 determines that candidate beam IDs are included in the received data indicating the detection results (Yes in step Sc2 when k=1).

The beam search execution determination unit 16 outputs a partial beam search request signal including “distributed antenna ID #1,” “beam ID #13,” and “beam ID #25” to the beam search execution instruction unit 11 in order to cause the distributed antenna device 30-1 including the first distributed antenna 31-1 to perform partial beam search. After outputting the partial beam search request signal to the beam search execution instruction unit 11, the beam search execution determination unit 16 starts an internal feedback signal timer. When starting the feedback signal timer, the beam search execution determination unit 16 sets the same time as that set in the feedback signal timer by the beam combination history generation unit 13 in the processing of step Sa1 in FIG. 9.

The beam search execution instruction unit 11 receives the partial beam search request signal output by the beam search execution determination unit 16, and reads “distributed antenna ID #1,” “beam ID #13,” and “beam ID #25” included in the partial beam search request signal. The beam search execution instruction unit 11 generates a beam search instruction signal including “distributed antenna ID #1” and “beam ID #13” and a beam search instruction signal including “distributed antenna ID #1” and “beam ID #25.” The beam search execution instruction unit 11 outputs the two generated beam search instruction signals one by one to the digital signal processing device 20 at predetermined fixed time intervals in the order of generation. The digital signal processing device 20 sequentially receives the two beam search instruction signals output by the beam search execution instruction unit 11. Thereafter, the processing after the digital signal processing device 20 receives the beam search instruction signal in the processing of step Sa1 in FIG. 9, is performed by the digital signal processing device 20, the main device 32-1, the distributed antenna 31-1, and the terminal device 40 with i=1 (step Sc7 when k=1).

The beam search execution determination unit 16 determines whether a feedback signal including “distributed antenna ID #1,” which is the distributed antenna ID of the first distributed antenna 31-1, as the source antenna ID has been received before the feedback signal timer expires (step Sc8).

For example, it is assumed that one of the above-mentioned events of the case where the beam combination history generation unit 13 could not receive the feedback signal has occurred. In this case, the beam search execution determination unit 16 determines that the feedback signal including “distributed antenna ID #1,” which is the distributed antenna ID of the first distributed antenna 31-1, as the source antenna ID has not been received before the feedback signal timer expires (No in step Sc8 when k=1), and processing proceeds to step Sc3.

On the other hand, it is assumed that any of the above-described events of the case where the beam combination history generation unit 13 could not receive the feedback signal has not occurred, and the feedback signal receiving unit 12 outputs the feedback signal to the beam search execution determination unit 16. In this case, the beam search execution determination unit 16 determines that the feedback signal including “distributed antenna ID #1,” which is the distributed antenna ID of the first distributed antenna 31-1, as the source antenna ID has been received before the feedback signal timer expires (Yes in step Sc8 when k=1).

In this case, the beam search execution determination unit 16 determines whether the reception power value included in the feedback signal exceeds a predetermined threshold (step Sc9 when k=1). When the beam search execution determination unit 16 determines that the reception power value included in the feedback signal does not exceed the predetermined threshold (No in step Sc9 when k=1), the processing proceeds to step Sc3. On the other hand, if the beam search execution determination unit 16 determines that the reception power value included in the feedback signal exceeds the predetermined threshold (step Sc9 when k=1, Yes), the processing proceeds to step Sc5.

In other words, regarding the processing of steps Sc7, Sc8, and Sc9, the beam search execution determination unit 16 causes the distributed antenna device 30-1 corresponding to “distributed antenna ID #1” to perform partial beam search for transmitting a beam corresponding to “beam ID #13” and a beam corresponding to “beam ID #25.” If no feedback signal is obtained by the partial beam search, the beam search execution determination unit 16 advances the processing to step Sc3 and causes the distributed antenna device 30-1 corresponding to “distributed antenna ID #1” to perform all-beam search to search for the best beam for the distributed antenna device 30-1 again. In the all-beam search in this case, the beam search execution determination unit 16 searches for only the beam corresponding to the “beam ID #13” and the beam other than the beam corresponding to the “beam ID #25”.

Then, when a feedback signal in which “distributed antenna ID #1” is included as a source antenna ID is captured before a feedback signal timer expires in step SC4, a beam search execution determination unit 16 advances processing to step SC5, the beam ID included in the feedback signal is defined as data to be added to the beam combination history table 140.

On the other hand, in a case where a feedback signal is obtained by the partial beam search, when the reception power value included in the feedback signal, that is, the reception power value of the beam selected as the best beam for the terminal device 40, does not exceed the threshold, the beam search execution determination unit 16 determines that the beam indicated by the feedback signal is an inappropriate beam that cannot be used for normal operation. Therefore, the beam search execution determination unit 16 advances the processing to step Sc3 and causes the distributed antenna device 30-1 corresponding to “distributed antenna ID #1” to perform all-beam search to search for the best beam for the distributed antenna device 30-1 again. In the all-beam search in this case, the beam search execution determination unit 16 searches for only the beam corresponding to the “beam ID #13” and the beam other than the beam corresponding to the “beam ID #25”.

Then, when a feedback signal in which “distributed antenna ID #1” is included as a source antenna ID is captured before a feedback signal timer expires in step SC4, a beam search execution determination unit 16 advances processing to step SC5, the beam ID included in the feedback signal is defined as data to be added to the beam combination history table 140.

On the other hand, when the reception power value included in the feedback signal exceeds the threshold, the beam search execution determination unit 16 advances the processing to step Sc5 to determine that the beam is the best beam for the distributed antenna device 30-1. In this case, since the beam search execution determination unit 16 can determine that the beam is an appropriate beam that can be used for normal operation without performing an all-beam search for the distributed antenna device 30-1, the number of beam searches can be reduced.

If there is a value that has never been selected among possible values (here, “1,” “3,” and “4”) of the variable k at that time, the candidate beam detection unit 15d selects the value that has never been selected, and processing of steps Sh4 to Sh6 is performed again (loop Lh2s to Lh2e). Here, since “3” (and “4”) among the possible values (here, “1,” “3,” and “4”) of the variable k has not been selected yet, the candidate beam detection unit 15d sets “3” as a new value of k.

The candidate beam detection unit 15d performs the following processing when k=3. That is, the candidate beam detection unit 15d detects the beam of the third distributed antenna device 30-3, which has been selected together with the detection reference beam, as a candidate beam from the beam combination history table 140. Here, the detection reference beam is a beam identified by “beam ID #33” of “distributed antenna ID #2”. In the beam combination history table 140, “beam ID #33” of “distributed antenna ID #2” corresponding to the detection reference beam is included in “record ID #2”, “record ID #4”, and “record ID #6”. However, the “distributed antenna ID #3” items of “record ID #2”, “record ID #4”, and “record ID #6” are blank. Therefore, the candidate beam detection unit 15d outputs detection results that there is no candidate beam ID indicating a candidate beam that is a beam of the third distributed antenna device 30-3 and has been selected together with the detection reference beam. The candidate beam detection unit 15d generates data indicating the detection results including only “distributed antenna ID #3” (step Sh4 when k=3).

The candidate beam detection unit 15d outputs data indicating the detection results including only “distributed antenna ID #3” to the beam search execution determination unit 16 (step Sh5 when k=3). Upon receiving the data indicating the detection results from the candidate beam detection unit 15d, the beam search execution determination unit 16 starts a subroutine for all-beam search execution determination processing shown in FIG. 11 (step Sh6 when k=3).

When the candidate beam detection unit 15d receives the termination notification signal output from the beam search execution determination unit 16, if there is a value that has never been selected among the possible values (here, “1,” “3,” and “4”) of the variable k at that time, the candidate beam detection unit 15d selects the value that has never been selected, and processing of steps Sh4 to Sh6 is performed again (loop Lh2s to Lh2e).

When the candidate beam detection unit 15d receives the termination notification signal output from the beam search execution determination unit 16, if there is no value that has never been selected among the possible values (here, “1,” “3,” and “4”) of the variable k at that time, the candidate beam detection unit 15d ends processing of loop Lh2s to Lh2e and advances the processing to step Sh7.

Here, since “4” among the possible values (here, “1,” “3,” and “4”) has not been selected yet, the candidate beam detection unit 15d sets “4” as a new value of k. The candidate beam detection unit 15d performs the following processing when k=4. That is, the candidate beam detection unit 15d detects the beam ID of the beam of the fourth distributed antenna device 30-4, which has been selected together with the detection reference beam, from the beam combination history table 140. Here, the detection reference beam is a beam identified by “beam ID #33” of “distributed antenna ID #2”. In the beam combination history table 140, “beam ID #33” of “distributed antenna ID #2” corresponding to the detection reference beam is included in “record ID #2,” “record ID #4,” and “record ID #6.” “Beam ID #15,” “beam ID #16,” and “beam ID #15” are written in the “distributed antenna ID #4” item of “record ID #2,” “record ID #4,” and “record ID #6.”

Therefore, the candidate beam detection unit 15d detects “beam ID #15” and “beam ID #16” as beam IDs of beams of the fourth distributed antenna device 30-4, which have been selected together with the detection reference beam, from the beam combination history table 140. The candidate beam detection unit 15d sets “beam ID #15” and “beam ID #16” as candidate beam IDs indicating candidate beams of the distributed antenna device 30-4 corresponding to “distributed antenna ID #4.” The candidate beam detection unit 15d generates data indicating detection results including “distributed antenna ID #4”, and “beam ID #15” and “beam ID #16” which are candidate beam IDs (step Sh4 when k=4). The candidate beam detection unit 15d outputs the generated data indicating the detection results to the beam search execution determination unit 16 (step Sh5 when k=4). Upon receiving the data indicating the detection results from the candidate beam detection unit 15d, the beam search execution determination unit 16 starts a subroutine for all-beam search execution determination processing shown in FIG. 11 (step Sh6 when k=4).

The beam search execution determination unit 16 receives the data indicating the detection results output by the candidate beam detection unit 15d (step Sc1 when k=4). The beam search execution determination unit 16 determines whether the candidate beam ID is included in the received data indicating the detection results (step Sc2 when k=4). Here, since the data indicating the detection results includes “beam ID #15” and “beam ID #16,” the beam search execution determination unit 16 determines that a candidate beam ID is included in the data indicating the received detection results (Yes in step Sc2 when k=4).

The beam search execution determination unit 16 outputs a partial beam search request signal including “distributed antenna ID #4”, “beam ID #15”, and “beam ID #16” to the beam search execution instruction unit 11 in order to cause the distributed antenna device 30-4 including the fourth distributed antenna 31-4 to perform partial beam search. After outputting the partial beam search request signal to the beam search execution instruction unit 11, the beam search execution determination unit 16 starts an internal feedback signal timer. When starting the feedback signal timer, the beam search execution determination unit 16 sets the same time as that set in the feedback signal timer by the beam combination history generation unit 13 in the processing of step Sa1 in FIG. 9.

The beam search execution instruction unit 11 receives the partial beam search request signal output by the beam search execution determination unit 16, and reads “distributed antenna ID #4”, “beam ID #15”, and “beam ID #16” included in the partial beam search request signal. The beam search execution instruction unit 11 generates a beam search instruction signal including “distributed antenna ID #4” and “beam ID #15,” and a beam search instruction signal including “distributed antenna ID #4” and “beam ID #16.” The beam search execution instruction unit 11 outputs the two generated beam search instruction signals one by one to the digital signal processing device 20 at predetermined fixed time intervals in the order of generation. The digital signal processing device 20 sequentially receives the two beam search instruction signals output by the beam search execution instruction unit 11. Thereafter, the processing after the digital signal processing device 20 receives the beam search instruction signal in the processing of step Sa1 in FIG. 9, is performed by the digital signal processing device 20, the main device 32-4, the distributed antenna 31-4, and the terminal device 40 with i=4 (step Sc7 when k=4).

The beam search execution determination unit 16 determines whether a feedback signal including “distributed antenna ID #4,” which is the distributed antenna ID of the fourth distributed antenna 31-4, as a source antenna ID has been received before the feedback signal timer expires (step Sc8).

For example, it is assumed that any of the above-mentioned events in cases where the beam combination history generation unit 13 cannot receive the feedback signal has occurred. In this case, the beam search execution determination unit 16 determines that the feedback signal including “distributed antenna ID #4,” which is the distributed antenna ID of the fourth distributed antenna 31-4, as the source antenna ID has not been received before the feedback signal timer expires (No in step Sc8 when k=4), and the processing proceeds to step Sc3.

On the other hand, it is assumed that any of the above-described events in cases where the beam combination history generation unit 13 cannot receive the feedback signal has not occurred, and the feedback signal receiving unit 12 outputs the feedback signal to the beam search execution determination unit 16. In this case, the beam search execution determination unit 16 determines that the feedback signal including “distributed antenna ID #4,” which is the distributed antenna ID of the fourth distributed antenna 31-4, as the source antenna ID has been received before the feedback signal timer expires (Yes in step Sc8 when k=4).

In this case, the beam search execution determination unit 16 determines whether the reception power value included in the feedback signal exceeds a predetermined threshold (step Sc9 when k=4). When the beam search execution determination unit 16 determines that the reception power value included in the feedback signal does not exceed the predetermined threshold (No in step Sc9 when k=4), the processing proceeds to step Sc3. On the other hand, if the beam search execution determination unit 16 determines that the reception power value included in the feedback signal exceeds the predetermined threshold (Yes in step Sc9 when k=4), the processing proceeds to step Sc5.

To put it another way about the processing of steps Sc7, Sc8, and Sc9, the beam search execution determination unit 16 performs a partial beam search to cause the distributed antenna device 30-4 corresponding to “distributed antenna ID #4” to transmit a beam corresponding to “beam ID #15” and a beam corresponding to “beam ID #16”. If no feedback signal is obtained according to the partial beam search, the beam search execution determination unit 16 advances processing to step Sc3 and causes the distributed antenna device 30-4 corresponding to “distributed antenna ID #4” to perform all-beam search to search for the best beam for the distributed antenna device 30-4 again. Further, in all-beam search in this case, the beam search execution determination unit 16 searches for only beams other than the beam corresponding to the “beam ID #15” and the beam corresponding to the “beam ID #16.”

Then, in a case where a feedback signal in which “distributed antenna ID #4” is included as a source antenna ID is received before a feedback signal timer expires in step Sc4, the beam search execution determination unit 16 advances the processing to step Sc5 to set the beam ID included in the feedback signal as a target data to be added to the beam combination history table 140.

On the other hand, in a case where a feedback signal is obtained by the partial beam search, when the reception power value included in the feedback signal, that is, the reception power value of the beam selected as the best beam for the terminal device 40, does not exceed the threshold, the beam search execution determination unit 16 determines that the beam indicated by the feedback signal is an inappropriate beam that cannot be used for normal operation. Therefore, the beam search execution determination unit 16 advances the processing to step Sc3 and causes the distributed antenna device 30-4 corresponding to “distributed antenna ID #4” to perform an all-beam search to search for the best beam for the distributed antenna device 30-4 again. In the all-beam search in this case, the beam search execution determination unit 16 searches for only beams other than the beam corresponding to the “beam ID #15” and the beam corresponding to “beam ID #26.”

Then, in a case where a feedback signal in which “distributed antenna ID #4” is included as a source antenna ID is received before a feedback signal timer expires in step Sc4, the beam search execution determination unit 16 advances the processing to step Sc5 to set the beam ID included in the feedback signal as a target data to be added to the beam combination history table 140.

On the other hand, when the reception power value included in the feedback signal exceeds the threshold, the beam search execution determination unit 16 advances the processing to step Sc5 to determine that the beam is the best beam for the distributed antenna device 30-4. In this case, since the beam search execution determination unit 16 can determine that the beam is an appropriate beam that can be used for normal operation without performing an all-beam search for the distributed antenna device 30-4, the number of beam searches can be reduced.

Referring back to FIG. 22, when the candidate beam detection unit 15d receives the termination notification signal output from the beam search execution determination unit 16, if there is a value that has never been selected among the possible values (here, “1,” “3,” and “4”) of the variable k at that time, the candidate beam detection unit 15d selects the value that has never been selected, and the processing of steps Sh4 to Sh6 is performed again (loop Lh2s to Lh2e). Here, since there are no other value which have never been selected among the possible values of the variable k at that time, the processing of loop Lh2s to Lh2e ends and the processing proceeds to processing of the step Sh7.

The beam combination recording unit 17 removes the reception power value from the one set of data received in the processing of step Sh3 and the processing of step Sc5, that is, the data that is a combination of the source antenna ID, beam ID, and reception power value, and generates one record in the beam combination history table 140 on the basis of the remaining data. That is, the beam combination recording unit 17 generates a new row in the beam combination history table 140, thereby generating “record ID #M+1” as a new record ID. The beam combination recording unit 17 writes “record ID #M+1” which is the generated new record ID in the “record ID” item of the generated new row. The beam combination recording unit 17 records corresponding beam IDs in elements of “distributed antenna ID #1,” “distributed antenna ID #2,” “distributed antenna ID #3,” and “distributed antenna ID #4” in the row of “record ID #M+1” on the basis of the combination of the source antenna ID and the beam ID (step Sh7).

In the wireless communication system 1d of the fifth embodiment described above, the candidate beam detection unit 15d performs all-beam searches simultaneously using a plurality of distributed antennas randomly selected from the distributed antenna devices 30-1 to 30-4 in a beam search period in which a beam used for wireless communication with the terminal device 40 is searched for, stops the all-beam searches when one beam identifier indicating the best beam among beams according to the all-beam searches has been acquired, sets a beam identified by the acquired beam identifier and information indicating a distributed antenna 31-1 to 31-4 that has transmitted the beam indicated by the beam identifier as a detection reference beam, and detects beam identifiers of distributed antennas 31-1 to 31-4 that have not performed all-beam searches in the beam search period, the beam identifiers corresponding to beams that have been selected together with the detection reference beam, from the beam combination history storage unit 14 as candidate beam identifiers for the distributed antennas 31-1 to 31-4.

The beam search execution determination unit 16 determines whether to cause the distributed antennas 31-1 to 31-4 that have not performed the all-beam search in the beam search period to perform the all-beam search on the basis of detection results from the candidate beam detection unit 15d. The beam combination recording unit 17 generates a record indicating a combination of beam identifiers indicating beams determined to be the best beams for the distributed antennas in the beam search period. The beam combination recording unit 17 records the generated record in the beam combination history storage unit 14. As a result, it is possible to obtain an effect that in the beam combination generation processing performed by the beam combination history generation unit 13, even when it is not possible to generate sufficient records indicating the history of beam combinations while moving the terminal device 40 little by little at intervals that do not reduce the transmission capacity throughout the cell 100 in the service providing area, it is possible to store a sufficiently large number of records to reduce the number of beam searches without reducing transmission capacity when performing beam search processing.

Further, the wireless communication system 1d in the fifth embodiment does not perform all-beam searches in a fixed order for the distributed antenna devices 30-1 to 30-4 at the first stage of beam search processing, but performs all-beam searches simultaneously using a plurality of distributed antenna devices randomly selected from among the distributed antenna devices 30-1 to 30-4. With such a configuration, the wireless communication system 1d performs all-beam search at random timing even for a distributed antenna device in which all-beam search has not been performed by selecting a beam which is not the best beam but whose reception power value exceeds a threshold by partial beam search. Accordingly, the beam combination history table 140 is also updated. Therefore, according to the wireless communication system 1d in the fifth embodiment, it is possible to prevent a combination of beams which are not best from being continuously selected fixedly while reducing the number of beam searches.

### Sixth Embodiment

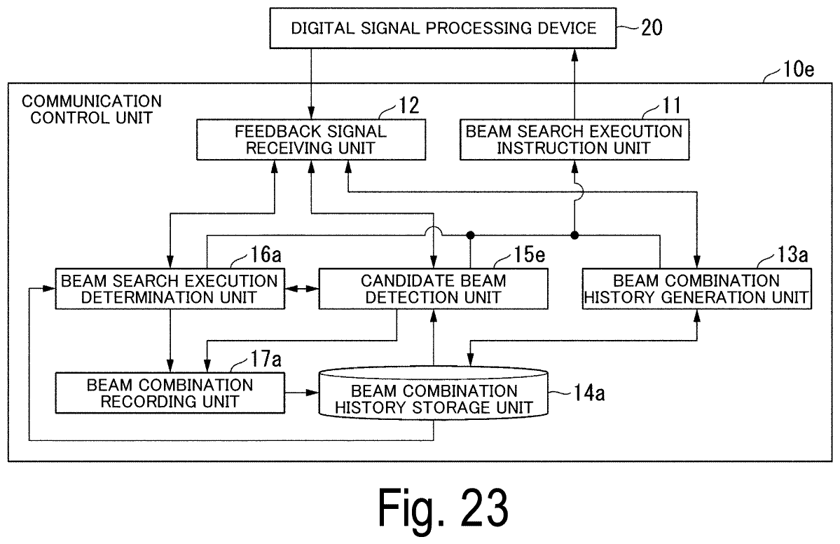

FIG. 23 is a block diagram showing a configuration of a communication control device 10e in a sixth embodiment. The communication control device 10e is a device used in place of the communication control device 10a of the second embodiment, and for convenience of description, the wireless communication system 1a including the communication control device 10e instead of the communication control device 10a will be referred to as a wireless communication system 1e below. In the communication control device 10e, the same components as whose of the communication control device 10a of the second embodiment are denoted by the same reference numerals, and different components will be described below.

The configuration of the wireless communication system 1e in the sixth embodiment differs from the configuration of the wireless communication system 1a in the second embodiment in that all-beam searches are not performed in a fixed order for distributed antenna devices at the first stage of beam search processing, but all-beam searches are performed simultaneously using some distributed antenna devices randomly selected from among a plurality of distributed antenna devices.

The communication control device 10e includes a beam search execution instruction unit 11, a feedback signal receiving unit 12, a beam combination history generation unit 13a, a beam combination history storage unit 14a, a candidate beam detection unit 15e, a beam search execution determination unit 16a, and a beam combination recording unit 17a.

When beam search processing for searching for a beam is started, the candidate beam detection unit 15e randomly selects a plurality of (X) distributed antenna devices from among N distributed antenna devices 30-1 to 30-N. For example, the candidate beam detection unit 15e randomly selects two (X=2) distributed antenna devices from among four (N=4) distributed antenna devices 30-1 to 30-4. Each time beam search processing is performed, the same number of distributed antenna devices (for example, two devices (X=2)) may be selected randomly, or different numbers of distributed antenna devices (for example, two and three devices (X=2 and 3)) may be selected randomly.

The candidate beam detection unit 15e causes the selected plurality of distributed antenna devices to perform all-beam searches simultaneously. That is, the candidate beam detection unit 15e designates distributed antenna IDs of the randomly selected two distributed antennas, for example, the distributed antennas 31-1 and 31-4, and outputs an all-beam search request signal including the designated two distributed antenna IDs to the beam search execution instruction unit 11. Upon receiving the first feedback signal after beam search processing is started, the candidate beam detection unit 15e stops all-beam search and sets a beam identified by a source antenna ID and a beam ID included in the feedback signal as a detection reference beam. The candidate beam detection unit 15e detects, from the beam combination history table 140a shown in FIG. 14, for example, beam IDs of distributed antenna devices 30-1 to 30-4 that have not performed all-beam searches in a beam search period, the beam IDs corresponding to beams that have been selected together with the detection reference beam, and the distributed antenna IDs corresponding to the beam IDs.

In such a case, the candidate beam detection unit 15e detects a reception power value written as an element together with the detected beam IDs in the beam combination history table 140a. The candidate beam detection unit 15e uses the detected beam IDs as candidate beam IDs indicating candidate beams in the distributed antenna devices 30-1 to 30-4 corresponding to the detected distributed antenna IDs and outputs a combination of the detected distributed antenna IDs and candidate beam IDs as detection results. The candidate beam detection unit 15e calculates the average values of the reception power values for each beam ID based on the combination of the detected beam ID and the detected reception power value, and sets the maximum value of the calculated average values as the average reception power value for the detected distributed antenna ID. The candidate beam detection unit 15e includes the calculated average reception power value in the data indicating the detection results.

### (Processing Performed by Wireless Communication System of Sixth Embodiment)

Similarly to the second embodiment, in the wireless communication system 1e of the sixth embodiment, the beam combination generation processing in step S1 and the beam search processing in step S2, shown in FIG. 8. However, the beam search processing performed in the sixth embodiment differs from the processing performed in the second embodiment with respect to points described below.

### (Beam Combination Generation Processing of Sixth Embodiment)

The same beam combination generation processing as in the first embodiment, shown in FIG. 9, is performed by the beam search execution instruction unit 11, the feedback signal receiving unit 12, the beam combination history generation unit 13a, the digital signal processing device 20, and the distributed antenna devices 30-1 to 30-4, and processing performed by the beam combination history generation unit 13a is performed by the beam combination history generation unit 13e.

### (Beam Search Processing of Sixth Embodiment)

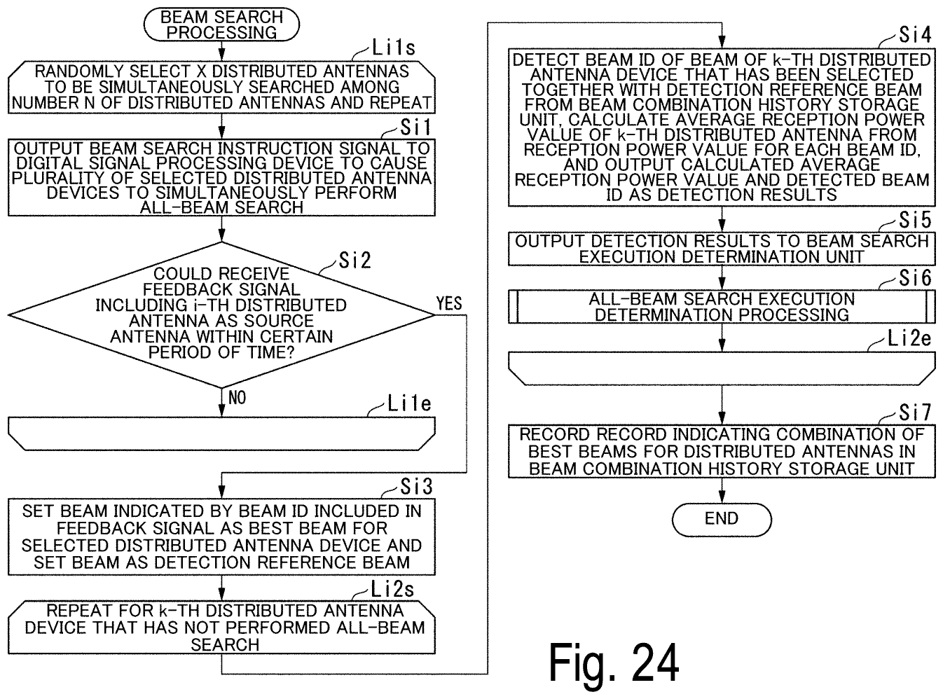

FIG. 24 is a flowchart showing a flow of beam search processing of the sixth embodiment. FIG. 24 is a flowchart showing the flow of beam search processing performed in the processing of step S2 in FIG. 8.

In FIG. 24, in the processing of steps Si1 and Si2, the processing of loop Li1s to Li1e for repeating the processing of steps Si1 and Si2, and the processing of step Si3, the processing of steps Sd1 and Sd2 in FIG. 15, the processing of loop Ld1s to Ld1e for repeating the processing of steps Sd1 and Sd2, and the same processing as the processing of step Sd3 are performed by the beam search execution instruction unit 11, the feedback signal receiving unit 12, the digital signal processing device 20, and the distributed antenna devices 30-1 to 30-4, and the processing performed by the candidate beam detection unit 15a is performed by the candidate beam detection unit 15e. In the processing of step Si7, the above-described processing is performed by the beam combination recording unit 17a.

In response to an operation of the operator of the wireless communication system 1e, the candidate beam detection unit 15e of the communication control device 10e starts beam search processing. The candidate beam detection unit 15e starts an internal beam search cycle timer. When starting the beam search cycle timer, the candidate beam detection unit 15e sets a time indicating the duration of one predetermined beam search cycle.

The candidate beam detection unit 15e reads all distributed antenna IDs written in the distributed antenna ID item of the beam combination history table 140a stored in the beam combination history storage unit 14a. The candidate beam detection unit 15e provides a variable i in an internal storage area thereof. Here, although i is a variable that is an integer value from 1 to N, the wireless communication system 1 in FIG. 1 includes four distributed antenna devices 30-1 to 30-4, and the candidate beam detection unit 15e reads four distributed antenna IDs, “distributed antenna ID #1,” “distributed antenna ID #2,” “distributed antenna ID #3,” and “distributed antenna ID #4” from the beam combination history table 140a, and thus it is assumed that N=4 in the following description. The following description will be made assuming that the i-th distributed antenna device is a distributed antenna device 30-i, the i-th distributed antenna is a distributed antenna 31-i, and the i-th main device is a main device 32-i.

Further, the candidate beam detection unit 15e provides a variable X in an internal storage area. Here, X is a variable that is an integer equal to or greater than 2. X represents the number of distributed antenna devices in which all beam searches are simultaneously performed. As an example, X=2 in the following description.

The candidate beam detection unit 15e outputs an output destination switching instruction signal for setting an output destination to the candidate beam detection unit 15e to the feedback signal receiving unit 12. Upon receiving the output destination switching instruction signal for setting the output destination to the candidate beam detection unit 15e from the candidate beam detection unit 15e, the feedback signal receiving unit 12 sets the candidate beam detection unit 15e as the output destination of the feedback signal.

The candidate beam detection unit 15e randomly selects two (X=2) values from among 1 to N as values of the variable i. The candidate beam detection unit 15e writes and records possible values (i.e., 1 to N) of the variable i and values which have already been selected in the internal storage area. Here, it is assumed that “1” and “3” are selected as values of the variable i. When i=1 and 3, the following processing is performed. That is, in order to cause the distributed antenna device 30-1 including the first distributed antenna 31-1 and the distributed antenna device 30-3 including the third distributed antenna 31-3 to perform all-beam searches simultaneously, the candidate beam detection unit 15e outputs an all-beam search request signal including “distributed antenna ID #1” which is the distributed antenna ID assigned to the first distributed antenna 31-1 and “distributed antenna ID #3” which is the distributed antenna ID assigned to the third distributed antenna 31-3 to the beam search execution instruction unit 11.

After outputting the all-beam search request signal to the beam search execution instruction unit 11, the candidate beam detection unit 15e starts an internal feedback signal timer. When starting the feedback signal timer, the candidate beam detection unit 15e sets the same time as that set in the feedback signal timer by the beam combination history generation unit 13a in the processing of step Sa1 in FIG. 9. Note that the time is a predetermined time and is set in the candidate beam detection unit 15e in advance. When the beam search execution instruction unit 11 receives the all-beam search request signal output by the candidate beam detection unit 15e, then processing after the beam search execution instruction unit 11 receives the all-beam search request signal in the processing of step Sa1 in FIG. 9 is performed by the beam search execution instruction unit 11, the digital signal processing device 20, the main device 32-1, and the main device 32-3, the distributed antenna 31-1, the distributed antenna 31-3, and the terminal device 40 with i=1 and 3 (steps Si1 when i=1 and 3).

The candidate beam detection unit 15e determines whether a feedback signal including any of “distributed antenna ID #1” which is the distributed antenna ID of the distributed antenna 31-1 or “distributed antenna ID #3” which is the distributed antenna ID of the distributed antenna 31-3 as a source antenna ID has been received before the feedback signal timer expires (step Si2 when i=1 and 3).

Here, it is assumed that any of the above-mentioned events in cases where the beam combination history generation unit 13a cannot receive the feedback signal has occurred. In this case, the candidate beam detection unit 15e determines that the feedback signal including “distributed antenna ID #1” which is the distributed antenna ID of the first distributed antenna 31-1 and “distributed antenna ID #3” which is the distributed antenna ID of the third distributed antenna 31-3 as source antenna IDs has not been received before the feedback signal timer expires (No in step Si2). Unless as many values of the variable i as the number N of distributed antennas have been selected at that time (that is, unless any of all possible values of the variable i has been selected), the candidate beam detection unit 15e randomly selects two (X=2) values from 1 to N as values of the variable i. Here, the remaining “2” and “4” are selected as values of the variable i. Then, the processing of steps Si1 and Si2 is performed again (loop Li1s to Li1e).

The candidate beam detection unit 15e performs the following processing as the second processing of loop Li1s to Li1e. That is, in order to cause the distributed antenna device 30-2 including the second distributed antenna 31-2 and the distributed antenna device 30-4 including the fourth distributed antenna 31-4 to perform all-beam searches simultaneously, the candidate beam detection unit 15e outputs an all-beam search request signal including “distributed antenna ID #2,” which is the distributed antenna ID assigned to the second distributed antenna 31-2, and “distributed antenna ID #4,” which is the distributed antenna ID assigned to the fourth distributed antenna 31-4 to the beam search execution instruction unit 11.

After outputting the all-beam search request signal to the beam search execution instruction unit 11, the candidate beam detection unit 15e starts an internal feedback signal timer. When starting the feedback signal timer, the candidate beam detection unit 15e sets the same time as that set in the feedback signal timer by the beam combination history generation unit 13 in the processing of step Sa1 in FIG. 9. When the beam search execution instruction unit 11 receives the all-beam search request signal output by the candidate beam detection unit 15e, then processing after the beam search execution instruction unit 11 receives the all-beam search request signal in the processing of step Sa1 in FIG. 9 is performed by the beam search execution instruction unit 11, the digital signal processing device 20, the main device 32-2, and the main device 32-4, the distributed antenna 31-2, the distributed antenna 31-4, and the terminal device 40 with i=2 and 4 (steps Si1 when i=2 and 4).

The candidate beam detection unit 15e determines whether a feedback signal including “distributed antenna ID #2,” which is the distributed antenna ID of the second distributed antenna 31-2, or “distributed antenna ID #4,” which is the distributed antenna ID of the fourth distributed antenna 31-4, as a source antenna ID has been received before the feedback signal timer expires (step Si2 when i=2 and 4). Here, it is assumed that any of the above-described events in cases where the beam combination history generation unit 13a cannot receive the feedback signal has not occurred, and the feedback signal receiving unit 12 outputs a feedback signal including “distributed antenna ID #2” which is the distributed antenna ID of the second distributed antenna 31-2 as a source antenna ID to the candidate beam detection unit 15e. In this case, the candidate beam detection unit 15e determines that the feedback signal including “distributed antenna ID #2,” which is the distributed antenna ID of the second distributed antenna 31-2, as a source antenna ID has been received before the feedback signal timer expires (Yes in step Si2 when i=2 and 4).

The candidate beam detection unit 15e exits the processing of loop Li1s to Li1e and sets the beam ID included in the received feedback signal as the beam ID indicating the best beam for the second distributed antenna device 30-2. The candidate beam detection unit 15e sets the beam identified by the beam ID and “distributed antenna ID #2,” which is the source antenna ID included in the feedback signal, as a detection reference beam. Here, it is assumed that the beam ID included in the feedback signal received by the candidate beam detection unit 15e is “beam ID #33.”

The candidate beam detection unit 15e combines the source antenna ID, beam ID, and reception power value included in the feedback signal into one set of data, and outputs the one set of data to the beam combination recording unit 17a. The beam combination recording unit 17a receives the one set of data output by the candidate beam detection unit 15e. The candidate beam detection unit 15e outputs an output destination switching instruction signal for setting an output destination to the beam search execution determination unit 16a to the feedback signal receiving unit 12. Upon receiving the output destination switching instruction signal for setting the output destination to the beam search execution determination unit 16a from the candidate beam detection unit 15e, the feedback signal receiving unit 12 sets the output destination of the feedback signal to the beam search execution determination unit 16a (step Si3).

In other words, regarding the processing in steps Si2 and Si3 above, the candidate beam detection unit 15e performs processing of causing all the distributed antenna devices 30-1 to 30-4 to perform all-beam search in a random order, and when one feedback signal is received during the processing, the candidate beam detection unit 15e ends the processing of loop Li1s to Li1e and sets the beam identified by the source antenna ID and beam ID included in the received feedback signal as a detection reference beam.

If the wireless communication system 1e includes N distributed antenna devices 30-1 to 30-N, at the time of exiting loop Li1s to Li1e, a distributed antenna device 30-k that has not performed all-beam search is identified using values of the variable i that have been selected up to that time and the value of N. The candidate beam detection unit 15e writes and records possible values of the variable k and values that have already been selected in an internal storage area.

The candidate beam detection unit 15e performs the following processing when k=1. That is, the candidate beam detection unit 15e detects, from the beam combination history table 140a, the beam ID of the beam of the first distributed antenna device 30-1, which has been selected together with the detection reference beam. Here, the detection reference beam is a beam identified by “beam ID #33” of “distributed antenna ID #2”. In the beam combination history table 140a, “beam ID #33” of “distributed antenna ID #2” corresponding to the detection reference beam is included in “record ID #2”, “record ID #4”, and “record ID #6”. “Beam ID #13” and “beam ID #25” are written in the “distributed antenna ID #i” of “Record ID #2,” “record ID #4,” and “record ID #6.”

Therefore, the candidate beam detection unit 15e detects “beam ID #13” and “beam ID #25” as the beam ID of the beam of the first distributed antenna device 30-1, which has been selected together with the detection reference beam, from the beam combination history table 140a. The candidate beam detection unit 15e sets “beam ID #13” and “beam ID #25” as candidate beam IDs indicating candidate beams of the distributed antenna device 30-1 corresponding to “distributed antenna ID #1.”

The candidate beam detection unit 15e further detects “(reception power value 2-1)” of “record ID #2”, and “(reception power value 6-1)” of “record ID #6” with respect to “beam ID #25” and detects “(reception power value 4-1)” of “record ID #4” with respect to “beam ID #13.” The candidate beam detection unit 15e calculates the average value of “(reception power value 2-1)” and “(reception power value 6-1)” corresponding to “beam ID #25.” Since there is only “(reception power value 4-1)” for “beam ID #13,” “(reception power value 4-1)” is used as the average value. The candidate beam detection unit 15e sets the maximum average value of the average value corresponding to “beam ID #13” and the average value of “beam ID #25” as the average reception power value for “distributed antenna ID #1”. The candidate beam detection unit 15e generates data indicating detection results including “distributed antenna ID #1,” “beam ID #13,” which is a candidate beam ID, “beam ID #25,” and the calculated average reception power value (step Si4 when k=1). The candidate beam detection unit 15e outputs the generated data indicating the detection results to the beam search execution determination unit 16a (step Si5 when k=1).

In the processing of step Se1 of the subroutine for all-beam search execution determination processing in FIG. 16, which is performed in the subsequent processing of step Si6, the beam search execution determination unit 16a receives the detection result data output by the candidate beam detection unit 15e. In the processing of step Se2, the beam search execution determination unit 16a determines that the candidate beam ID is included in the received data indicating the detection results (step Se2 when k=1, Yes).

If the beam search execution determination unit 16a determines “Yes” in the determination processing of step Se8, the beam search execution determination unit 16a reads the average reception power value included in the data indicating the detection results, adds a margin to the read average reception power value, and calculates a threshold for “distributed antenna ID #1” (step Se9). The beam search execution determination unit 16a determines whether the reception power value included in the feedback signal exceeds the threshold calculated for the source antenna ID (here, “distributed antenna ID #1”) included in the feedback signal (step Se10 when k=1).

If the beam search execution determination unit 16a determines that the reception power value included in the feedback signal exceeds the threshold calculated for the source antenna ID included in the feedback signal (Yes in step Se10), then the processing proceeds to step Se5. On the other hand, if the beam search execution determination unit 16a determines that the reception power value included in the feedback signal does not exceed the threshold calculated for the source antenna ID included in the feedback signal (No in step Se10), then the processing proceeds to step Se3.

As a result, in the sixth embodiment, when the beam search execution determination unit 16a determines to cause any of the distributed antenna devices 30-1 to 30-4 to perform a partial beam search, if the reception power value included in the feedback signal acquired through the partial beam search is approximately equal to the past average reception power value of the distributed antenna devices 30-1 to 30-4 for the partial beam search, a beam indicated by a beam ID included in the feedback signal can be searched as the best beam of the distributed antenna devices 30-1 to 30-4 corresponding to the source antenna ID included in the feedback signal. The beam search execution determination unit 16a can add data related to the beam to the beam combination history table 140a.

On the other hand, if the reception power value included in the feedback signal acquired through the partial beam search is not approximately equal to the past average reception power value of the distributed antenna devices 30-1 to 30-4 targeted for the partial beam search, the beam search execution determination unit 16a causes the distributed antenna devices 30-1 to 30-4 corresponding to the source antenna ID included in the feedback signal to perform an all-beam search. If the beam search execution determination unit 16a can acquire a feedback signal through the all-beam search, it is possible to search for the best beam in the distributed antenna devices 30-1 to 30-4 for all-beam search, and if it is not possible to acquire the feedback signal, it is impossible to search for the best beam for the distributed antenna devices 30-1 to 30-4 for all-beam search. Therefore, in the sixth embodiment, it is possible to search for the best beam more accurately than in the first embodiment, the third embodiment, and the fifth embodiment at the time of performing a partial beam search in addition to the effects achieved by the communication control device 10 of the first embodiment, the communication control device 10b of the third embodiment, and the communication control device 10d of the fifth embodiment.

In the fifth embodiment described above, the possibility that a beam which is not best in terms of communication quality is selected can be further reduced by setting the predetermined threshold of the reception power value higher. However, in this case, since all-beam searches are performed with respect to more distributed antenna devices in the fifth embodiment, it is difficult to reduce the number of beam searches. Further, since the optimum threshold changes depending on the position of a terminal device or the like, it is difficult to set a threshold for selecting the best beam as a uniform value while reducing the number of beam searches. On the other hand, in the sixth embodiment, a threshold is substantially changed for each position of the terminal device 40 by changing the threshold for each combination of beams, and thus the threshold is adaptively set.

Although the method in which the average value of reception power values for each detected beam ID is used as a reference has been described in the sixth embodiment, the reference is not limited to the average value. For example, the value used as the reference may be a median value, a mode value, a maximum value, or a minimum value. Further, when a maximum value, a minimum value or an average value is used as the reference among these values, other records may be deleted by calculating the value every time by a combination of the same beam IDs.

If there is a value that has never been selected among possible values (here, “1,” “3,” and “4”) of the variable k at that time, the candidate beam detection unit 15e selects the value that has never been selected, and processing of steps Si4 to Si6 is performed again (loop Li2s to Li2e). Here, since “3” (and “4”) among the possible values (here, “1,” “3,” and “4”) of the variable k has not been selected yet, the candidate beam detection unit 15e sets “3” as a new value of k.

The candidate beam detection unit 15e performs the following processing when k=3. In the processing of loop Li2s to Li2e, when k=3, the candidate beam detection unit 15e cannot detect the candidate beam ID corresponding to “distributed antenna ID #3” from the beam combination history table 140a as in the first embodiment, the third embodiment, and the fifth embodiment. Therefore, in this case, the candidate beam detection unit 15e cannot detect the reception power value. Therefore, the candidate beam detection unit 15e does not calculate the average reception power value and outputs detection results that there is no candidate beam ID indicating a candidate beam which is a beam of the third distributed antenna device 30-3 and has been selected together with the detection reference beam, similarly to step Sb4 of the first embodiment, step Sd4 of the third embodiment, and step Sh4 of the fifth embodiment. The candidate beam detection unit 15e generates data indicating the detection results including only “distributed antenna ID #3” (step Si4 when k=3).

The candidate beam detection unit 15e outputs data indicating the detection results including only “distributed antenna ID #3” to the beam search execution determination unit 16a (step Si5 when k=3). When the beam search execution determination unit 16a receives data indicating the detection results from the candidate beam detection unit 15e, the beam search execution determination unit 16a starts a subroutine for all-beam search execution determination processing shown in FIG. 16 (step Si6 when k=3).

A subroutine of all-beam search execution determination processing performed in step Si6 of the beam search processing of the sixth embodiment will be described with reference to FIG. 16. In processing of steps Se1 to Se6, the same processing as steps Sc1 to Sc6 shown in FIG. 11 is performed by the beam search execution instruction unit 11, the feedback signal receiving unit 12, the digital signal processing device 20, and the distributed antenna devices 30-1 to 30-4, and processing performed by the beam search execution determination unit 16 is performed by the beam search execution determination unit 16a. Therefore, when k=3, the beam search execution determination unit 16a determines “No” in the determination processing of step Se2, and the processing proceeds to step Se3, and thus the same processing as in the case of k=3 in the first embodiment and in the case of k=3 in the third embodiment, and in the case of k=3 in the fifth embodiment is performed thereafter.

As a result, in the sixth embodiment, when the beam search execution determination unit 16a determines to cause any of the distributed antenna devices 30-1 to 30-4 to perform a partial beam search, if the reception power value included in the feedback signal acquired through the partial beam search is approximately equal to the past average reception power value of the distributed antenna devices 30-1 to 30-4 for the partial beam search, a beam indicated by a beam ID included in the feedback signal can be searched as the best beam of the distributed antenna devices 30-1 to 30-4 corresponding to the source antenna ID included in the feedback signal. The beam search execution determination unit 16a can add data related to the beam to the beam combination history table 140a.

On the other hand, if the reception power value included in the feedback signal acquired through the partial beam search is not approximately equal to the past average reception power value of the distributed antenna devices 30-1 to 30-4 targeted for the partial beam search, the beam search execution determination unit 16a causes the distributed antenna devices 30-1 to 30-4 corresponding to the source antenna ID included in the feedback signal to perform an all-beam search. If the beam search execution determination unit 16a can acquire a feedback signal through the all-beam search, it is possible to search for the best beam in the distributed antenna devices 30-1 to 30-4 for all-beam search, and if it is not possible to acquire the feedback signal, it is impossible to search for the best beam for the distributed antenna devices 30-1 to 30-4 for all-beam search. Therefore, in the sixth embodiment, it is possible to search for the best beam more accurately than in the first embodiment, the third embodiment, and the fifth embodiment at the time of performing a partial beam search in addition to the effects achieved by the communication control device 10 of the first embodiment, the communication control device 10b of the third embodiment, and the communication control device 10d of the fifth embodiment.

In addition, the wireless communication system 1e in the sixth embodiment does not perform all-beam searches in a fixed order for the distributed antenna devices 30-1 to 30-4 at the first stage of beam search processing, but performs all-beam searches simultaneously using a plurality of distributed antenna devices randomly selected from among the distributed antenna devices 30-1 to 30-4. With such a configuration, the wireless communication system 1e performs all-beam search at random timing even for a distributed antenna device in which all-beam search has not been performed by selecting a beam which is not the best beam but whose reception power value exceeds a threshold by partial beam search. Accordingly, the beam combination history table 140a is also updated. Therefore, according to the wireless communication system 1e in the sixth embodiment, it is possible to prevent a combination of beams which are not best from being continuously selected fixedly while reducing the number of beam searches.

The wireless communication systems in the third to sixth embodiments described above repeatedly selects one or a plurality of distributed antenna devices 30-1 to 30-4 randomly at the first stage of beam search processing and perform all-beam searches in order. On the other hand, the wireless communication systems may select one or a plurality of distributed antenna devices 30-1 to 30-4 randomly only for the first time at the first stage of beam search processing, and then shift the selection order one by one every time.

That is, for example, the candidate beam detection units 15b and 15c first randomly select one of 1 to N (here, it is assumed that N=4) as a value of the variable i at the first stage of beam search processing. For example, it is assumed here that i=2 is selected. Accordingly, the candidate beam detection units 15b and 15c first cause the distributed antenna device 30-2 including the second distributed antenna 31-2 to perform an all-beam search. Thereafter, the candidate beam detection units 15b and 15c select i=3 obtained by adding 1 to the value of the variable i instead of randomly selecting one of 1 to N as a value of the variable i. Accordingly, the candidate beam detection units 15b and 15c subsequently cause the distributed antenna device 30-3 including the third distributed antenna 31-3 to perform an all-beam search. Thereafter, the candidate beam detection units 15b and 15c add 1 to the value of the variable i in order and select i=4 and i=1 in order. Accordingly, the candidate beam detection units 15b and 15c subsequently cause the distributed antenna device 30-4 including the fourth distributed antenna 31-4 to perform an all-beam search, and then cause the distributed antenna device 30-1 including the first distributed antenna 31-1 to perform an all-beam search.

In this manner, when the candidate beam detection units 15b and 15c select 2 as a value of the variable i at the first time according to random selection, the candidate beam detection units 15b and 15c select the value of the variable i in the order of 2, 3, 4, and 1. Then, in the next candidate beam detection processing, the candidate beam detection units 15b and 15c select 3 obtained by adding 1 to 2 which is the randomly selected value as the value of the variable i, and select values of the variable i in the order of 3, 4, 1, and 2. Then, in the next candidate beam detection processing, the candidate beam detection units 15b and 15c select 4 obtained by adding 1 to 3 which is the added value as the value of the variable i, and select values of the variable i in the order of 4, 1, 2, and 3.

Alternatively, for example, the candidate beam detection units 15d and 15e first randomly select two (here, it is assumed that X=2) from among 1 to N (here, it is assumed that N=8) as values of the variable i for the first time at the first stage of beam search processing. For example, it is assumed that i=2 and 6 are selected here. Accordingly, the candidate beam detection units 15d and 15e first cause the distributed antenna device 30-2 including the second distributed antenna 31-2 and the distributed antenna device 30-6 (not shown) including the sixth distributed antenna 31-6 (not shown) to perform all-beam searches. Thereafter, the candidate beam detection units 15d and 15e select i=3 and 7 obtained by adding 1 to the values of the variable i instead of randomly selecting one of 1 to N as a value of the variable i. Accordingly, the candidate beam detection units 15d and 15e subsequently cause the distributed antenna device 30-3 including the third distributed antenna 31-3 and the distributed antenna device 30-7 (not shown) including the seventh distributed antenna 31-7 (not shown) to perform all-beam searches.

Thereafter, the candidate beam detection units 15d and 15e add 1 to the values of the variable i in order and select i=4 and 8, and i=5 and 1 in order. Accordingly, the candidate beam detection units 15d and 15e subsequently cause the distributed antenna device 30-4 including the fourth distributed antenna 31-4 and the distributed antenna device 30-8 (not shown) including the eighth distributed antenna 31-8 (not shown) to perform all-beam searches, and then cause the distributed antenna device 30-5 (not shown) including the fifth distributed antenna 31-5 (not shown) and the distributed antenna device 30-1 including the first distributed antenna 31-1 to perform all-beam searches.

In this manner, when the candidate beam detection units 15d and 15e select 2 and 6 as values of the variable i according to random selection at the first time, the candidate beam detection units 15d and 15e select values of the variable i in the order of 2 and 6, 3 and 7, 4 and 8, 5 and 1. Then, in the next candidate beam detection processing, the candidate beam detection units 15d and 15e select 3 and 7 obtained by adding 1 to 2 and 6 which are randomly selected values as the values of the variable i, and select values of the variable i in the order of 3 and 7, 4 and 8, 5 and 1, 6 and 2. Then, in the next candidate beam detection processing, the candidate beam detection units 15d and 15e select 4 and 8 obtained by adding 1 to 3 and 7 which are the added values as the values of the variable i, and select values of the variable i in the order of 4 and 8, 5, 1, 6 and 2, 7 and 3.

With such a configuration, the wireless communication system randomly selects one or a plurality of distributed antenna devices 30-1 to 30-4 only for the first time at the first stage of beam search processing, and then shifts the selection order one by one every time. With such a configuration, the wireless communication system performs an all-beam search at random timing even for a distributed antenna device in which an all-beam search has not been performed by selecting a beam which is not the best beam but whose reception power value exceeds a threshold according to a partial beam search. Accordingly, the beam combination history table is also updated. Therefore, according to the wireless communication system, it is possible to prevent a combination of beams which are not best from being continuously selected fixedly while reducing the number of beam searches.

Generally, a distributed antenna system using a high-frequency band needs to periodically perform beam selection at an appropriate frequency in order to follow propagation path variation caused by movement of a terminal device, change in the surrounding environment, and the like. However, if the time required for one beam selection excessively increases due to an increase in the number of distributed antennas, the time required for the beam selection may become longer than the execution cycle of the beam selection. In this case, the beam selection cannot be completed within the execution cycle of the beam selection, and thus it becomes difficult to execute data transmission itself.

On the other hand, the wireless communication system 1d in the fifth embodiment and the wireless communication system 1e in the sixth embodiment are configured to simultaneously perform all-beam searches using a plurality of distributed antenna devices randomly selected from among the distributed antenna devices 30-1 to 30-4 at the first stage of beam search processing. Here, as a method for simultaneously performing all-beam searches using distributed antenna devices, for example, a technique such as frequency multiplexing or code multiplexing is used.

In the fifth and sixth embodiments, all-beam searches can be performed by a plurality of distributed antennas simultaneously using orthogonal radio resources. However, when this is carried out by all distributed antennas, all-beam searches are completed, and thus a partial beam search using a history is not required, but radio resources necessary for beam search are enormous. Therefore, in the fifth and sixth embodiments, all-beam searches are simultaneously performed by some of a plurality of distributed antennas, and partial beam searches using a history are performed for the remaining distributed antennas.

On the other hand, in seventh and eighth embodiments which will be described below, the same beam search signal is simultaneously transmitted through all distributed antennas, and the best beam is determined from reception quality for each beam ID in a terminal device 40a. Then, the distributed antenna having the best beam is identified by the reception quality of a feedback signal on the distributed antenna side. In this manner, in the seventh and eighth embodiments which will be described below, since the same radio resources are used, radio resources spent for beam search can be reduced as compared with the fifth and sixth embodiments. In the seventh and eighth embodiments, the best beam of the best distributed antenna can be searched according to the above-described configuration, but the best beam from another distributed antenna cannot be searched, and thus a partial beam search using a history is used here.

Further, in the seventh and eighth embodiments which will be described below, a wireless communication system performs all-beam searches simultaneously using all of a plurality of distributed antenna devices at the first stage of the beam search processing.

### Seventh Embodiment

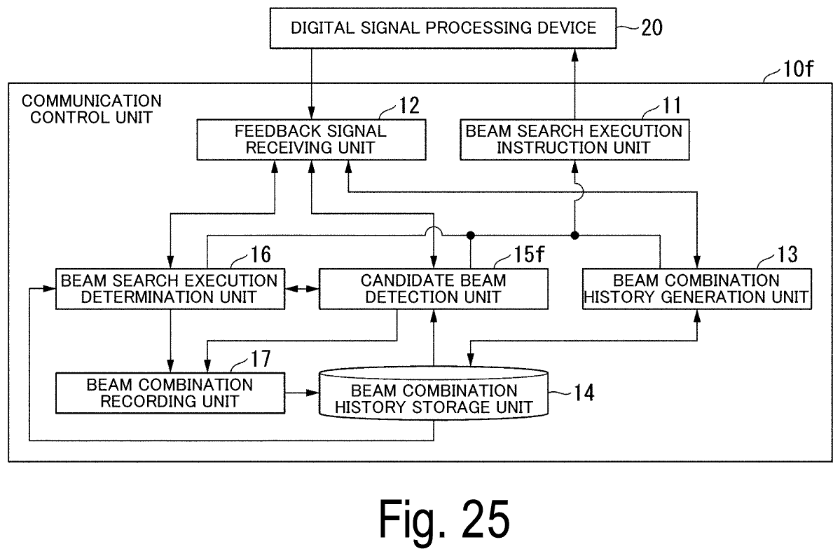

FIG. 25 is a block diagram showing a configuration of a communication control device 10f in the seventh embodiment. The communication control device 10f is a device used in place of the communication control device 10 of the first embodiment. Hereinafter, for convenience of explanation, the wireless communication system 1 including the communication control device 10f instead of the communication control device 10 will be referred to as a wireless communication system 1f. In the communication control device 10f, the same components as the communication control device 10 of the first embodiment are given the same reference numerals, and different components will be explained below.

The configuration of a wireless communication system 1f in the seventh embodiment differs from the configuration of the wireless communication system 1 in the first embodiment in that all-beam searches are simultaneously performed using all of a plurality of distributed antenna devices instead of performing all-beam searches one by one in a fixed order for the plurality of distributed antenna devices in the first stage of beam search processing.

The communication control device 10f includes a beam search execution instruction unit 11, a feedback signal receiving unit 12, a beam combination history generation unit 13, a beam combination history storage unit 14, a candidate beam detection unit 15f, a beam search execution determination unit 16, and a beam combination recording unit 17.

When beam search processing for searching for a beam is started, the candidate beam detection unit 15f causes all of N distributed antenna devices 30-1 to 30-N to simultaneously perform all-beam searches. At this time, the candidate beam detection unit 15f outputs an all-beam search request signal for causing all the N distributed antenna devices 30-1 to 30-N to transmit beam search signals including the same beam ID to the beam search execution instruction unit 11. Here, the candidate beam detection unit 15f outputs the all-beam search request signal to the beam search execution instruction unit 11 such that beams including the same beam ID are simultaneously transmitted from all of four (N=4) distributed antenna devices 30-1 to 30-4.

The candidate beam detection unit 15f stops all-beam searches when first feedback signals are received from all distributed antenna devices (the distributed antenna devices 30-1 to 30-4 here since N=4) after beam search processing is started.

In the seventh embodiment and the eighth embodiment which will be described later, a beam ID is included in a feedback signal but a distributed antenna ID is not included, unlike the above-described embodiments. This is because a beam ID that is information for identifying a beam used for transmission can be included in a beam search signal since beam search signals including the same beam ID are simultaneously transmitted from all distributed antenna devices to the terminal device 40a which will be described later in the wireless communication systems in the seventh and eighth embodiments, but a distributed antenna ID for identifying a distributed antenna device used for transmission cannot be included in a beam search signal.

Therefore, in the wireless communication systems in the seventh and eighth embodiments, a feedback signal transmitted from the terminal device 40a is received by each distributed antenna device (here, each of the distributed antenna devices 30-1 to 30-4), the reception quality (e.g., reception power) of the feedback signal is measured for each distributed antenna device, and it which distributed antenna device is best for wireless communication with the terminal device 40a is determined.

In the wireless communication systems in the seventh and eighth embodiments, the same beam search signal is simultaneously transmitted from a plurality of distributed antenna devices, and thus when the beam search signal is received by the terminal device 40a, a delay wave in a range such as a general guard interval can be received without interference. However, with such a configuration, in the wireless communication systems in the seventh and eighth embodiments, the best distributed antenna cannot be determined and only the best beam can be determined on the side of the terminal device 40a. Therefore, in the wireless communication systems in the seventh and eighth embodiments, the feedback signal transmitted from the terminal device 40a is received by a plurality of distributed antennas, and a distributed antenna with the best reception quality (e.g., the maximum reception power) is determined as the best antenna.

The candidate beam detection unit 15f reads the beam ID included in the feedback signal transmitted from the terminal device 40a. The candidate beam detection unit 15f measures the reception power of the feedback signal and identifies the distributed antenna device having the maximum reception power. The candidate beam detection unit 15f sets a beam identified by the distributed antenna ID indicating the identified distributed antenna device and the beam ID read from the feedback signal as a detection reference beam.

The candidate beam detection unit 15f detects, from the beam combination history table 140, the beam IDs of distributed antenna devices other than the distributed antenna device having the maximum reception power, the beam IDs corresponding to beams that have been selected together with the detection reference beam, and the distributed antenna IDs corresponding to the beam IDs. The candidate beam detection unit 15f sets the detected beam IDs as candidate beam IDs indicating candidate beams in the distributed antenna devices 30-1 to 30-4 corresponding to the detected distributed antenna IDs and outputs a combination of the detected distributed antenna IDs and candidate beam IDs as detection results.

### (Processing Performed by Wireless Communication System of Seventh Embodiment)

Similarly to the first embodiment, in the wireless communication system 1f of the seventh embodiment, the beam combination generation processing in step S1 and the beam search processing in step S2, shown in FIG. 8, are also performed. However, the beam search processing performed in the seventh embodiment differs from the processing performed in the first embodiment with respect to the points described below.

### (Beam Combination Generation Processing of Seventh Embodiment)

Beam combination generation processing shown in FIG. 9, which is the same processing as in the first embodiment, is performed by the beam search execution instruction unit 11, the feedback signal receiving unit 12, the beam combination history generation unit 13, the digital signal processing device 20, and the distributed antenna devices 30-1 to 30-4.

### (Beam Search Processing of Seventh Embodiment)

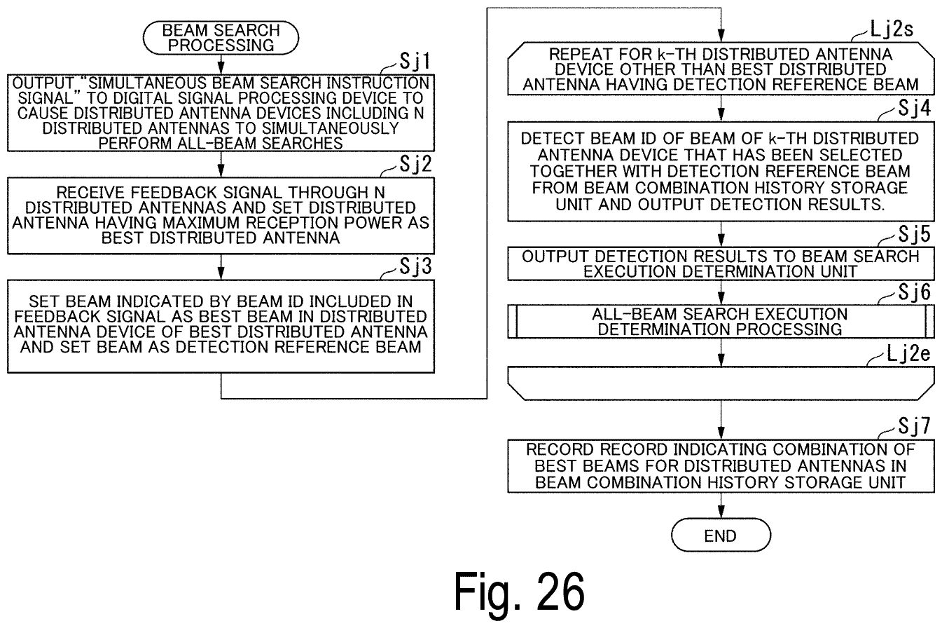

FIG. 26 is a flowchart showing a flow of beam search processing of the seventh embodiment. FIG. 26 is a flowchart showing the flow of the beam search processing performed in the processing of step S2 in FIG. 8. As a premise for starting the beam search processing shown in FIG. 8, it is assumed that the beam combination history table 140 shown in FIG. 4 has been generated in the beam combination history storage unit 14.

In FIG. 26, in processing of steps Sj1 to Sj3, the aforementioned processing is performed by the candidate beam detection unit 15f. In processing of steps Sj4 to Sj6, processing of loop Lj2s to Lj2e for repeating the processing of steps Sj4 to Sj6, and processing of step Sj7, the same processing as the processing of step Sb3, the processing of steps Sb4 to Sb6, the processing of loop Lb2s to Lb2e for repeating the processing of steps Sb4 and Sb6, and the processing of step Sb7 in FIG. 10 is performed by the beam search execution instruction unit 11, the feedback signal receiving unit 12, the beam combination recording unit 17, the digital signal processing device 20, and the distributed antenna devices 30-1 to 30-4, and the processing performed by the candidate beam detection unit 15 is performed by the candidate beam detection unit 15f.

In response to an operation of the operator of the wireless communication system 1f, the candidate beam detection unit 15f of the communication control device 10f starts beam search processing. The candidate beam detection unit 15f starts an internal beam search cycle timer. When starting the beam search cycle timer, the candidate beam detection unit 15f sets a time indicating the duration of one predetermined beam search cycle.

The candidate beam detection unit 15f reads all distributed antenna IDs written in the distributed antenna ID item of the beam combination history table 140 stored in the beam combination history storage unit 14. The candidate beam detection unit 15f provides a variable i in an internal storage area thereof. Here, although i is a variable that is an integer value from 1 to N, the wireless communication system 1 in FIG. 1 includes four distributed antenna devices 30-1 to 30-4, and the candidate beam detection unit 15f reads four distributed antenna IDs, “distributed antenna ID #1,” “distributed antenna ID #2,” “distributed antenna ID #3,” and “distributed antenna ID #4” from the beam combination history table 140, and thus it is assumed that N=4 in the following description. The following description will be made assuming that the i-th distributed antenna device is a distributed antenna device 30-i, the i-th distributed antenna is a distributed antenna 31-i, and the i-th main device is a main device 32-i.

The candidate beam detection unit 15f outputs an output destination switching instruction signal for setting an output destination to the candidate beam detection unit 15f to the feedback signal receiving unit 12. Upon receiving the output destination switching instruction signal for setting the output destination to the candidate beam detection unit 15f from the candidate beam detection unit 15f, the feedback signal receiving unit 12 sets the candidate beam detection unit 15f as the output destination of the feedback signal.

The candidate beam detection unit 15f selects all values of 1 to N (here, N=4) as values of the variable i. The candidate beam detection unit 15f outputs an all-beam search request signal including “distributed antenna ID #1” which is a distributed antenna ID given to the first distributed antenna 31-1, “distributed antenna ID #2” which is a distributed antenna ID given to the second distributed antenna 31-2, “distributed antenna ID #3” which is a distributed antenna ID given to the third distributed antenna 31-3, and “distributed antenna ID #4” which is a distributed antenna ID given to the fourth distributed antenna 31-4 to the beam search execution instruction unit 11 in order to cause the distributed antenna device 30-1 including the first distributed antenna 31-1, the distributed antenna device 30-2 including the second distributed antenna 31-2, the distributed antenna device 30-3 including the third distributed antenna 31-3, and the distributed antenna device 30-4 including the fourth distributed antenna 31-4 to perform all-beam searches for transmitting beam search signals including the same beam ID.

After outputting the all-beam search request signal to the beam search execution instruction unit 11, the candidate beam detection unit 15f starts an internal feedback signal timer. When starting the feedback signal timer, the candidate beam detection unit 15f sets the same time as that set in the feedback signal timer by the beam combination history generation unit 13 in the processing of step Sa1 in FIG. 9. Note that the time is a predetermined time and is set in the candidate beam detection unit 15f in advance.

The beam search execution instruction unit 11 reads a beam ID maximum value from the beam count table 110 in the internal storage area. Here, as an example, it is assumed that the beam search execution instruction unit 11 reads “40” as the beam ID maximum value. The beam search execution instruction unit 11 generates a number of beam search instruction signals corresponding to the read beam ID maximum value, that is, “40,” which are simultaneous beam search instruction signals each including one beam ID between 1 and the beam ID maximum value such that the beam IDs included therein are all different beam IDs.

Here, the simultaneous beam search instruction signals are instruction signals for simultaneously transmitting beam search signals including the same beam ID from a plurality of distributed antenna devices to the terminal device 40a, and returning a feedback signal indicating the best beam ID to the terminal device 40a. The beam search execution instruction unit 11 outputs the 40 generated beam search instruction signals one by one to the digital signal processing device 20 at predetermined fixed time intervals in the order of generation (step Sj1).

The digital signal processing device 20 sequentially receives the 40 beam search instruction signals output from the beam search execution instruction unit 11. The digital signal processing device 20 generates beam search signals from the received beam search instruction signals. The digital signal processing device 20 outputs the generated beam search signals to all main devices 32-i (i=1 to N) in the order of generation, respectively. The respective main devices 32-i (i=1 to N) receive the beam search signals output from the digital signal processing device 20. Each main device 32-i (i=1 to N) modulates a carrier wave on the basis of the beam search signal to form a beam in a direction corresponding to the beam ID included in the received beam search signal. Each main device 32-i (i=1 to N) generates a radio-frequency analog signal carrying the beam search signal generated by modulation. Each main device 32-i (i=1 to N) outputs the generated radio-frequency analog signal to the i-th distributed antenna 31-i (i−1 to N), whereby all distributed antennas 31-i (i=1 to N) transmit beams carrying the beam search signal in the direction of the beam ID included in the beam search signal.

The terminal device 40a receives all beams transmitted by the distributed antennas 31-i (i=1 to N). The terminal device 40 performs processing which will be described later on each of the received beams, and transmits a feedback signal including a beam ID indicating the best beam to all the distributed antennas 31-I (i=1 to N). Each distributed antenna 31-i (i=1 to N) receives radio waves carrying the feedback signal transmitted by the terminal device 40a. Each distributed antenna 31-i (i=1 to N) outputs the received radio waves as an analog signal to each main device 32-i (i=1 to N). Each main device 32-i (i=1 to N) converts the analog signal including the feedback signal into a digital signal and outputs the digital signal to the digital signal processing device 20. The digital signal processing device 20 detects and acquires the feedback signal included in the digital signal output by each main device 32-i (i=1 to N). The digital signal processing device 20 outputs the acquired feedback signal to the feedback signal receiving unit 12 of the communication control device 10f. The feedback signal receiving unit 12 receives the feedback signal output by the digital signal processing device 20, and outputs the received feedback signal to the candidate beam detection unit 15f set as an output destination.

The candidate beam detection unit 15f receives the feedback signal transmitted from the terminal device 40a and received by each distributed antenna 31-i (i=1 to N). The candidate beam detection unit 15f reads the beam ID included in the received feedback signal. Further, the candidate beam detection unit 15f measures the reception power of the feedback signal and identifies a distributed antenna having the maximum reception power as the best distributed antenna (step Sj2). In addition, the candidate beam detection unit 15f defines a beam identified by the beam ID read from the feedback signal as the best beam in the distributed antenna device having the best distributed antenna and sets it as a detection reference beam (step Sj3).

Here, it is assumed that the distributed antenna having the maximum reception power is the second distributed antenna 31-2. The distributed antenna ID of the second distributed antenna 31-2 is “distributed antenna ID #2.” Here, it is assumed that the beam ID included in the feedback signal received by the candidate beam detection unit 15f is “beam ID #33.”

The candidate beam detection unit 15f detects, from the beam combination history table 140, the beam IDs of distributed antenna devices other than the distributed antenna device having the maximum reception power, the beam IDs corresponding to beams that have been selected together with the detection reference beam, and the distributed antenna IDs corresponding to the beam IDs. The candidate beam detection unit 15f defines detected beam IDs as beam IDs as candidate beam IDs indicating candidate beams in the distributed antenna devices 30-1 to 30-4 corresponding to the detected distributed antenna IDs and outputs a combination of the detected distributed antenna IDs and candidate beam IDs as detection results (step Sj4).

The candidate beam detection unit 15f outputs an output destination switching instruction signal for setting the output destination to the beam search execution determination unit 16 to the feedback signal receiving unit 12. Upon receiving the output destination switching instruction signal for setting the output destination to the beam search execution determination unit 16 from the candidate beam detection unit 15f, the feedback signal receiving unit 12 sets the output destination of the feedback signal to the beam search execution determination unit 16 (step Sj5).

The candidate beam detection unit 15f performs the following processing when k=1. That is, the candidate beam detection unit 15f detects the beam ID of the beam of the first distributed antenna device 30-1, which has been selected together with the detection reference beam, from the beam combination history table 140. Here, the detection reference beam is a beam identified by “beam ID #33” of “distributed antenna ID #2”. In the beam combination history table 140, “beam ID #33” of “distributed antenna ID #1” corresponding to the detection reference beam is included in “record ID #2,” “record ID #4,” and “record ID #6.” “Beam ID #13” and “beam ID #25” are written in the “distributed antenna ID #1” of “Record ID #2,” “record ID #4,” and “record ID #6.”

Therefore, the candidate beam detection unit 15f detects “beam ID #13” and “beam ID #25” as the beam ID of the beam of the first distributed antenna device 30-1, which has been selected together with the detection reference beam, from the beam combination history table 140. The candidate beam detection unit 15f sets “beam ID #13” and “beam ID #25” as candidate beam IDs indicating candidate beams of the distributed antenna device 30-1 corresponding to “distributed antenna ID #1.” The candidate beam detection unit 15f generates data indicating detection results including “distributed antenna ID #1,” “beam ID #13” and “beam ID #25 that are candidate beam IDs (step Sj4 when k=1). The candidate beam detection unit 15f outputs the generated data indicating the detection results to the beam search execution determination unit 16 (step Sh5 when k=1). Upon receiving the data indicating the detection results from the candidate beam detection unit 15f, the beam search execution determination unit 16 starts a subroutine for all-beam search execution determination processing shown in FIG. 11 (step Sj6 when k=1).

The beam search execution determination unit 16 receives the data indicating the detection results output by the candidate beam detection unit 15f (step Sc1 when k=1). The beam search execution determination unit 16 determines whether the candidate beam ID is included in the received data indicating the detection results (step Sc2 when k=1). Here, since the data indicating the detection results includes “beam ID #13” and “beam ID #25,” the beam search execution determination unit 16 determines that candidate beam IDs are included in the received data indicating the detection results (Yes in step Sc2 when k=1).

The beam search execution determination unit 16 outputs a partial beam search request signal including “distributed antenna ID #1,” “beam ID #13,” and “beam ID #25” to the beam search execution instruction unit 11 in order to cause the distributed antenna device 30-1 including the first distributed antenna 31-1 to perform partial beam search. After outputting the partial beam search request signal to the beam search execution instruction unit 11, the beam search execution determination unit 16 starts an internal feedback signal timer. When starting the feedback signal timer, the beam search execution determination unit 16 sets the same time as that set in the feedback signal timer by the beam combination history generation unit 13 in the processing of step Sa1 in FIG. 9.

The beam search execution instruction unit 11 receives the partial beam search request signal output by the beam search execution determination unit 16, and reads “distributed antenna ID #1,” “beam ID #13,” and “beam ID #25” included in the partial beam search request signal. The beam search execution instruction unit 11 generates a beam search instruction signal including “distributed antenna ID #1” and “beam ID #13” and a beam search instruction signal including “distributed antenna ID #1” and “beam ID #25.” The beam search execution instruction unit 11 outputs the two generated beam search instruction signals one by one to the digital signal processing device 20 at predetermined fixed time intervals in the order of generation. The digital signal processing device 20 sequentially receives the two beam search instruction signals output by the beam search execution instruction unit 11. Thereafter, processing after the digital signal processing device 20 receives the beam search instruction signals is performed by the digital signal processing device 20, the main device 32-1, the distributed antenna 31-1, and the terminal device 40a with i=1 in the processing of step Sa1 in FIG. 9 (step Sc7 when k=1).

The beam search execution determination unit 16 determines whether a feedback signal including “distributed antenna ID #1,” which is the distributed antenna ID of the first distributed antenna 31-1, as the source antenna ID has been received before the feedback signal timer expires (step Sc8).

For example, it is assumed that any of the above-mentioned events in cases where the beam combination history generation unit 13 cannot receive the feedback signal has occurred. In this case, the beam search execution determination unit 16 determines that the feedback signal including “distributed antenna ID #1,” which is the distributed antenna ID of the first distributed antenna 31-1, as the source antenna ID has not been received before the feedback signal timer expires (No in step Sc8 when k=1), and processing proceeds to step Sc3.

On the other hand, it is assumed that any of the above-described events in cases where the beam combination history generation unit 13 cannot receive the feedback signal has not occurred, and the feedback signal receiving unit 12 outputs the feedback signal to the beam search execution determination unit 16. In this case, the beam search execution determination unit 16 determines that the feedback signal including “distributed antenna ID #1,” which is the distributed antenna ID of the first distributed antenna 31-1, as the source antenna ID has been received before the feedback signal timer expires (Yes in step Sc8 when k=1).

In this case, the beam search execution determination unit 16 determines whether the reception power value included in the feedback signal exceeds a predetermined threshold (step Sc9 when k=1). When the beam search execution determination unit 16 determines that the reception power value included in the feedback signal does not exceed the predetermined threshold (No in step Sc9 when k=1), the processing proceeds to step Sc3. On the other hand, if the beam search execution determination unit 16 determines that the reception power value included in the feedback signal exceeds the predetermined threshold (Yes in step Sc9 when k=1), processing proceeds to step Sc5.

In other words, regarding the processing of steps Sc7, Sc8, and Sc9, the beam search execution determination unit 16 causes the distributed antenna device 30-1 corresponding to “distributed antenna ID #1” to perform partial beam search for transmitting a beam corresponding to “beam ID #13” and a beam corresponding to “beam ID #25.” If no feedback signal is obtained by the partial beam search, the beam search execution determination unit 16 advances the processing to step Sc3 and causes the distributed antenna device 30-1 corresponding to “distributed antenna ID #1” to perform all-beam search to search for the best beam for the distributed antenna device 30-1 again. In the all-beam search in this case, the beam search execution determination unit 16 searches for only the beam corresponding to the “beam ID #13” and the beam other than the beam corresponding to the “beam ID #25”.

Then, when a feedback signal in which “distributed antenna ID #1” is included as a source antenna ID is captured before a feedback signal timer expires in step SC4, a beam search execution determination unit 16 advances processing to step SC5, the beam ID included in the feedback signal is defined as data to be added to the beam combination history table 140.

On the other hand, if a feedback signal according to the partial beam search is obtained, when the reception power value included in the feedback signal, that is, the reception power value of the beam selected as the best beam for the terminal device 40a, does not exceed the threshold, the beam search execution determination unit 16 determines that the beam indicated by the feedback signal is an inappropriate beam that cannot be used for normal operation. Therefore, the beam search execution determination unit 16 advances the processing to step Sc3 and causes the distributed antenna device 30-1 corresponding to “distributed antenna ID #1” to perform all-beam search to search for the best beam for the distributed antenna device 30-1 again. In the all-beam search in this case, the beam search execution determination unit 16 searches for only the beam corresponding to the “beam ID #13” and the beam other than the beam corresponding to the “beam ID #25”.

Then, when a feedback signal in which “distributed antenna ID #1” is included as a source antenna ID is captured before a feedback signal timer expires in step SC4, a beam search execution determination unit 16 advances processing to step SC5, the beam ID included in the feedback signal is defined as data to be added to the beam combination history table 140.

On the other hand, when the reception power value included in the feedback signal exceeds the threshold, the beam search execution determination unit 16 advances the processing to step Sc5 to determine that the beam is the best beam for the distributed antenna device 30-1. In this case, since the beam search execution determination unit 16 can determine that the beam is an appropriate beam that can be used for normal operation without performing an all-beam search for the distributed antenna device 30-1, the number of beam searches can be reduced. By proceeding to step Sc5, the beam search execution determination unit 16 sets data regarding the beam as data to be added to the beam combination history table 140.

If there is a value that has never been selected among possible values (here, “1,” “3,” and “4”) of the variable k at that time, the candidate beam detection unit 15f selects the value that has never been selected, and processing of steps Sh4 to Sh6 is performed again (loop Lh2s to Lh2e). Here, since “3” (and “4”) among the possible values (here, “1,” “3,” and “4”) of the variable k has not been selected yet, the candidate beam detection unit 15f sets “3” as a new value of k.

The candidate beam detection unit 15f performs the following processing when k=3. That is, the candidate beam detection unit 15f detects the beam of the third distributed antenna device 30-3, which has been selected together with the detection reference beam, as a candidate beam from the beam combination history table 140. Here, the detection reference beam is a beam identified by “beam ID #33” of “distributed antenna ID #2”. In the beam combination history table 140, “beam ID #33” of “distributed antenna ID #2” corresponding to the detection reference beam is included in “record ID #2,” “record ID #4,” and “record ID #6,” but the “distributed antenna ID #3” items of “record ID #2,” “record ID #4,” and “record ID #6” are blank. Therefore, the candidate beam detection unit 15f outputs detection results that there is no candidate beam ID indicating a candidate beam that is a beam of the third distributed antenna device 30-3 and has been selected together with the detection reference beam. The candidate beam detection unit 15f generates data indicating the detection results including only “distributed antenna ID #3” (step Sj4 when k=3).

The candidate beam detection unit 15f outputs data indicating the detection results including only “distributed antenna ID #3” to the beam search execution determination unit 16 (step Sj5 when k=3). Upon receiving the data indicating the detection results from the candidate beam detection unit 15f, the beam search execution determination unit 16 starts a subroutine for all-beam search execution determination processing shown in FIG. 11 (step Sj6 when k=3).

When the candidate beam detection unit 15f receives the termination notification signal output from the beam search execution determination unit 16, if there is a value that has never been selected among the possible values (here, “1,” “3,” and “4”) of the variable k at that time, the candidate beam detection unit 15f selects the value that has never been selected, and processing of steps Sj4 to Sj6 is performed again (loop Lj2s to Lj2e).

When the candidate beam detection unit 15f receives the termination notification signal output from the beam search execution determination unit 16, if there is no value that has never been selected among the possible values (here, “1,” “3,” and “4”) of the variable k at that time, the candidate beam detection unit 15f ends processing of loop Lh2s to Lh2e and advances the processing to step Sj7.

Here, since “4” among the possible values (here, “1,” “3,” and “4”) has not been selected yet, the candidate beam detection unit 15f sets “4” as a new value of k. The candidate beam detection unit 15f performs the following processing when k=4. That is, the candidate beam detection unit 15f detects the beam ID of the beam of the fourth distributed antenna device 30-4, which has been selected together with the detection reference beam, from the beam combination history table 140. Here, the detection reference beam is a beam identified by “beam ID #33” of “distributed antenna ID #2”. In the beam combination history table 140, “beam ID #33” of “distributed antenna ID #2” corresponding to the detection reference beam is included in “record ID #2,” “record ID #4,” and “record ID #6.” “Beam ID #15,” and “beam ID #16,” and “beam ID #15” are written in “distributed antenna ID #4” item of “record ID #2,” “record ID #4,” and “record ID #6.”

Therefore, the candidate beam detection unit 15f detects “beam ID #15” and “beam ID #16” as beam IDs of beams of the fourth distributed antenna device 30-4, which have been selected together with the detection reference beam, from the beam combination history table 140. The candidate beam detection unit 15f sets “beam ID #15” and “beam ID #16” as candidate beam IDs indicating candidate beams of the distributed antenna device 30-4 corresponding to “distributed antenna ID #4.” The candidate beam detection unit 15f generates data indicating detection results including “distributed antenna ID #4”, and “beam ID #15” and “beam ID #16” which are candidate beam IDs (step Sj4 when k=4). The candidate beam detection unit 15f outputs the generated data indicating the detection results to the beam search execution determination unit 16 (step Sj5 when k=4). Upon receiving the data indicating the detection results from the candidate beam detection unit 15f, the beam search execution determination unit 16 starts a subroutine for all-beam search execution determination processing shown in FIG. 11 (step Sj6 when k=4).

The beam search execution determination unit 16 receives the data indicating the detection results output by the candidate beam detection unit 15f (step Sc1 when k=4). The beam search execution determination unit 16 determines whether the candidate beam ID is included in the received data indicating the detection results (step Sc2 when k=4). Here, since the data indicating the detection results includes “beam ID #15” and “beam ID #16,” the beam search execution determination unit 16 determines that candidate beam IDs are included in the data indicating the received detection results (Yes in step Sc2 when k=4).

The beam search execution determination unit 16 outputs a partial beam search request signal including “distributed antenna ID #4,” “beam ID #15,” and “beam ID #16” to the beam search execution instruction unit 11 in order to cause the distributed antenna device 30-4 including the fourth distributed antenna 31-4 to perform a partial beam search for the candidate beam IDs. After outputting the partial beam search request signal to the beam search execution instruction unit 11, the beam search execution determination unit 16 starts an internal feedback signal timer. When starting the feedback signal timer, the beam search execution determination unit 16 sets the same time as that set in the feedback signal timer by the beam combination history generation unit 13 in the processing of step Sa1 in FIG. 9.

The beam search execution instruction unit 11 receives the partial beam search request signal output by the beam search execution determination unit 16, and reads “distributed antenna ID #4,” “beam ID #15,” and “beam ID #16” included in the partial beam search request signal. The beam search execution instruction unit 11 generates a beam search instruction signal including “distributed antenna ID #4” and “beam ID #15,” and a beam search instruction signal including “distributed antenna ID #4” and “beam ID #16.” The beam search execution instruction unit 11 outputs the two generated beam search instruction signals one by one to the digital signal processing device 20 at predetermined fixed time intervals in the order of generation. The digital signal processing device 20 sequentially receives the two beam search instruction signals output by the beam search execution instruction unit 11. Thereafter, processing after the digital signal processing device 20 receives the beam search instruction signals is performed by the digital signal processing device 20, the main device 32-4, the distributed antenna 31-4, and the terminal device 40a with i=4 in the processing of step Sa1 in FIG. 9 (step Sc7 when k=4).

The beam search execution determination unit 16 determines whether a feedback signal including “distributed antenna ID #4” which is the distributed antenna ID of the fourth distributed antenna 31-4 as a source antenna ID has been received before the feedback signal timer expires (step Sc8).

For example, it is assumed that any of the above-mentioned events in cases where the beam combination history generation unit 13 cannot receive the feedback signal has occurred. In this case, the beam search execution determination unit 16 determines that the feedback signal including “distributed antenna ID #4” which is the distributed antenna ID of the fourth distributed antenna 31-4 as a source antenna ID has not been received before the feedback signal timer expires (No in step Sc8 when k=4), and the processing proceeds to step Sc3.

On the other hand, it is assumed that any of the above-described events in cases where the beam combination history generation unit 13 cannot receive the feedback signal has not occurred, and the feedback signal receiving unit 12 outputs the feedback signal to the beam search execution determination unit 16. In this case, the beam search execution determination unit 16 determines that the feedback signal including “distributed antenna ID #4” which is the distributed antenna ID of the fourth distributed antenna 31-4 as a source antenna ID has been received before the feedback signal timer expires (Yes in step Sc8 when k=4).

In this case, the beam search execution determination unit 16 determines whether the reception power value included in the feedback signal exceeds a predetermined threshold (step Sc9 when k=4). When the beam search execution determination unit 16 determines that the reception power value included in the feedback signal does not exceed a predetermined threshold (step Sc9 when k=4, No), the processing proceeds to step Sc3. On the other hand, if the beam search execution determination unit 16 determines that the reception power value included in the feedback signal exceeds the predetermined threshold (Yes in step Sc9 when k=4), processing proceeds to step Sc5.

To put it another way about the processing of steps Sc7, Sc8, and Sc9, the beam search execution determination unit 16 performs a partial beam search to cause the distributed antenna device 30-4 corresponding to “distributed antenna ID #4” to transmit a beam corresponding to “beam ID #15” and a beam corresponding to “beam ID #16”. If no feedback signal is obtained according to the partial beam search, the beam search execution determination unit 16 advances the processing to step Sc3 and causes the distributed antenna device 30-4 corresponding to “distributed antenna ID #4” to perform an all-beam search to search for the best beam for the distributed antenna device 30-4 again. In the all-beam search in this case, the beam search execution determination unit 16 searches for only beams other than the beam corresponding to the “beam ID #15” and the beam corresponding to “beam ID #26.”

Then, in a case where a feedback signal in which “distributed antenna ID #4” is included as a source antenna ID is received before a feedback signal timer expires in step Sc4, the beam search execution determination unit 16 advances the processing to step Sc5 to set the beam ID included in the feedback signal as a target data to be added to the beam combination history table 140.

On the other hand, if a feedback signal according to the partial beam search is obtained, when the reception power value included in the feedback signal, that is, the reception power value of the beam selected as the best beam for the terminal device 40a, does not exceed the threshold, the beam search execution determination unit 16 determines that the beam indicated by the feedback signal is an inappropriate beam that cannot be used for normal operation. Therefore, the beam search execution determination unit 16 advances the processing to step Sc3 and causes the distributed antenna device 30-4 corresponding to “distributed antenna ID #4” to perform an all-beam search to search for the best beam for the distributed antenna device 30-4 again. In the all-beam search in this case, the beam search execution determination unit 16 searches for only beams other than the beam corresponding to the “beam ID #15” and the beam corresponding to “beam ID #26.”

Then, in a case where a feedback signal in which “distributed antenna ID #4” is included as a source antenna ID is received before a feedback signal timer expires in step Sc4, the beam search execution determination unit 16 advances the processing to step Sc5 to set the beam ID included in the feedback signal as a target data to be added to the beam combination history table 140.

On the other hand, when the reception power value included in the feedback signal exceeds the threshold, the beam search execution determination unit 16 advances the processing to step Sc5 to determine that the beam is the best beam for the distributed antenna device 30-4. In this case, since the beam search execution determination unit 16 can determine that the beam is an appropriate beam that can be used for normal operation without performing an all-beam search for the distributed antenna device 30-4, the number of beam searches can be reduced.

Referring back to FIG. 26, when the candidate beam detection unit 15f receives the termination notification signal output from the beam search execution determination unit 16, if there is a value that has never been selected among the possible values (here, “1,” “3,” and “4” of the variable k at that time, the candidate beam detection unit 15f selects the value that has never been selected, and the processing of steps Sj4 to Sj6 is performed again (loop Lj2s to Lj2e). Here, since there are no other value which have never been selected among the possible values of the variable k at that time, the processing of loop Lj2s to Lj2e ends and the processing proceeds to processing of the step Sj7.

The beam combination recording unit 17 removes the reception power value from one set of data received in the processing of step Sj3 and the processing of step Sc5, that is, the data that is a combination of the source antenna ID, beam ID, and reception power value, and generates one record in the beam combination history table 140 on the basis of the remaining data. That is, the beam combination recording unit 17 generates a new row in the beam combination history table 140, thereby generating “record ID #M+1” as a new record ID. The beam combination recording unit 17 writes “record ID #M+1” which is the generated new record ID in the “record ID” item of the generated new row. The beam combination recording unit 17 writes corresponding beam IDs in elements of “distributed antenna ID #1,” “distributed antenna ID #2,” “distributed antenna ID #3,” and “distributed antenna ID #4” in the row of “record ID #M+1” on the basis of the combination of the source antenna ID and the beam ID (step Sj7).

### (Configuration of Terminal Device of Seventh Embodiment)

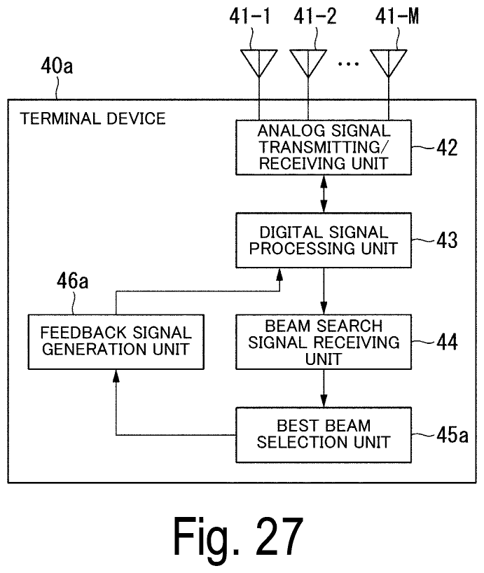

FIG. 27 is a block diagram showing a configuration of the terminal device 40a. The terminal device in the eighth embodiment which will be described later is the same as the terminal device 40a described below.

The terminal device 40a includes M terminal antennas 41-1 to 41-M, an analog signal transmitting/receiving unit 42, a digital signal processing unit 43, a beam search signal receiving unit 44, a best beam selection unit 45a, and a feedback signal generation unit 46a. Here, M is an integer of 2 or more. Wireless communication using distributed MIMO is performed between the terminal antennas 41-1 to 41-M and distributed antennas 31-1 to 31-4 included in the distributed antenna devices 30-1 to 30-4.

The analog signal transmitting/receiving unit 42 generates a radio-frequency analog signal by modulating carrier waves on the basis of a digital signal of transmission data output by the digital signal processing unit 43. The analog signal transmitting/receiving unit 42 transmits the generated analog signal using radio waves through the terminal antennas 41-1 to 41-M. The analog signal transmitting/receiving unit 42 demodulates analog signals output by the terminal antennas 41-1 to 41-M receiving radio waves and converts them into digital signals. The analog signal transmitting/receiving unit 42 outputs the converted digital signals to the digital signal processing unit 43. The analog signal transmitting/receiving unit 42 measures reception powers of beams received by the terminal antennas 41-1 to 41-M. The analog signal transmitting/receiving unit 42 associates reception power values obtained through the measurement with a digital signal corresponding to a beam to be measured, and outputs it to the digital signal processing unit 43.

The digital signal processing unit 43 outputs a digital signal of a feedback signal output by the feedback signal generation unit 46a to the analog signal transmitting/receiving unit 42. The digital signal processing unit 43 receives the digital signal output from the analog signal transmitting/receiving unit 42 and the reception power value associated with the digital signal. The digital signal processing unit 43 associates the received reception power value with the beam search signal included as reception data in the received digital signal, and outputs it to the beam search signal receiving unit 44.

The beam search signal receiving unit 44 receives the beam search signal output by the digital signal processing unit 43 and the reception power value associated with the beam search signal. The beam search signal receiving unit 44 combines the beam ID included in the received beam search signal and the received reception power value, and writes and stores the combination in an internal storage area as a set of data. When all beam search signals are received, the beam search signal receiving unit 44 reads all data stored in the internal storage area. The beam search signal receiving unit 44 outputs all the read data to the best beam selection unit 45a as one set of data.

The best beam selection unit 45a receives the one set of data output by the beam search signal receiving unit 44. The best beam selection unit 45a selects data corresponding to the maximum reception power value from among the received one set of data. In other words, the best beam selection unit 45a selects the beam indicated by the beam ID corresponding to the selected maximum reception power value as the best beam. The best beam selection unit 45a outputs the beam ID and the reception power value included in the selected data to the feedback signal generation unit 46a. The feedback signal generation unit 46a generates a feedback signal including the beam ID and the reception power value output by the best beam selection unit 45a. The feedback signal generation unit 46a outputs the generated feedback signal to the digital signal processing unit 43.

### (Processing Performed by Terminal Device of Seventh Embodiment)

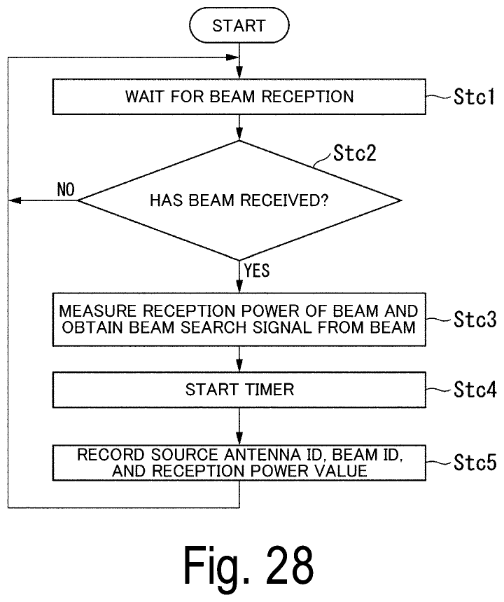

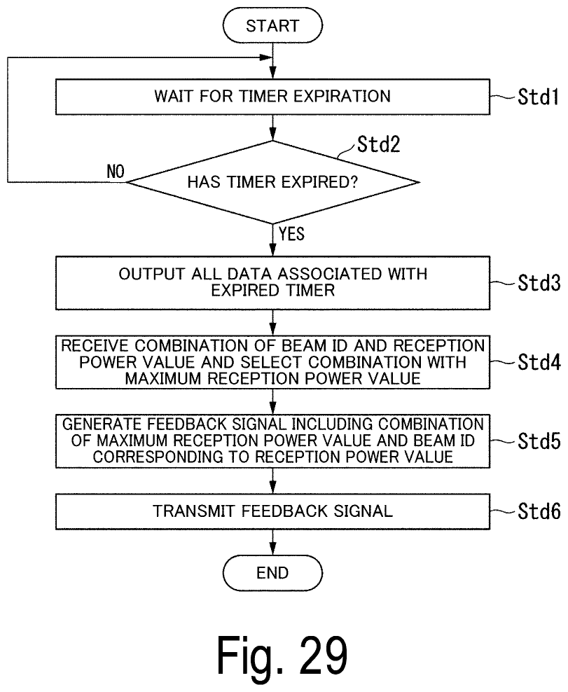

Processing performed by the terminal device 40a will be described with reference to FIGS. 28 and 29. FIG. 28 is a flowchart showing a flow of processing performed when the terminal device 40a receives beams transmitted by the distributed antenna devices 30-1 to 30-4.

The analog signal transmitting/receiving unit 42 waits for reception of beams transmitted by the distributed antennas 31-1 to 31-4 of the distributed antenna devices 30-1 to 30-4 (step Stc1), and repeatedly determines whether beams have been received through the terminal antennas 41-1 to 41-M (step Stc2). If the analog signal transmitting/receiving unit 42 determines that no beam has been received (No in step Stc2), the analog signal transmitting/receiving unit 42 continues to perform the processing of step Stc1, that is, waits for beam reception.

On the other hand, if the analog signal transmitting/receiving unit 42 determines that a beam has been received (Yes in step Stc2), the analog signal transmitting/receiving unit 42 measures the reception power of the beam received through the terminal antennas 41-1 to 41-M. The analog signal transmitting/receiving unit 42 converts the received beam into a digital signal. The analog signal transmitting/receiving unit 42 associates a reception power value obtained through measurement with the digital signal obtained through the conversion, and outputs the digital signal to the digital signal processing unit 43. The digital signal processing unit 43 receives the digital signal output from the analog signal transmitting/receiving unit 42 and the reception power value associated with the digital signal. The digital signal processing unit 43 acquires a beam search signal included in the digital signals as reception data by detecting reception data from the received digital signal. The digital signal processing unit 43 associates the received reception power value with the acquired beam search signal and outputs the beam search signal to the beam search signal receiving unit 44.

The beam search signal receiving unit 44 receives the beam search signal output from digital signal processing unit 43 and the reception power value associated with the beam search signal. The beam search signal receiving unit 44 reads a beam ID included in the received beam search signal (step Stc3).

The beam search signal receiving unit 44 can generate an internal timer, and starts the timer. When starting the timer, the beam search signal receiving unit 44 sets, in the timer, the time required for the distributed antenna devices 30-1 to 30-4 that transmit the largest number of beams to transmit all beams. Note that the time is assumed to be a predetermined time (step Sta4).

The beam search signal receiving unit 44 combines the read beam ID and the received reception power value as one set of data, and writes and stores the one set of data in an internal storage area (step Stc5). Thereafter, processing after step Stc1 is repeated.

FIG. 29 is a flowchart showing a flow of processing performed when the timer started by the beam search signal receiving unit 44 expires. The beam search signal receiving unit 44 waits for the timer started in the processing of step Stc4 in FIG. 28 to expire. It is assumed that the timer outputs a timer expiration notification signal when the time being measured reaches a set time and the timer expires (step Std1).

The beam search signal receiving unit 44 repeatedly determines whether a timer expiration notification has been received (step Std2), and if it is determined that a timer expiration notification is not received (No in step Std2), continuously waits for the processing of step Std1, that is, expiration of the timer. On the other hand, if the beam search signal receiving unit 44 determines that a timer expiration notification has been received (Yes in step Std2), the beam search signal receiving unit 44 erases the timer. The beam search signal receiving unit 44 detects and reads all pieces of data associated with the timer that has expired, that is, data which is a combination of the beam ID and the reception power value, from among data stored in the internal storage area. After reading, the beam search signal receiving unit 44 deletes the read data from the internal storage area. The beam search signal receiving unit 44 outputs all the read data to the best beam selection unit 45a as one set of data (step Std3).

The best beam selection unit 45a receives the one set of data output by the beam search signal receiving unit 44. The best beam selection unit 45a selects data including the maximum reception power value from among the received set of data (step Std4). The best beam selection unit 45a outputs the beam ID and the reception power value included in the selected data to the feedback signal generation unit 46a. The feedback signal generation unit 46a receives the beam ID and the reception power value output by the best beam selection unit 45a, and generates a feedback signal including the received ID and reception power value. The feedback signal generation unit 46a outputs the generated feedback signal to the digital signal processing unit 43 (step Std5).

In the seventh embodiment, the feedback signal generation unit 46 does not necessarily include a received power value in a feedback signal. The feedback signal generation unit 46 may generate a feedback signal including a received source antenna ID and beam ID.

The digital signal processing unit 43 receives the feedback signal output from the feedback signal generation unit 46a. The digital signal processing unit 43 outputs the received feedback signal to the analog signal transmitting/receiving unit 42. The analog signal transmitting/receiving unit 42 generates a radio-frequency analog signal from the feedback signal output by the digital signal processing unit 43. The analog signal transmitting/receiving unit 42 transmits the generated analog signal using radio waves through the terminal antennas 41-1 to 41-M (step Std6).

In the wireless communication system 1f of the seventh embodiment, the candidate beam detection unit 15f simultaneously performs all-beam searches for transmitting a beam search signal including the same beam ID using all of a plurality of distributed antenna devices in a beam search period in which a beam used for wireless communication with the terminal device 40a is searched for, and receives a feedback signal by all the antenna devices. The wireless communication system 1f stops the all-beam searches when one beam identifier indicating the best beam among beams according to the all-beam searches included in the feedback signal has been acquired, and sets a beam identified by the acquired beam identifier and information indicating distributed antennas 31-1 to 31-4 whose reception quality (for example, reception power) of the feedback signal is the best. The wireless communication system 1f detects a beam identifier of a beam which is a beam identifier of a distributed antenna other than the best distributed antennas having the detection reference beam and has been selected together with the detection reference beam from the beam combination history storage unit 14 as a candidate beam identifier for the distributed antennas 31-1 to 31-4.

The beam search execution determination unit 16 determines whether to cause the distributed antennas 31-1 to 31-4 that have not performed the all-beam search in the beam search period to perform the all-beam search on the basis of detection results from the candidate beam detection unit 15f. The beam combination recording unit 17 generates a record indicating a combination of beam identifiers indicating beams determined to be the best beams for the distributed antennas in the beam search period. The beam combination recording unit 17 records the generated record in the beam combination history storage unit 14. As a result, in beam combination generation processing performed by the beam combination history generation unit 13, even when it is not possible to generate sufficient records indicating a history of beam combinations while moving the terminal device 40a little by little at intervals that do not reduce the transmission capacity throughout the cell 100 in the service providing area, an effect that it is possible to accumulate a sufficiently large number of records to reduce the number of beam searches without reducing the transmission capacity is obtained when performing beam search processing.

### Eighth Embodiment

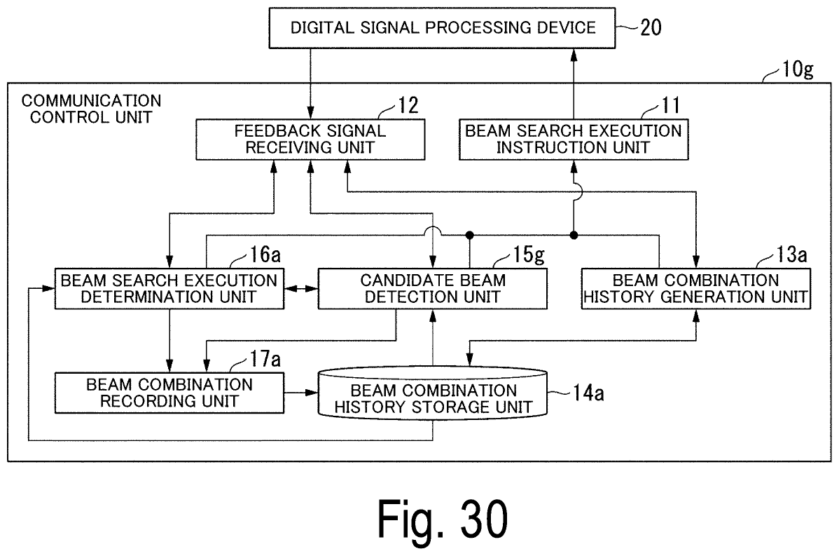

FIG. 30 is a block diagram showing a configuration of a communication control device 10g in the eighth embodiment. The communication control device 10g is a device used in place of the communication control device 10a of the second embodiment, and for convenience of description, the wireless communication system 1a including the communication control device 10g instead of the communication control device 10a will be referred to as a wireless communication system 1g below. In the communication control device 10e, the same components as whose of the communication control device 10a of the second embodiment are denoted by the same reference numerals, and different components will be described below.

The configurations of the wireless communication system 1g in the eighth embodiment differs from the configuration of the wireless communication system 1a in the second embodiment in that all-beam searches are simultaneously performed using all of a plurality of distributed antenna devices instead of performing all-beam searches one by one in a fixed order for the plurality of distributed antenna devices at the first stage of beam search processing.

The communication control device 10g includes a beam search execution instruction unit 11, a feedback signal receiving unit 12, a beam combination history generation unit 13a, a beam combination history storage unit 14a, a candidate beam detection unit 15g, a beam search execution determination unit 16a, and a beam combination recording unit 17a.

When beam search processing for searching for a beam is started, the candidate beam detection unit 15g causes all of N distributed antenna devices 30-1 to 30-N to simultaneously perform all-beam searches. At this time, the candidate beam detection unit 15g outputs an all-beam search request signal for causing all the N distributed antenna devices 30-1 to 30-N to transmit beam search signals including the same beam ID to the beam search execution instruction unit 11. Here, the candidate beam detection unit 15g outputs the all-beam search request signal to the beam search execution instruction unit 11 such that beams including the same beam ID are simultaneously transmitted from all of four (N=4) distributed antenna devices 30-1 to 30-4.

The candidate beam detection unit 15g stops all-beam searches when first feedback signals are received from all distributed antenna devices (the distributed antenna devices 30-1 to 30-4 here since N=4) after beam search processing is started.

Similarly to the seventh embodiment, the eighth embodiment differs from the above-described embodiments in that a beam ID is included in a feedback signal but a distributed antenna ID is not included therein. This is because a beam ID that is information for identifying a beam used for transmission can be included in a beam search signal since the beam search signal including the same beam ID is simultaneously transmitted from all distributed antenna devices to the terminal device 40a which will be described later in the wireless communication system 1g in the eighth embodiment, but a distributed antenna ID for identifying a distributed antenna device used for transmission cannot be included.

Therefore, in the wireless communication system 1g in an eighth embodiment, a feedback signal transmitted from the terminal device 40a is received by each distributed antenna device (here, distributed antenna devices 30-1 to 30-4), reception quality of the feedback signal (for example, reception power) is measured for each distributed antenna device, and which distributed antenna device is best for wireless communication with the terminal device 40a is determined.

In the wireless communication system 1g in the eighth embodiment, since the same beam search signal is simultaneously transmitted from a plurality of distributed antenna devices, a delay wave in a range such as a general guard interval can be received without interference when the beam search signal is received by the terminal device 40a. However, with such a configuration, in the wireless communication system 1g in the eighth embodiment, the best distributed antenna cannot be determined and only the best beam can be determined on the side of the terminal device 40a. Therefore, in the wireless communication system 1g in the eighth embodiment, a feedback signal transmitted from the terminal device 40a is received by a plurality of distributed antennas, and a distributed antenna having the best reception quality (e.g., the maximum reception power) is determined as the best antenna.

The candidate beam detection unit 15g reads the beam ID included in the feedback signal transmitted from the terminal device 40a. The candidate beam detection unit 15g measures the reception power of the feedback signal and identifies the distributed antenna device having the maximum reception power. The candidate beam detection unit 15g sets a beam identified by the distributed antenna ID indicating the identified distributed antenna device and the beam ID read from the feedback signal as a detection reference beam.

The candidate beam detection unit 15g detects, from the beam combination history table 140a shown in FIG. 14, for example, beam IDs of distributed antenna devices 30-1 to 30-4 that have not performed the all-beam search during a beam search period, the beam IDs corresponding to beams that have been selected together with the detection reference beam, and distributed antenna IDs corresponding to the beam IDs. In such a case, the candidate beam detection unit 15g detects a reception power value written as an element together with the detected beam IDs in the beam combination history table 140a. The candidate beam detection unit 15g uses the detected beam IDs as candidate beam IDs indicating candidate beams in the distributed antenna devices 30-1 to 30-4 corresponding to the detected distributed antenna IDs and outputs a combination of the detected distributed antenna IDs and candidate beam IDs as detection results. The candidate beam detection unit 15g calculates the average values of the reception power values for each beam ID based on the combination of the detected beam ID and the detected reception power value, and sets the maximum value of the calculated average values as the average reception power value for the detected distributed antenna ID. The candidate beam detection unit 15g includes the calculated average reception power value in the data indicating the detection results.

### (Processing Performed by Wireless Communication System of Eighth Embodiment)

Similarly to the second embodiment, in the wireless communication system 1g of the eighth embodiment, the beam combination generation processing in step S1 and the beam search processing in step S2, shown in FIG. 8, are also performed. However, the beam search processing performed in the eighth embodiment differ from the processing performed in the second embodiment with respect to the points described below.

### (Beam Combination Generation Processing of Eighth Embodiment)

The same beam combination generation processing as that in the first embodiment shown in FIG. 9 is performed by the beam search execution instruction unit 11, the feedback signal receiving unit 12, the beam combination history generation unit 13a, the digital signal processing device 20, and the distributed antenna devices 30-1 to 30-4.

### (Beam Search Processing of Eighth Embodiment)

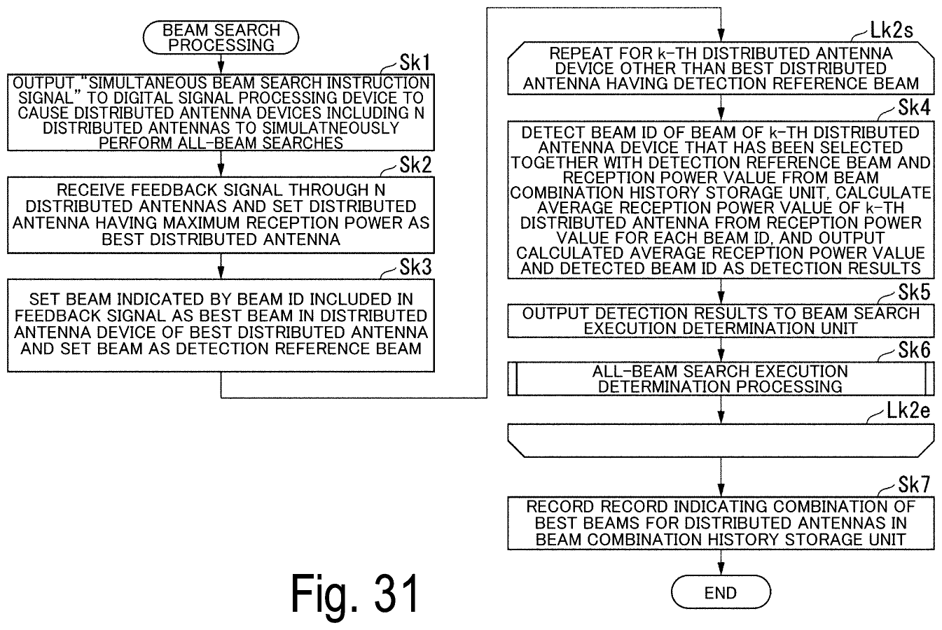

FIG. 31 is a flowchart showing a flow of beam search processing of the eighth embodiment. FIG. 31 is a flowchart showing the flow of the beam search processing performed in the processing of step S2 in FIG. 8.

In processing of steps Sk1 to Sk3, the above-described processing is performed by the candidate beam detection unit 15g. In processing of steps Sk4 to Sk6, processing of loop Lk2s to Lk2e for repeating the processing of steps Sk4 to Sk6, and processing of step Sk7, the same processing as the processing of step Sb3, the processing of steps Sb4 to Sb6, the processing of loop Lb2s to Lb2e for repeating the processing of steps Sb4 to Sb6, and the processing of step Sb7 in FIG. 10 is performed by the beam search execution instruction unit 11, the feedback signal receiving unit 12, the beam combination recording unit 17a, the digital signal processing device 20, and the distributed antenna devices 30-1 to 30-4, and the processing performed by the candidate beam detection unit 15a is performed by the candidate beam detection unit 15g.

In response to an operation of the operator of the wireless communication system 1g, the candidate beam detection unit 15g of the communication control device 10g starts beam search processing. The candidate beam detection unit 15g starts an internal beam search cycle timer. When starting the beam search cycle timer, the candidate beam detection unit 15g sets a time indicating the duration of one predetermined beam search cycle.

The candidate beam detection unit 15g reads all distributed antenna IDs written in the distributed antenna ID item of the beam combination history table 140a stored in the beam combination history storage unit 14a. The candidate beam detection unit 15g provides a variable i in an internal storage area thereof. Here, although i is a variable that is an integer value from 1 to N, the wireless communication system 1 in FIG. 1 includes four distributed antenna devices 30-1 to 30-4, and the candidate beam detection unit 15g reads four distributed antenna IDs, “distributed antenna ID #1,” “distributed antenna ID #2,” “distributed antenna ID #3,” and “distributed antenna ID #4” from the beam combination history table 140, and thus it is assumed that N=4 in the following description. The following description will be made assuming that the i-th distributed antenna device is a distributed antenna device 30-i, the i-th distributed antenna is a distributed antenna 31-i, and the i-th main device is a main device 32-i.

The candidate beam detection unit 15g outputs an output destination switching instruction signal for setting an output destination to the candidate beam detection unit 15g to the feedback signal receiving unit 12. Upon receiving the output destination switching instruction signal for setting the output destination to the candidate beam detection unit 15g from the candidate beam detection unit 15g, the feedback signal receiving unit 12 sets the candidate beam detection unit 15g as the output destination of the feedback signal.

The candidate beam detection unit 15g selects all values of 1 to N (here, N=4) as values of the variable i. The candidate beam detection unit 15g outputs an all-beam search request signal including “distributed antenna ID #1” which is a distributed antenna ID given to the first distributed antenna 31-1, “distributed antenna ID #2” which is a distributed antenna ID given to the second distributed antenna 31-2, “distributed antenna ID #3” which is a distributed antenna ID given to the third distributed antenna 31-3, and “distributed antenna ID #4” which is a distributed antenna ID given to the fourth distributed antenna 31-4 to the beam search execution instruction unit 11 in order to cause the distributed antenna device 30-1 including the first distributed antenna 31-1, the distributed antenna device 30-2 including the second distributed antenna 31-2, the distributed antenna device 30-3 including the third distributed antenna 31-3, and the distributed antenna device 30-4 including the fourth distributed antenna 31-4 to perform all-beam searches for transmitting beam search signals including the same beam ID.

After outputting the all-beam search request signal to the beam search execution instruction unit 11, the candidate beam detection unit 15g starts an internal feedback signal timer. When starting the feedback signal timer, the candidate beam detection unit 15g sets the same time as that set in the feedback signal timer by the beam combination history generation unit 13 in the processing of step Sa1 in FIG. 9. Note that the time is a predetermined time and is set in the candidate beam detection unit 15g in advance.

The beam search execution instruction unit 11 reads a beam ID maximum value from the beam count table 110 in the internal storage area. Here, as an example, it is assumed that the beam search execution instruction unit 11 reads “40” as the beam ID maximum value. The beam search execution instruction unit 11 generates a number of beam search instruction signals corresponding to the read beam ID maximum value, that is, “40,” which are simultaneous beam search instruction signals each including one beam ID between 1 and the beam ID maximum value such that the beam IDs included therein are all different beam IDs.

As described above, the simultaneous beam search instruction signal mentioned here is an instruction signal for simultaneously transmitting beam search signals including the same beam ID from a plurality of distributed antenna devices to the terminal device 40a, and returning a feedback signal indicating the best beam ID to the terminal device 40a. The beam search execution instruction unit 11 outputs the 40 generated beam search instruction signals one by one to the digital signal processing device 20 at predetermined fixed time intervals in the order of generation (step Sk1).

The digital signal processing device 20 sequentially receives the 40 beam search instruction signals output from the beam search execution instruction unit 11. The digital signal processing device 20 generates beam search signals from the received beam search instruction signals. The digital signal processing device 20 outputs the generated beam search signals to all main devices 32-i (i=1 to N) in the order of generation, respectively. The respective main devices 32-i (i=1 to N) receive the beam search signals output from the digital signal processing device 20. Each main device 32-i (i=1 to N) modulates a carrier wave on the basis of the beam search signal to form a beam in a direction corresponding to the beam ID included in the received beam search signal. Each main device 32-i (i=1 to N) generates a radio-frequency analog signal carrying the beam search signal generated by modulation. Each main device 32-i (i=1 to N) outputs the generated radio-frequency analog signal to the i-th distributed antenna 31-i (i−1 to N), whereby all distributed antennas 31-i (i=1 to N) transmit beams carrying the beam search signal in the direction of the beam ID included in the beam search signal.

The terminal device 40a receives all beams transmitted by the distributed antennas 31-i (i=1 to N). The terminal device 40 performs processing which will be described later on each of the received beams, and transmits a feedback signal including a beam ID indicating the best beam to all the distributed antennas 31-I (i=1 to N). Each distributed antenna 31-i (i=1 to N) receives radio waves carrying the feedback signal transmitted by the terminal device 40a. Each distributed antenna 31-i (i=1 to N) outputs the received radio waves as an analog signal to each main device 32-i (i=1 to N). Each main device 32-i (i=1 to N) converts the analog signal including the feedback signal into a digital signal and outputs the digital signal to the digital signal processing device 20. The digital signal processing device 20 detects and acquires the feedback signal included in the digital signal output by each main device 32-i (i=1 to N). The digital signal processing device 20 outputs the acquired feedback signal to the feedback signal receiving unit 12 of the communication control device 10g. The feedback signal receiving unit 12 receives the feedback signal output by the digital signal processing device 20, and outputs the received feedback signal to the candidate beam detection unit 15g set as an output destination.

The candidate beam detection unit 15g receives the feedback signal transmitted from the terminal device 40a and received by each distributed antenna 31-i (i=1 to N). The candidate beam detection unit 15g reads the beam ID included in the received feedback signal. Further, the candidate beam detection unit 15g measures the reception power of the feedback signal and identifies a distributed antenna having the maximum reception power as the best distributed antenna (step Sk2). In addition, the candidate beam detection unit 15g defines a beam identified by the beam ID read from the feedback signal as the best beam in the distributed antenna device having the best distributed antenna and sets it as a detection reference beam (step Sk3).

Here, it is assumed that the distributed antenna device having the maximum reception power is the second distributed antenna 31-2. The distributed antenna ID of the second distributed antenna 31-2 is “distributed antenna ID #2.” Here, it is assumed that the beam ID included in the feedback signal received by the candidate beam detection unit 15g is “beam ID #33.”

The candidate beam detection unit 15g outputs an output destination switching instruction signal for setting an output destination to the beam search execution determination unit 16a to the feedback signal receiving unit 12a. Upon receiving the output destination switching instruction signal for setting the output destination to the beam search execution determination unit 16a from the candidate beam detection unit 15g, the feedback signal receiving unit 12 sets the output destination of the feedback signal to the beam search execution determination unit 16a (step Sk5).

The candidate beam detection unit 15g performs the following processing when k=1. That is, the candidate beam detection unit 15g detects, from the beam combination history table 140a, the beam ID of the beam of the first distributed antenna device 30-1, which has been selected together with the detection reference beam. Here, the detection reference beam is a beam identified by “beam ID #33” of “distributed antenna ID #2”. In the beam combination history table 140a, “beam ID #33” of “distributed antenna ID #2” corresponding to the detection reference beam is included in “record ID #2,” “record ID #4,” and “record ID #6.” “Beam ID #13” and “beam ID #25” are written in the “distributed antenna ID #1” of “Record ID #2,” “record ID #4,” and “record ID #6.”

Therefore, the candidate beam detection unit 15g detects “beam ID #13” and “beam ID #25” as the beam ID of the beam of the first distributed antenna device 30-1, which has been selected together with the detection reference beam, from the beam combination history table 140a. The candidate beam detection unit 15g sets “beam ID #13” and “beam ID #25” as candidate beam IDs indicating candidate beams of the distributed antenna device 30-1 corresponding to “distributed antenna ID #1.”

The candidate beam detection unit 15g further detects “(reception power value 2-1)” of “record ID #2”, and “(reception power value 6-1)” of “record ID #6” with respect to “beam ID #25” and detects “(reception power value 4-1)” of “record ID #4” with respect to “beam ID #13.” The candidate beam detection unit 15g calculates the average value of “(reception power value 2-1)” and “(reception power value 6-1)” corresponding to “beam ID #25.” Since there is only “(reception power value 4-1)” for “beam ID #13,” “(reception power value 4-1)” is used as the average value. The candidate beam detection unit 15g sets the maximum average value of the average value corresponding to “beam ID #13” and the average value of “beam ID #25” as the average reception power value for “distributed antenna ID #1”. The candidate beam detection unit 15g generates data indicating detection results including “distributed antenna ID #1,” “beam ID #13,” which is a candidate beam ID, “beam ID #25,” and the calculated average reception power value (step Sk4 when k=1). The candidate beam detection unit 15g outputs the generated data indicating the detection results to the beam search execution determination unit 16a (step Sk5 when k=1).

In the processing of step Se1 of the subroutine for all-beam search execution determination processing in FIG. 16, which is performed in the subsequent processing of step Sk6, the beam search execution determination unit 16a receives the detection result data output by the candidate beam detection unit 15g. In the processing of step Se2, the beam search execution determination unit 16a determines that the candidate beam ID is included in the received data indicating the detection results (Yes in step Se2 when k=1).

If the beam search execution determination unit 16a determines “Yes” in the determination processing of step Se8, the beam search execution determination unit 16a reads the average reception power value included in the data indicating the detection results, adds a margin to the read average reception power value, and calculates a threshold for “distributed antenna ID #1” (step Se9). The beam search execution determination unit 16a determines whether the reception power value included in the feedback signal exceeds the threshold calculated for the source antenna ID (here, “distributed antenna ID #1”) included in the feedback signal (step Se10 when k=1).

If the beam search execution determination unit 16a determines that the reception power value included in the feedback signal exceeds the threshold calculated for the source antenna ID included in the feedback signal (Yes in step Se10), then the processing proceeds to step Se5. On the other hand, if the beam search execution determination unit 16a determines that the reception power value included in the feedback signal does not exceed the threshold calculated for the source antenna ID included in the feedback signal (No in step Se10), then the processing proceeds to step Se3.

As a result, in the eighth embodiment, when the beam search execution determination unit 16a determines to cause any of the distributed antenna devices 30-1 to 30-4 to perform a partial beam search, if the reception power value included in the feedback signal acquired through the partial beam search is approximately equal to the past average reception power value of the distributed antenna devices 30-1 to 30-4 for the partial beam search, the beam indicated by the beam ID included in the feedback signal can be searched as the best beam of the distributed antenna devices 30-1 to 30-4 corresponding to the source antenna ID included in the feedback signal. The beam search execution determination unit 16a can add data related to the beam to the beam combination history table 140a.

On the other hand, if the reception power value included in the feedback signal acquired through the partial beam search is not approximately equal to the past average reception power value of the distributed antenna devices 30-1 to 30-4 targeted for the partial beam search, the beam search execution determination unit 16a causes the distributed antenna devices 30-1 to 30-4 corresponding to the source antenna ID included in the feedback signal to perform an all-beam search. If the beam search execution determination unit 16a can acquire a feedback signal through the all-beam search, it is possible to search for the best beam in the distributed antenna devices 30-1 to 30-4 for all-beam search, and if it is not possible to acquire the feedback signal, it is impossible to search for the best beam for the distributed antenna devices 30-1 to 30-4 for all-beam search. Therefore, in the eighth embodiment, it is possible to search for the best beam more accurately than in the first embodiment, the third embodiment, the fifth embodiment, and the seventh embodiment at the time of performing a partial beam search, in addition to the effects obtained by the communication control device 10 of the first embodiment, the communication control device 10b of the third embodiment, the communication control device 10d of the fifth embodiment, and the communication control device 10f of the seventh embodiment.

If there is a value that has never been selected among possible values (here, “1,” “3,” and “4”) of the variable k at that time, the candidate beam detection unit 15g selects the value that has never been selected, and processing of steps Sk4 to Sk6 is performed again (loop Lk2s to Lk2e). Here, since “3” (and “4”) among the possible values (here, “1,” “3,” and “4”) of the variable k has not been selected yet, the candidate beam detection unit 15g sets “3” as a new value of k.

The candidate beam detection unit 15g performs the following processing when k=3. In the processing of loop Lk2s to Lk2e, when k=3, the candidate beam detection unit 15g cannot detect the candidate beam ID corresponding to “distributed antenna ID #3” from the beam combination history table 140a as in the first embodiment, the third embodiment, the fifth embodiment, and the seventh embodiment. Accordingly, in this case, the candidate beam detection unit 15g cannot detect the reception power value. Therefore, the candidate beam detection unit 15g does not calculate the average reception power value and outputs detection results that there is no candidate beam ID indicating a candidate beam which is a beam of the third distributed antenna device 30-3 and has been selected together with the detection reference beam, similarly to the processing of step Sb4 of the first embodiment, step Sd4 of the third embodiment, step Sh4 of the fifth embodiment, and step Sj4 of the seventh embodiment. The candidate beam detection unit 15g generates data indicating the detection results including only “distributed antenna ID #3” (step Sk4 when k=3).

The candidate beam detection unit 15g outputs data indicating the detection results including only “distributed antenna ID #3” to the beam search execution determination unit 16a (step Sk5 when k=3). When the beam search execution determination unit 16a receives the data indicating the detection results from the candidate beam detection unit 15g, the beam search execution determination unit 16a starts the subroutine for all-beam search execution determination processing shown in FIG. 16 (step Sk6 when k=3).

The subroutine of the all-beam search execution determination processing performed in step Sk6 of the beam search processing of the eighth embodiment will be described with reference to FIG. 16. In processing of steps Se1 to Se6, the same processing as steps Sc1 to Sc6 shown in FIG. 11 is performed by the beam search execution instruction unit 11, the feedback signal receiving unit 12, the digital signal processing device 20, and the distributed antenna devices 30-1 to 30-4, and processing performed by the beam search execution determination unit 16 is performed by the beam search execution determination unit 16a. Therefore, when k=3, the beam search execution determination unit 16a determines “No” in the determination processing of step Se2 and the processing proceeds to step Se3, and thus the same processing as in the case of k=3 in the first embodiment, in the case of k=3 in the third embodiment, in the case of k=3 in the fifth embodiment, and in the case of k=3 in the seventh embodiment is performed thereafter.

As a result, in the eighth embodiment, when the beam search execution determination unit 16a determines to cause any of the distributed antenna devices 30-1 to 30-4 to perform a partial beam search, if the reception power value included in the feedback signal acquired through the partial beam search is approximately equal to the past average reception power value of the distributed antenna devices 30-1 to 30-4 for the partial beam search, the beam indicated by the beam ID included in the feedback signal can be searched as the best beam of the distributed antenna devices 30-1 to 30-4 corresponding to the source antenna ID included in the feedback signal. The beam search execution determination unit 16a can add data related to the beam to the beam combination history table 140a.

On the other hand, if the reception power value included in the feedback signal acquired through the partial beam search is not approximately equal to the past average reception power value of the distributed antenna devices 30-1 to 30-4 targeted for the partial beam search, the beam search execution determination unit 16a causes the distributed antenna devices 30-1 to 30-4 corresponding to the source antenna ID included in the feedback signal to perform an all-beam search. If the beam search execution determination unit 16a can acquire a feedback signal through the all-beam search, it is possible to search for the best beam in the distributed antenna devices 30-1 to 30-4 for all-beam search, and if it is not possible to acquire the feedback signal, it is impossible to search for the best beam for the distributed antenna devices 30-1 to 30-4 for all-beam search. Therefore, in the eighth embodiment, it is possible to search for the best beam more accurately than in the first embodiment, the third embodiment, the fifth embodiment, and the seventh embodiment at the time of performing a partial beam search, in addition to the effects obtained by the communication control device 10 of the first embodiment, the communication control device 10b of the third embodiment, the communication control device 10d of the fifth embodiment, and the communication control device 10f of the seventh embodiment.

However, in the positional relationship between a distributed antenna device and a terminal device in which a candidate beam cannot be selected even if an all-beam search is performed, record are not recorded in the beam combination history table 140 or the beam combination history table 140a. Therefore, in the case of the above positional relationship, even if the beam combination history table 140 or the beam combination history table 140a is referred to, there is a possibility that the beam ID of a beam that is a candidate beam is not always detected. In this case, in each of the above-described embodiments, distributed antenna devices always execute the all-beam search. Accordingly, the effect of reducing the number of beam searches is reduced.

On the other hand, in ninth and tenth embodiments which will be described below, the wireless communication system is not necessarily configured to perform an all-beam search even when the beam ID of a beam that is a candidate beam is not present in the beam combination history table 140 or the beam combination history table 140a. When the beam ID of a beam that is a candidate beam is not present in the beam combination history table 140 or the beam combination history table 140a, wireless communication systems in the ninth and tenth embodiments determine whether to perform an all-beam search according to a predetermined determination rule.

### Ninth Embodiment

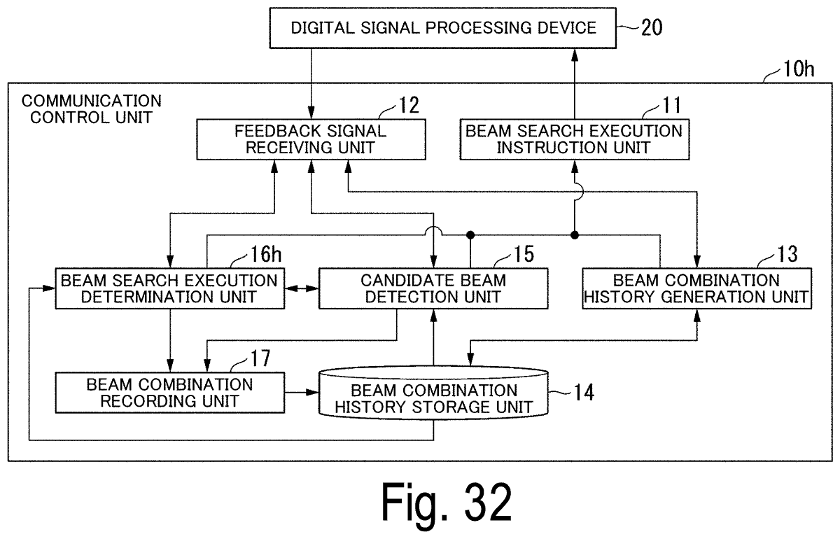

FIG. 32 is a block diagram showing the configuration of a communication control device 10h according to a ninth embodiment. The communication control device 10h is a device used in place of the communication control device 10 of the first embodiment. Hereinafter, for convenience of explanation, the wireless communication system 1 including the communication control device 10h instead of the communication control device 10 will be referred to as a wireless communication system 1h. In the communication control device 10h, the same components as that of the communication control device 10 of the first embodiment are denoted by the same reference numerals, and different components will be described below.

The configurations of the wireless communication system 1h in the ninth embodiment differs from the configuration of the wireless communication system 1 in the first embodiment in that, when the beam ID of a beam that is a candidate beam is not present in the beam combination history table 140, all-beam beam search is not necessarily performed and whether to perform the all-beam search is determined according to a predetermined determination rule. An example of the predetermined determination rule will be described later.

The communication control device 10h includes a beam search execution instruction unit 11, a feedback signal receiving unit 12, a beam combination history generation unit 13, a beam combination history storage unit 14, a candidate beam detection unit 15, a beam search execution determination unit 16h, and a beam combination recording unit 17.

The beam search execution determination unit 16h determines whether to cause distributed antenna devices 30-1 to 30-4, which have not performed all-beam searches in a beam search period, to perform the all-beam searches on the basis of detection results from the candidate beam detection unit 15.

More specifically, the beam search execution determination unit 16h determines whether or not distributed antenna devices 30-1 to 30-4 which have not performed all-beam searches in the beam search period and have no candidate beam IDs included in the detection results from the candidate beam detection unit 15 are set as distributed antenna devices 30-1 to 30-4 that are caused to perform an all-beam search. Here, the best beam is not selected for distributed antenna devices 30-1 to 30-4 which are not determined to be caused to perform the all-beam search.

The beam search execution determination unit 16h causes the distributed antenna devices 30-1 to 30-4 having no candidate beam IDs included in the detection results from the candidate beam detection unit 15 to perform a partial beam search based on candidate beam IDs included in the detection results. That is, the beam search execution determination unit 16h outputs a partial beam search request signal including the distributed antenna IDs included in the detection results and the candidate beam IDs to the beam search execution instruction unit 11. The beam search execution determination unit 16h determines, on the basis of a reception power value included in a feedback signal transmitted by the terminal device 40 that has received beams according to the partial beam search and a predetermined threshold, whether to cause the distributed antenna devices 30-1 to 30-4 corresponding to source antenna IDs included in the feedback signal to perform an all-beam search. When it is determined that the all-beam search is to be performed, the beam search execution determination unit 16h designates the source antenna IDs that are determination targets included in the feedback signal. The beam search execution determination unit 16h outputs an all-beam search request signal including the designated source antenna IDs to the beam search execution instruction unit 11.

(all-Beam Search Execution Determination Processing of Ninth Embodiment)

Hereinafter, all-beam search execution determination processing in the ninth embodiment will be described. For example, the candidate beam detection unit 15 performs the following processing when k=3 in the beam search processing shown in FIG. 10. That is, the candidate beam detection unit 15 detects the beam of the third distributed antenna device 30-3, which has been selected together with the detection reference beam, as a candidate beam from the beam combination history table 140. Here, the detection reference beam is a beam identified by “beam ID #33” of “distributed antenna ID #2”. In the beam combination history table 140, “beam ID #33” of “distributed antenna ID #2” corresponding to the detection reference beam is included in “record ID #2,” “record ID #4,” and “record ID #6,” but the “distributed antenna ID #3” items of “record ID #2,” “record ID #4,” and “record ID #6” are blank. Therefore, the candidate beam detection unit 15 outputs detection results that there is no candidate beam ID indicating a candidate beam that is a beam of the third distributed antenna device 30-3 and has been selected together with the detection reference beam. The candidate beam detection unit 15 generates data indicating detection results including only “distributed antenna ID #3” (step Sb4 when k=3).

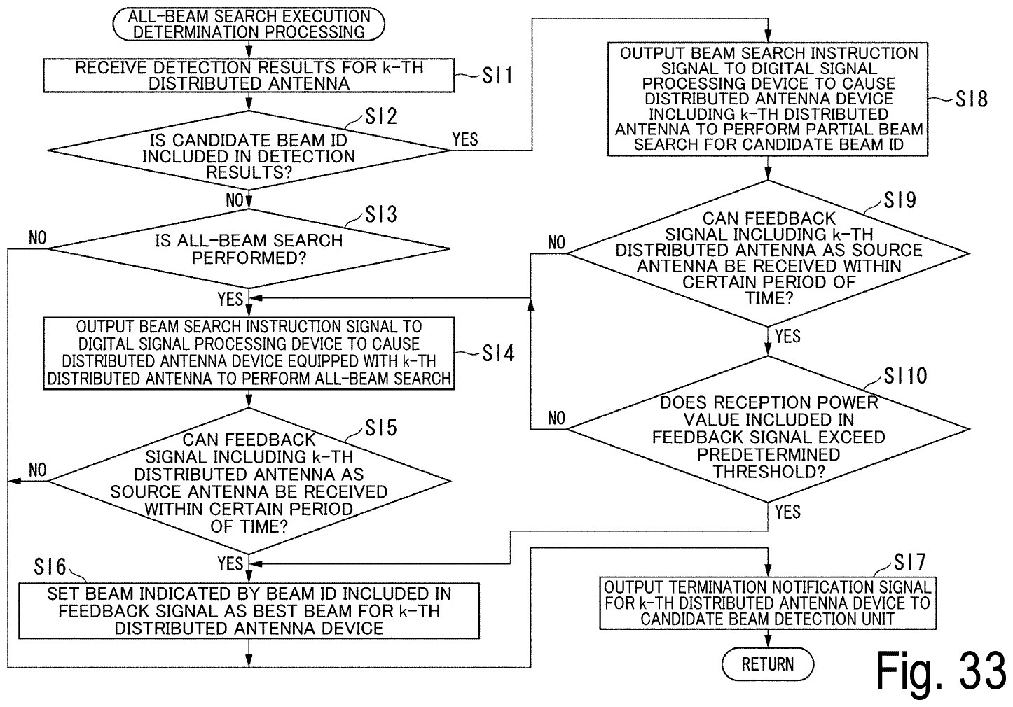

The candidate beam detection unit 15 outputs data indicating the detection results including only “distributed antenna ID #3” to the beam search execution determination unit 16h (step Sb5 when k=3). Upon receiving the data indicating the detection results from the candidate beam detection unit 15, the beam search execution determination unit 16h starts a subroutine for all-beam search execution determination processing shown in FIG. 33 (step Sb6 when k=3).

The beam search execution determination unit 16h receives the data indicating the detection results output by the candidate beam detection unit 15 (step Sl1 when k=3). The beam search execution determination unit 16h determines whether a candidate beam ID is included in the received data indicating the detection results (step Sl2 in the case of k=3). Here, since no candidate beam ID is included in the data indicating the detection results, the beam search execution determination unit 16h determines that no candidate beam ID is included in the received data indicating the detection results (No in step Sl2 when k=3).

When it is determined that no candidate beam ID is included in the received data indicating the detection results (No in step Sl2 when k=3), the beam search execution determination unit 16h determines whether to execute an all-beam search according to the predetermined determination rule (step Sl3 in the case of k=3). When it is determined that the all-beam search is not executed (No in step Sl3 when k=3), processing of the subroutine shown in FIG. 33 ends.

Hereinafter, processing of steps Sl4 to Sl7 when it is determined that the all-beam search is executed (Yes in step Sl3 when k=3) will be described. The beam search execution determination unit 16h reads “distributed antenna ID #k” included in the data indicating the detection results, and outputs an all-beam search request signal including “distributed antenna ID #k” to the beam search execution instruction unit 11 in order to cause the distributed antenna device 30-k including the k-th distributed antenna 31-k to perform an all-beam search on the basis of the read “distributed antenna ID #k.” After outputting the all-beam search request signal to the beam search execution instruction unit 11, the beam search execution determination unit 16h starts an internal feedback signal timer.

When starting the feedback signal timer, the beam search execution determination unit 16h sets the same time as that set in the feedback signal timer by the beam combination history generation unit 13 in the processing of step Sa1 in FIG. 9. Note that this time is a predetermined time, and is set in advance in the beam search execution determination unit 16h. When the beam search execution instruction unit 11 receives the all-beam search request signal output by the beam search execution determination unit 16h, processing after the beam search execution instruction unit 11 receives the all-beam search request signal in the processing of step Sa1 in FIG. 9 is performed by the beam search execution instruction unit 11, the digital signal processing device 20, the main device 32-k, the distributed antenna 31-k, and the terminal device 40 with i=k (step Sl4).

The beam search execution determination unit 16h determines whether a feedback signal including “distributed antenna ID #k,” which is the distributed antenna ID of the k-th distributed antenna 31-k, as a source antenna ID has been received before the feedback signal timer expires (step Sl5).

For example, it is assumed that any of the above-described events in cases where the beam combination history generation unit 13 cannot receive the feedback signal has not occurred, and the feedback signal receiving unit 12 outputs the feedback signal to the beam search execution determination unit 16h. In this case, the beam search execution determination unit 16h determines that the feedback signal including “distributed antenna ID #k,” which is the distributed antenna ID of the k-th distributed antenna 31-k, as a source antenna ID has been received before the feedback signal timer expires (Yes in step Sl5). The beam search execution determination unit 16h sets a beam ID included in the feedback signal as the beam ID indicating the best beam for the k-th distributed antenna device 30-k. The beam search execution determination unit 16h combines the source antenna ID, beam ID, and reception power value included in the feedback signal into one set of data, and outputs the one set of data to the beam combination recording unit 17. The beam combination recording unit 17 receives the one set of data output by the beam search execution determination unit 16h. (step Sl6).

On the other hand, it is assumed that any one of the above-mentioned events in cases where the beam combination history generation unit 13 cannot receive the feedback signal has occurred. In this case, the beam search execution determination unit 16h determines that the feedback signal including “distributed antenna ID #k,” which is the distributed antenna ID of the k-th distributed antenna 31-k, as a source antenna ID has not been received before the feedback signal timer expires (No in step Sl5).

After processing in step Sl6 or after determining “No” in the processing in step Sl5, the beam search execution determination unit 16h outputs a termination notification signal indicating that processing for the k-th distributed antenna device 30-k has ended and including the value of the counter k to the candidate beam detection unit 15 (step Sl7), and ends the subroutine processing.

Referring back to FIG. 10, when the candidate beam detection unit 15 receives the termination notification signal output from the beam search execution determination unit 16h, if the value of k at that time is not N (here, N=4), the candidate beam detection unit 15 performs the processing of steps Sb4 to Sb6 again using the value obtained by adding 1 to the value of k as a new value of k (loop Lb2s to Lb2e).

(All-Beam Search Execution Determination Rule when there is No Candidate Beam)

An example of a determination rule as to whether or not an all-beam search is executed when a beam ID of a beam that is a candidate beam is not present in the beam combination history table 140 will be described below. The following determination rules can also be applied to a tenth embodiment which will be described later.

### Determination Rule (1)

When the number of records in combination records of the best beams of a plurality of distributed antennas (that is, the beam combination history table 140) exceeds a predetermined number (Y records), it is determined that the all-beam search is not executed. That is, when records are accumulated and the number of recorded records is determined to be sufficient, an operation for performing the all-beam search is not performed when no candidate beam is present. The all-beam search may not be executed in a case where combinations of best beams overlap consecutively or within a predetermined number (A times) of executions in the past such that the number of executions of the all-beam search does not increase when the terminal device 40 is in a stationary state.

### Determination Rule (2)

The number of executions of the all-beam search is counted for each combination of a detection reference beam and a distributed antenna having no beam ID of a beam that is a candidate beam, and when it is output that there is no beam ID of a beam that is a candidate beam in the above combination that exceeds a predetermined number of executions (Z times), it is determined that the all-beam search is not executed (the all-beam search may not be executed in a case where the aforementioned combinations overlap consecutively or within a predetermined number of executions (A times) in the past such that the number of executions of the all-beam search does not increase when the terminal device 40 is in a stationary state.

### Determination Rule (3)

In a case where there is no beam ID of a beam that is a candidate beam for a distributed antenna that has not been selected because reception power does not exceed the threshold in a predetermined number of executions (B times) of a beam search period in the past, it is determined that the all-beam search is not executed at a predetermined probability (C %). This is because, when the all-beam search is performed every time the above condition is satisfied, the all-beam search is permanently performed, and thus the effect of reducing the number of beam searches is reduced.

The configuration of the wireless communication system 1h in the ninth embodiment described above can also be applied to the configurations of the first embodiment, the third embodiment, the fifth embodiment, and the seventh embodiment. That is, in each of the above embodiments, if the beam ID of a beam that is a candidate beam is not present in the beam combination history table 140, the all-beam search is not necessarily performed, and it may be determined whether or not the all-beam search is performed according to a predetermined determination rule.

In the ninth embodiment, when there is no candidate beam ID indicating a beam that has been selected in combination with the detection reference beam, the operation of performing the all-beam search is stopped on the basis of the predetermined determination rule. However, the present invention is not limited to this configuration, and for example, it is possible to stop the operation of all-beam search performed when reception power does not exceed the threshold in a partial beam search in accordance with a predetermined determination rule.

As described above, in the positional relationship between a distributed antenna device and the terminal device in which a candidate beam cannot be selected even if all-beam search is performed, records are not recorded in the beam combination history table 140. Therefore, in the case of the above positional relationship, even if the beam combination history table 140 is referred to, there is a possibility that the beam ID of a beam that is a candidate beam is not always detected. In this case, in the above-described first to eighth embodiments, the distributed antenna devices always perform the all-beam search. Accordingly, the effect of reducing the number of beam searches is reduced.

On the other hand, in the ninth embodiment, even when the beam ID of a beam that is a candidate beam is not present in the beam combination history table 140, the wireless communication system 1h does not necessarily perform all-beam search. The wireless communication system 1h in the ninth embodiment determines whether to perform all-beam search according to a predetermined determination rule when the beam ID of a beam that is a candidate beam is not present in the beam combination history table 140. By providing such a configuration, the wireless communication system 1h in the ninth embodiment can curb reduction in the effect of reducing the number of beam searches even in a positional relationship between a distributed antenna device and a terminal device in which a candidate beam cannot be selected even if all-beam search is performed.

### Tenth Embodiment

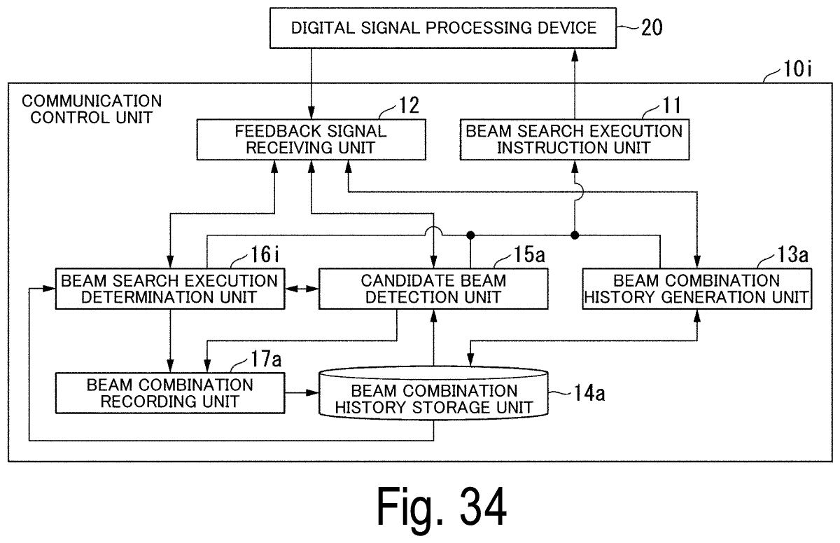

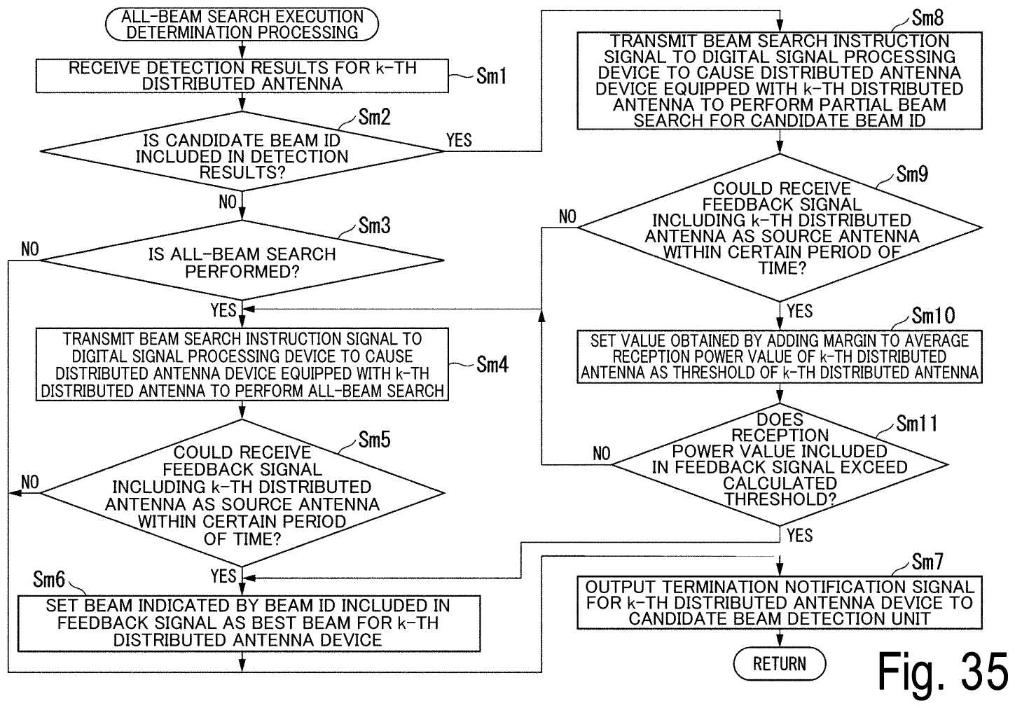

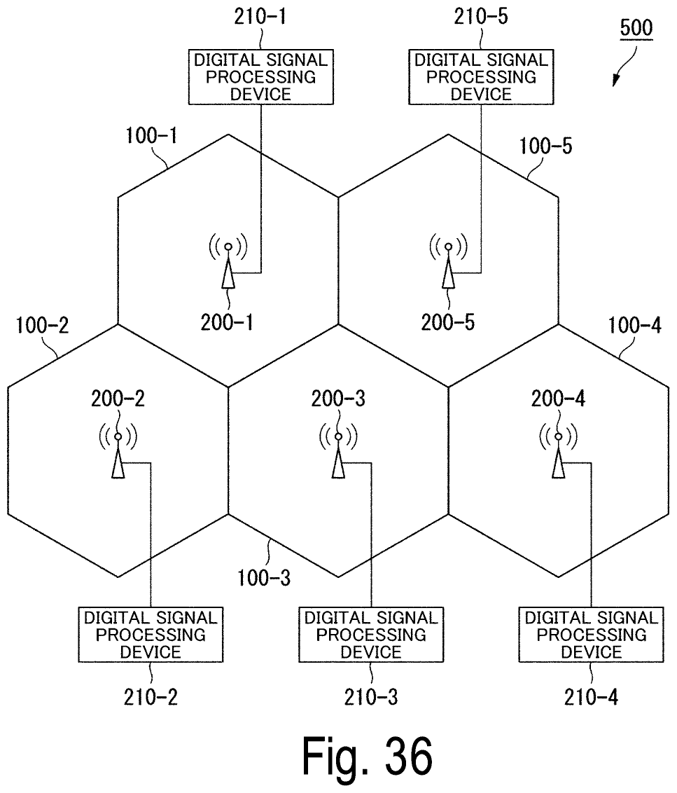

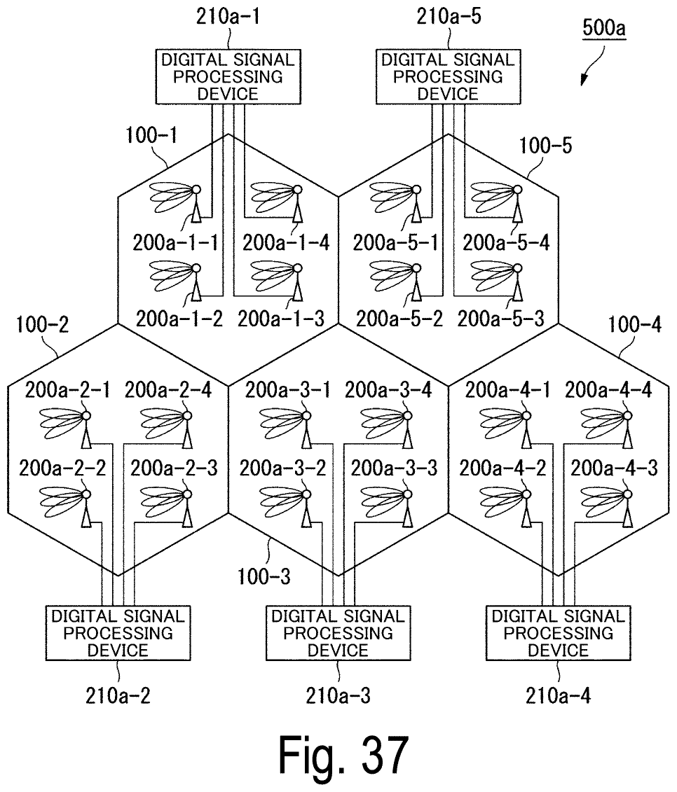

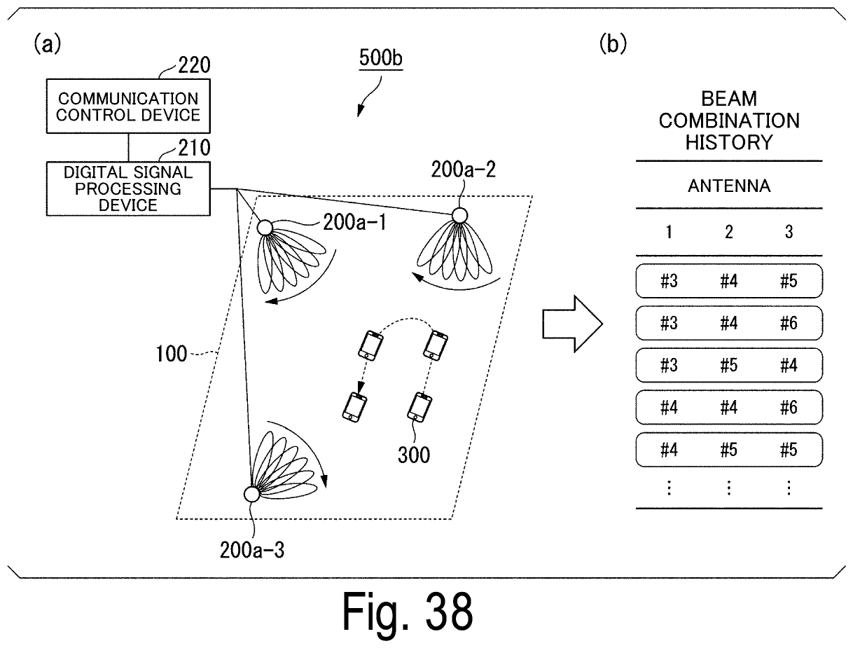

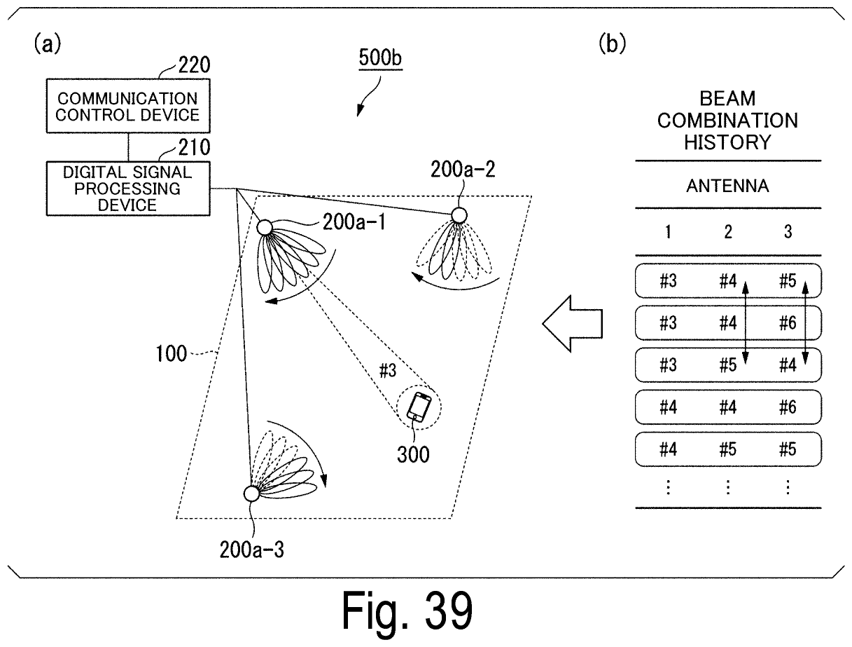

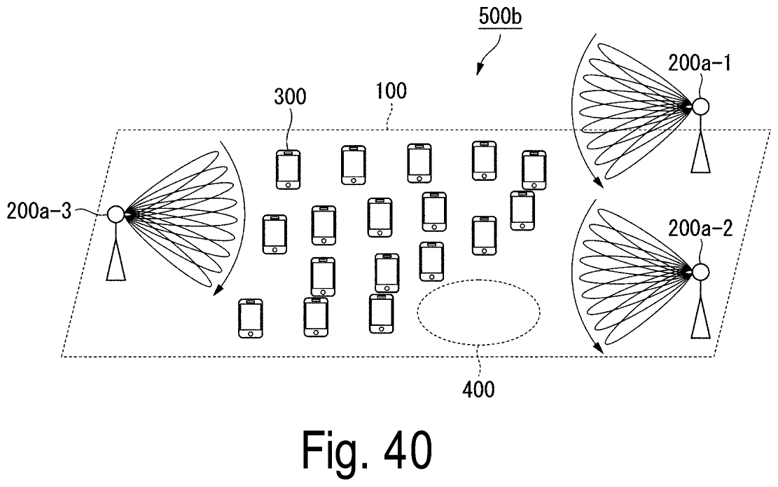

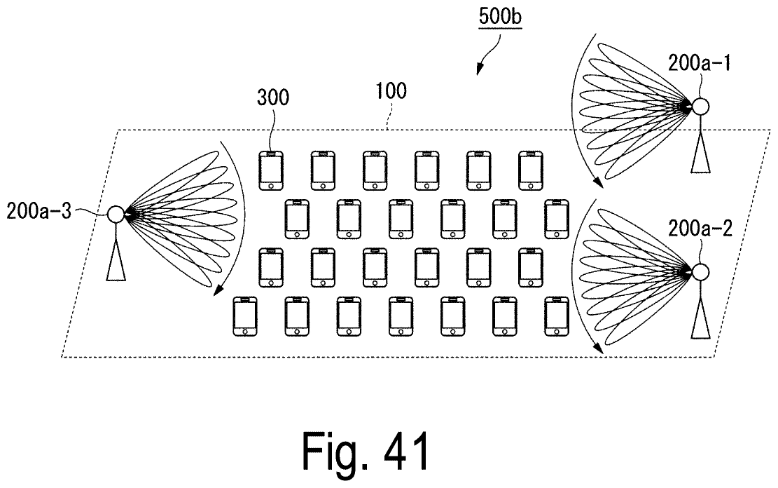

FIG. 34 is a block diagram showing the configuration of a communication control device 10i in a tenth embodiment. The communication control device 10i is a device used in place of the communication control device 10a of the second embodiment, and for convenience of description, the wireless communication system 1a including the communication control device 10i instead of the communication control device 10a will be referred to as a wireless communication system 1i below. In the communication control device 10i, the same components as whose of the communication control device 10a of the second embodiment are denoted by the same reference numerals, and different components will be described below.

The configurations of the wireless communication system 1i in the tenth embodiment differs from the configuration of the wireless communication system 1a in the second embodiment in that, when the beam ID of a beam that is a candidate beam is not present in the beam combination history table 140a, an all-beam search is not necessarily performed and whether or not the all-beam search is performed is determined according to a predetermined determination rule.

The communication control device 10i includes a beam search execution instruction unit 11, a feedback signal receiving unit 12, a beam combination history generation unit 13a, a beam combination history storage unit 14a, a candidate beam detection unit 15a, a beam search execution determination unit 16i, and a beam combination recording unit 17a.

The beam search execution determination unit 16i determines whether to cause distributed antenna devices 30-1 to 30-4, which have not performed an all-beam search in a beam search period, to perform the all-beam search on the basis of detection results from the candidate beam detection unit 15a.

More specifically, the beam search execution determination unit 16i determines whether to set the distributed antenna devices 30-1 to 30-4 which have not performed the all-beam search in the beam search period and have no candidate beam IDs included in the detection results from the candidate beam detection unit 15a as distributed antenna devices 30-1 to 30-4 to be caused to perform the all-beam search. Here, the best beam is not selected for distributed antenna devices 30-1 to 30-4 which are not determined to be caused to perform the all-beam search.

The beam search execution determination unit 16i causes the distributed antenna devices 30-1 to 30-4 having no candidate beam IDs included in the detection results from the candidate beam detection unit 15 to perform a partial beam search based on candidate beam IDs included in the detection results. That is, the beam search execution determination unit 16i outputs a partial beam search request signal including the distributed antenna IDs included in the detection results and the candidate beam IDs to the beam search execution instruction unit 11. The beam search execution determination unit 16i determines, on the basis of a reception power value included in a feedback signal transmitted by the terminal device 40 that has received beams according to the partial beam search and a predetermined threshold, whether to cause the distributed antenna devices 30-1 to 30-4 corresponding to source antenna IDs included in the feedback signal to perform the all-beam search. When it is determined that the all-beam search is to be performed, the beam search execution determination unit 16i designates the source antenna IDs that are determination targets included in the feedback signal. The beam search execution determination unit 16i outputs an all-beam search request signal including the designated source antenna IDs to the beam search execution instruction unit 11.

### (All-Beam Search Execution Determination Processing of Tenth Embodiment)

Hereinafter, all-beam search execution determination processing in the tenth embodiment will be described. For example, when k=3 in the processing of loop Ld2s to Ld2e of beam search processing shown in FIG. 15, the candidate beam detection unit 15a cannot detect a candidate beam ID corresponding to “distributed antenna ID #3” from the beam combination history table 140a as in the first embodiment. Therefore, in this case, the candidate beam detection unit 15a cannot detect the reception power value. Therefore, the candidate beam detection unit 15a does not calculate the average reception power value and outputs detection results that there is no candidate beam ID indicating a candidate beam which is the beam of the third distributed antenna device 30-3 and has been selected together with the detection reference beam similarly to the processing of step Sb4 of the first embodiment. The candidate beam detection unit 15a generates data indicating the detection results including only “distributed antenna ID #3” (step Sd4 when k=3).

The candidate beam detection unit 15a outputs data indicating the detection results including only “distributed antenna ID #3” to the beam search execution determination unit 16i (step Sb5 when k=3). When the beam search execution determination unit 16i receives data indicating the detection results from the candidate beam detection unit 15a, the beam search execution determination unit 16i starts a subroutine for all-beam search execution determination processing shown in FIG. 35 (step Sd6 when k=3).

The beam search execution determination unit 16i receives the data indicating the detection results output by the candidate beam detection unit 15 (step Sm1 when k=3). The beam search execution determination unit 16i determines whether a candidate beam ID is included in the received data indicating the detection results (step Sm2 in the case of k=3). Here, since no candidate beam ID is included in the data indicating the detection results, the beam search execution determination unit 16i determines that no candidate beam ID is included in the received data indicating the detection results (No in step Sm2 when k=3).

When it is determined that no candidate beam ID is included in the received data indicating the detection results (No in step Sm2 when k=3), the beam search execution determination unit 16i determines whether to execute an all-beam search according to the predetermined determination rule (step Sm3 in the case of k=3). When it is determined that the all-beam search is not executed (No in step Sm3 when k=3), processing of the subroutine shown in FIG. 35 ends.

In processing of steps Sm4 to Sm7 in a case where it is determined that the all-beam search is performed (Yes in step Sm3 when k=3), the same processing as steps Se3 to Se6 shown in FIG. 16 is performed by the beam search execution instruction unit 11, the feedback signal receiving unit 12, the digital signal processing device 20, and the distributed antenna devices 30-1 to 30-4, and the processing performed by the beam search execution determination unit 16a is performed by the beam search execution determination unit 16i.

(All-Beam Search Execution Determination Rule when there is No Candidate Beam)

The all-beam search execution determination rule in a case where there is no candidate beam exemplified in the ninth embodiment is also applicable to the tenth embodiment.

The configuration of the wireless communication system 1i in the tenth embodiment described above can also be applied to the configurations of the second embodiment, the fourth embodiment, the sixth embodiment, and the eighth embodiment. That is, in each of the above embodiments, in a case where the beam ID of a beam that is a candidate beam is not present in the beam combination history table 140a, the all-beam search is not necessarily performed, and whether or not the all-beam search is performed may be determined according to a predetermined determination rule.

As described above, in a positional relationship between a distributed antenna device and a terminal device in which a candidate beam cannot be selected even if the all-beam search is performed, records are not recorded in the beam combination history table 140a. Therefore, in the case of the above positional relationship, there is a possibility that the beam ID of a beam that is a candidate beam is not always detected even if the beam combination history table 140a is referred to. In this case, in the above-described first to eighth embodiments, the distributed antenna devices always perform the all-beam search. Accordingly, the effect of reducing the number of beam searches is reduced.

On the other hand, in the tenth embodiment, even when the beam ID of a beam that is a candidate beam is not present in the beam combination history table 140a, the wireless communication system 1i is not necessarily performing the all-beam search. When the beam ID of a beam that is a candidate beam is not present in the beam combination history table 140a, the wireless communication system 1i in the tenth embodiment determines whether or not to perform the all-beam search according to a predetermined determination rule. With such a configuration, the wireless communication system 1i in the tenth embodiment can curb reduction in the effect of reducing the number of beam searches even in a positional relationship between a distributed antenna device and a terminal device in which a candidate beam cannot be selected even if the all-beam search is performed.

### (Supplementary Forms)

The wireless communication systems in the first to tenth embodiments include a configuration in which an all-beam search is repeatedly performed for all distributed antenna devices which do not perform the all-beam search, but are not limited to this configuration. For example, the wireless communication systems may end processing without performing the all-beam search for all distributed antenna devices, and transmit data using beams that have already been detected.

Further, the order of distributed antenna devices when the above-mentioned all-beam search processing is repeated may not be fixed. For example, the order of distributed antenna devices when the all-beam search processing is repeated may be random, or the order may be shifted in order for each beam search period.

In the first to tenth embodiments described above, processing for searching for transmitting-side beams in the distributed antenna devices 30-1 to 30-4, the digital signal processing device 20, and the communication control devices 10 and 10a to 10i is shown. For example, when the wireless communication systems 1 and 1a to 1i are systems such as FDD using different frequencies for transmission and reception, the terminal devices 40 and 40a on the receiving side need to perform processing for searching for a receiving-side beam. The processing of searching for the receiving-side beam is performed, for example, as follows. The terminal devices 40 and 40a on the receiving side transmit a signal requesting a reception beam search procedure to each of the distributed antennas 31-1 to 31-4 on the transmitting side. When the digital signal processing device 20 receives the signal requesting a reception beam search procedure via the distributed antenna devices 30-1 to 30-4, the digital signal processing device 20 transmits signals periodically to the distributed antenna devices 30-1 to 30-4 through the distributed antennas 31-1 to 31-4 included in the distributed antennas. The terminal devices 40 and 40a switch directions of receiving-side beams formed by the plurality of terminal antennas 41-1 to 41-M, and receive signals periodically transmitted by the distributed antennas 31-1 to 31-4. The terminal devices 40 and 40a measure reception powers of the received signals.

As a result, the terminal devices 40 and 40a can select a receiving-side beam by determining which direction of the receiving-side beams formed by the terminal antennas 41-1 to 41-M has the best reception power value. When the distributed antenna devices 30-1 to 30-4 periodically transmit signals through the distributed antennas 31-1 to 31-4 provided therein, the terminal devices 40 and 40a may receive the signals and select a receiving-side beam without transmitting the signal requesting a reception beam search procedure. The mechanisms of the first to tenth embodiments described above may also be applied to this processing of selecting a receiving-side beam. Conversely, in a configuration in which the terminal devices 40 and 40a search for a transmitting-side beam, and the distributed antenna devices 30-1 to 30-4, the digital signal processing device 20, and the communication control devices 10 and 10a to 10i search for receiving-side beams, the above-described mechanisms of the first to tenth embodiments may also be applied.

In the first to tenth embodiments described above, the terminal devices 40 and 40a may measure reception power and select the best beam on the basis of the reception power value obtained by the measurement. Here, the reception power value is an example, and the terminal devices 40 and 40a may measure other indicators indicating reception quality such as a carrier-to-noise ratio and a signal-to-noise ratio, and select the best beam on the basis of the value indicating the measured reception quality.

In the first to tenth embodiments described above, the terminal devices 40 and 40a select the best beam in each of the distributed antenna devices 30-1 to 30-4 on the basis of a plurality of beam search signals transmitted by the distributed antennas 31-1 to 31-4. On the other hand, the communication control devices 10 and 10a to 10i may select the best beam in each of the distributed antenna devices 30-1 to 30-4. For example, the terminal devices 40 and 40a do not include the best beam selection unit 45, and the beam search signal receiving unit 44 outputs all read data as one set of data to the feedback signal generation unit 46 in the processing of step Stb3 in FIG. 7 and step Std3 in FIG. 29. The feedback signal generation unit 46 generates one feedback signal that includes the source antenna ID that is common to all of the one set of data, a plurality of beam IDs included in the one set of data, and the reception power value corresponding to the beam ID. The beam combination history generation units 13 and 13a, the candidate beam detection units 15 and 15a to 15g, and the beam search execution determination units 16, 16a, 16 h and 16i can select the best beams for the distributed antenna devices 30-1 to 30-4 corresponding to source antenna IDs included in the feedback signal on the basis of a combination of the plurality of beam IDs included in the received one feedback signal and the reception power values corresponding to the plurality of beam IDs.

In the first to tenth embodiments described above, the operator designates the timing of starting the beam combination generation processing of step S1 and the timing of starting the beam search processing of step S2 by operating the communication control devices 10 and 10a to 10i. On the other hand, when the beam combination generation processing of step S1 is started by the operator operating the communication control devices 10 and 10a to 10i, after the processing of step S1, the beam combination history generation units 13 and 13a may start the candidate beam detection units 15 and 15a to 15g such that the beam search processing of step S2 is started automatically without operator's operation.

In the first to tenth embodiments described above, the beam search processing of step S2 may be started without performing the beam combination generation processing of step S1. In this case, in a state before the beam search processing is started, no record is present in the beam combination history tables 140 and 140a of the beam combination history storage units 14 and 14a. Therefore, since the candidate beam detection units 15 and 15a to 15g cannot detect a candidate beam, all-beam search processing of steps Sb1 and Sb2 in FIG. 10 and steps Sc3 and Sc4 in FIG. 11 in the first embodiment and steps Sd1 and Sd2 in FIG. 15 and steps Se3 and Se4 in FIG. 16 in the second embodiment is mainly performed. By repeating the all-beam search processing in the beam search processing, records are accumulated in the beam combination history tables 140 and 140a of the beam combination history storage units 14 and 14a, and partial beam search processing is gradually performed. Therefore, in this case, the communication control devices 10 and 10a to 10g do not need to be provided with the beam combination history generation units 13 and 13a, and thus it is possible to accumulate a number of records sufficient for reducing the number of beam searches without reducing the transmission capacity when performing beam search processing without generating records indicating a history of beam combinations in advance.

In the first to tenth embodiments described above, the beam search signal receiving unit 44 of the terminal devices 40 and 40a performs the processing of step Stb3 and step Std3 after the timer expires, as shown in the flowcharts of FIG. 7 and FIG. 29. On the other hand, the beam search signal receiving unit 44 may perform the processing of step Std3 and step Std3 without waiting for the timer to expire when it can be determined that all beams carrying beam search signals transmitted by distributed antenna devices 30-1 to 30-4 corresponding to one transmitting antenna ID have been received, as shown below. For example, it is assumed that the numbers of beams that can be transmitted by the distributed antenna devices 30-1 to 30-4 are all the same number, and this number is known.

In this case, each time the beam search signal receiving unit 44 receives a beam search signal output from the digital signal processing unit 43, the beam search signal receiving unit 44 counts the number of received beam search signals for each source antenna ID included in the beam search signal. The beam search signal receiving unit 44 determines whether the number counted for each source antenna ID matches the known number of beams that can be transmitted by the distributed antenna devices 30-1 to 30-4 each time counting is performed. It is assumed that the beam search signal receiving unit 44 determines that the number counted for any one of source antenna IDs matches the known number of beams that can be transmitted by the distributed antenna devices 30-1 to 30-4. In this case, it can be considered that the beam search signal receiving unit 44 has received all beam search signals transmitted by the distributed antenna devices 30-1 to 30-4 corresponding to the source antenna ID, and thus the processing of step Stb3 and step Std3 can be performed without waiting for expiration of the timer started in association with the source antenna ID.

In the first to sixth embodiments described above, when the beam search execution instruction unit 11 generates a plurality of beam search instruction signals corresponding to one distributed antenna ID, the beam search execution instruction unit 11 may add the number of generated beam search instruction signals, that is, the number of beams transmitted by the distributed antennas 31-1 to 31-4 corresponding to the distributed antenna ID, and a transmission timing which is an interval of transmitting beams to the beam search instruction signal to be first output to the digital signal processing device 20 among the plurality of generated beam search instruction signals. Here, the transmission timing may be a time appropriately determined in the wireless communication system, or may be a time determined in specifications or the like. In this case, when the digital signal processing device 20 receives the beam search instruction signal including the number of beams, transmission timing, distributed antenna ID, and beam ID, the digital signal processing device 20 generates the beam search signal including the number of beams, the transmission timing, the source antenna ID, and the beam ID from the received beam search instruction signal.

The “beam search signal” used in each embodiment may also be read as a “pilot signal,” “reference signal,” “control signal,” “control information,” or “control channel.”

Since the digital signal processing device 20 outputs the generated beam search signals to the main devices 32-1 to 32-4 corresponding to the source antenna IDs in the order of generation, the beam search signal including the number of beams and the transmission timing will reach the terminal device 40 first. In the processing of step Sta5, the beam search signal receiving unit 44 of the terminal device 40 can calculate a time to be set in the timer on the basis of the number of beams and the transmission timing included in the received beam search signal and set the calculated time in the timer. By doing this, the terminal device 40 can ascertain the number of beams transmitted by one of the distributed antenna devices 30-1 to 30-4 in a beam search period when the first beam search signal corresponding to the one of the distributed antenna devices 30-1 to 30-4 is received, and thus a more appropriate time can be set in the timer, and the time required for beam search processing can be reduced.

The candidate beam detection unit 15a in the processing of step Sd4 in FIG. 15 in the second embodiment described above, the candidate beam detection unit 15c in the processing of step Sg4 in FIG. 20 in the fourth embodiment described above, the candidate beam detection unit 15e in the processing of step Si4 in FIG. 24 in the sixth embodiment described above, and the candidate beam detection unit 15g in the processing of step Sk4 in FIG. 31 in the eighth embodiment described above may calculate the average reception power value by detecting a reception power value written in the same element of the beam combination history table 140a together with a detected candidate beam ID. On the other hand, the average reception power value may be calculated by the following procedure.

For example, in the processing of step Sd4 in FIG. 15, step Sg4 in FIG. 20, step Si4 in FIG. 24, and step Sk4 in FIG. 31, the candidate beam detection unit 15a detects only a candidate beam ID, generates data indicating detection results including the detected candidate beam ID, a distributed antenna ID to be processed, and a detection reference beam, and outputs the data to the beam search execution determination unit 16a. For example, after the processing of step Se7 in FIG. 16, the beam search execution determination unit 16a may detect the reception power values written in the locations of the same elements together with the candidate beam ID based on the distributed antenna ID included in the data indicating the detection results and the data indicating the detection reference beam and calculate the average reception power value. By doing this, in two kinds of processing of step Sd4, step Sg4 and step Si4, or step Sk4 and step Se7, processing of detecting the same candidate beam ID from the beam combination history table 140a is performed, average reception power value calculation processing can be performed only when “Yes” is determined in the determination processing of step Se2, the average reception power value can be calculated using a time taken until a feedback signal is received in processing of step Se8, and a threshold can be calculated from the calculated average reception power value.

In the first to tenth embodiments described above, the terminal devices 40 and 40a include the plurality of terminal antennas 41-1 to 41-M, they may include one terminal antenna. In this case, if the distributed antenna devices 30-1 to 30-4 become a transmitting side and the terminal devices 40 and 40a become a receiving side, MISO (Multiple Input Single Output) is performed, and if the distributed antenna devices 30-1 to 30-4 become a receiving side and the terminal devices 40 40a become a transmitting side, SIMO (Single Input Multiple Output) is performed. Further, when the terminal devices 40 and 40a include one terminal antenna, site diversity may be performed such that one of the distributed antenna devices 30-1 to 30-4 with the best reception power value is adaptively selected from a plurality of candidate distributed antenna devices 30-1 to 30-4 and wireless communication is performed.

In the configurations of the first to tenth embodiments described above, in the processing of step Sc9 shown in FIG. 11, step Se10 shown in FIG. 16, step Sl10 in FIG. 33, and step Sm11 shown in FIG. 35, determination processing is performed to determine whether a reception power value exceeds a threshold. However, the present invention is not limited to the embodiments, and the determination processing of “whether it exceeds” is merely an example, and depending on how the threshold is determined, it may be replaced with determination processing of whether a reception power value is equal to or higher than a threshold.

In the first to tenth embodiments described above, the communication control devices 10 and 10a to 10g may include the digital signal processing device 20 therein. The beam search execution instruction unit 11 and the feedback signal receiving unit 12 of the communication control devices 10 and 10a to 10g may be included in the digital signal processing device 20.

In the first to tenth embodiments described above, when performing an all-beam search, the beam search signal is transmitted in all beam directions. On the other hand, when performing an all-beam search, for example, a two-step beam search may be applied such that the first step involves performing a rough beam search using a beam with a wide beam width and the second step involves performing a precise beam search in a range selected in the first step using a beam with a narrow beam width, and if the position information of the terminal devices 40 40a is known, beam search may be performed by focusing on the periphery of the direction in which the terminal devices 40 and 40a are present, or beam search may be performed only around beams that have been connected to the terminal devices 40 and 40a in advance.

In the first to tenth embodiments described above, when the terminal devices 40 and 40a are stationary, it is conceivable that the beam combination history generation units 13 and 13a and the beam combination recording units 17 and 17a generate records with the same combination of beam IDs in a short period of time. In this case, in order to prevent records with the same combination of beam IDs from being continuously recorded in the beam combination history tables 140 and 140a, for example, the beam combination history generation units 13 and 13a and the beam combination recording units 17 and 17a store a record written immediately before in the internal storage area in the beam combination history tables 140 and 140a, and when a record of the same combination of beam IDs as the combination of beam IDs in the record written immediately before stored in the internal storage area is generated within a predetermined period of time, the generated record may be discarded without being written to the beam combination history tables 140 and 140a.

According to the above-described embodiments, the communication control device includes a candidate beam detection unit (a candidate beam detector), a beam search execution determination unit (beam search execution determiner), and a beam combination recording unit (a beam combination recorder). The candidate beam detection unit causes each of a plurality of distributed antennas to perform all-beam search performed by transmitting beams in all transmittable directions in a beam search period for searching for a beam used for wireless communication with a terminal device in an order of distributed antennas different for each beam search period. Here, causing the all-beam search to be performed in the order of distributed antennas different for each search period is, for example, causing a plurality of distributed antenna devices to perform the all-beam search in a random order rather than causing the plurality of distributed antenna devices to perform the all-beam search in a fixed order. Alternatively, causing the all-beam search to be performed in the order of distributed antennas different for each search period is, for example, causing the all-beam search to be performed while shifting the selection order of a plurality of distributed antenna devices one by one each. When the candidate beam detection unit has acquired one beam identifier indicating the best beam among the beams according to the all-beam search, the candidate beam detection unit stops the all-beam search. The candidate beam detection unit sets a beam identified by the acquired beam identifier and information indicating a distributed antenna that has transmitted the beam indicated by the beam identifier as a detection reference beam. The candidate beam detection unit detects, from the beam combination history table, a beam identifier of a distributed antenna that has not performed the all-beam search during a beam search period, the beam identifier corresponding to a beam that has been selected together with the detection reference beam, as a candidate beam identifier for the distributed antenna. The beam search execution determination unit determines whether to cause a distributed antenna that has not performed the all-beam search in the beam search period to perform the all-beam search on the basis of the detection results from the candidate beam detection unit. The beam combination recording unit generates a record indicating a combination of beam identifiers indicating beams determined to be the best beams for respective distributed antennas in the beam search period. The beam combination recording unit records the generated record in the beam combination history storage unit (the beam combination history storage).

The communication control devices 10 and 10a to 10g in the first to tenth embodiments described above may be realized by a computer. In such a case, a program for realizing this function may be recorded on a computer-readable recording medium, and the program recorded on the recording medium may be read and executed by the computer system. Meanwhile, the “computer system” mentioned herein includes an OS and hardware such as peripheral equipment. In addition, the “computer-readable recording medium” refers to a portable medium such as a flexible disk, a magneto-optical disk, a ROM, or a CD-ROM or a storage device such as a hard disk that is built into the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. The program described above may be used to implement some of the functions described above or may also be combined with a program already recorded in the computer system to implement the above-mentioned functions, or a programmable logic device such as an FPGA (Field Programmable Gate Array) may be used to implement the functions.

Although the example of the present invention has been described in detail with reference to the drawings, a specific configuration is not limited to this example, and design within the scope of the gist of the present invention, and the like are included.

### INDUSTRIAL APPLICABILITY

The present invention can be applied to wireless communication systems with distributed antennas.

### REFERENCE SIGNS LIST

1 Wireless communication system
10 Communication control device
11 Beam search execution instruction unit
12 Feedback signal receiving unit
13 Beam combination history generation unit
14 Beam combination history storage unit
15 Candidate beam detection unit
16 Beam search execution determination unit
17 Beam combination recording unit
20 Digital signal processing device
30-1 to 30-4 Distributed antenna device
31-1 to 31-4 Distributed antenna
32-1 to 32-4 Main device
40 Terminal device

1. A communication control device comprising:
a candidate beam detector configured to cause each of a plurality of distributed antennas to perform an all-beam search performed by transmitting beams in all transmittable directions in a beam search period for searching for a beam to be used for wireless communication with a terminal device in a different order of the distributed antennas for each beam search period, to stop the all-beam search when one beam identifier indicating a best beam has been acquired among beams according to the all-beam search, to set a beam identified by the acquired beam identifier and information indicating the distributed antenna that has transmitted the beam indicated by the beam identifier as a detection reference beam, and to detect a beam identifier of the distributed antenna that has not performed the all-beam search in the beam search period, the beam identifier corresponding to a beam that has been selected together with the detection reference beam, as a candidate beam identifier for the distributed antenna from a beam combination history storage;
a beam search execution determiner configured to determine whether or not to cause the distributed antenna that has not performed the all-beam search in the beam search period to perform the all-beam search on the basis of detection results from the candidate beam detector; and
a beam combination recorder configured to generate a record indicating a combination of beam identifiers indicating beams determined to be best beams in the respective distributed antennas in the beam search period and to record the generated record in the beam combination history storage.

2. The communication control device according to claim 1, wherein
the beam search execution determiner determines the distributed antenna which has not performed the all-beam search in the beam search period and in which the candidate beam identifier has not been detected by the candidate beam detector as the distributed antenna which is to be subjected to the all-beam search, and
wherein the beam that is the best beam in each of the distributed antennas in the beam search period is a beam determined to be a best beam by the terminal device among beams transmitted by the distributed antennas which have performed the all-beam search in the beam search period.

3. The communication control device according to claim 1, wherein
the beam search execution determiner causes the distributed antenna in which the candidate beam identifier has been detected by the candidate beam detector to perform a partial beam search for transmitting a beam indicated by the candidate beam identifier, and determines whether or not to cause the distributed antenna to perform an all-beam search on the basis of a value indicating reception quality of a beam determined to be a best beam by the terminal device among beams according to the partial beam search and a threshold, and
wherein the beam that is the best beam in each of the distributed antennas in the beam search period is a beam determined to be a best beam by the terminal device among beams according to the partial beam search performed immediately before by the distributed antenna when the beam search execution determiner determines that the distributed antenna is not to be subjected to the all-beam search, or a beam determined to be a best beam by the terminal device among beams according to the all-beam search performed by the distributed antenna when the beam search execution determiner determines that the distributed antenna is to be subjected to the all-beam search.

4. The communication control device according to claim 3, wherein the beam combination history storage stores a value indicating reception quality when the terminal device has received the beam indicated by the beam identifier in association with each beam identifier for each of the distributed antennas, and
the beam search execution determiner determines whether or not to cause the distributed antenna to perform the all-beam search on the basis of the threshold calculated from the value indicating the reception quality associated with the candidate beam identifier in the beam combination history storage and a value indicating reception quality of the beam indicated by the beam identifier.

5. The communication control device according to claim 1, further comprising a beam combination history generator configured to record a record indicating a combination of beam identifiers indicating beams determined to be best beams for the distributed antennas by the terminal device among beams according to the all-beam search performed by all the distributed antennas in each trial cycle before the beam search period in the beam combination history storage for each trial cycle.

6. A wireless communication system comprising a terminal device, a plurality of distributed antenna devices each including one distributed antenna, and a communication control device,
wherein the communication control device includes:
a candidate beam detector configured to cause each of a plurality of distributed antennas to perform an all-beam search performed by transmitting beams in all transmittable directions in a beam search period for searching for a beam to be used for wireless communication with a terminal device in a different order of the distributed antennas for each beam search period, to stop the all-beam search when one beam identifier indicating a best beam has been acquired among beams according to the all-beam search, to set a beam identified by the acquired beam identifier and information indicating the distributed antenna that has transmitted the beam indicated by the beam identifier as a detection reference beam, and to detect a beam identifier of the distributed antenna that has not performed the all-beam search in the beam search period, the beam identifier corresponding to a beam that has been selected together with the detection reference beam, as a candidate beam identifier for the distributed antenna from a beam combination history storage;
a beam search execution determiner configured to determine whether or not to cause the distributed antenna that has not performed the all-beam search in the beam search period to perform the all-beam search on the basis of detection results from the candidate beam detector; and
a beam combination recorder configured to generate a record indicating a combination of beam identifiers indicating beams determined to be best beams in the respective distributed antennas in the beam search period and to record the generated record in the beam combination history storage.

7. A communication control method comprising:
causing each of a plurality of distributed antennas to perform an all-beam search performed by transmitting beams in all transmittable directions in a beam search period for searching for a beam to be used for wireless communication with a terminal device in a different order of the distributed antennas for each beam search period, stopping the all-beam search when one beam identifier indicating a best beam is acquired among beams according to the all-beam search, setting a beam identified by the acquired beam identifier and information indicating the distributed antenna that has transmitted a beam indicated by the beam identifier as a detection reference beam, and detecting a beam identifier of the distributed antenna that has not performed the all-beam search in the beam search period, the beam identifier corresponding to a beam that has been selected together with the detection reference beam, as a candidate beam identifier for the distributed antenna from a beam combination history storage;
determining whether or not to cause the distributed antenna that has not performed the all-beam search in the beam search period to perform the all-beam search on the basis of detection results from the candidate beam detector; and
generating a record indicating a combination of beam identifiers indicating beams determined to be best beams in the respective distributed antennas in the beam search period and recording the generated record in the beam combination history storage.

8. A non-transitory computer readable medium which stores a program for causing a computer to execute:
causing each of a plurality of distributed antennas to perform an all-beam search performed by transmitting beams in all transmittable directions in a beam search period for searching for a beam to be used for wireless communication with a terminal device in a different order of the distributed antennas for each beam search period, stopping the all-beam search when one beam identifier indicating a best beam has been acquired among beams according to the all-beam search, setting a beam identified by the acquired beam identifier and information indicating the distributed antenna that has transmitted the beam indicated by the beam identifier as a detection reference beam, and detecting a beam identifier of the distributed antenna that has not performed the all-beam search in the beam search period, the beam identifier corresponding to a beam that has been selected together with the detection reference beam, as a candidate beam identifier for the distributed antenna from a beam combination history storage;
determining whether or not to cause the distributed antenna that has not performed the all-beam search in the beam search period to perform the all-beam search on the basis of detection results from the candidate beam detector; and
generating a record indicating a combination of beam identifiers indicating beams determined to be best beams in the respective distributed antennas in the beam search period and recording the generated record in the beam combination history storage.
